(19) United States
(12) Patent Application Publication
(10) Pub. No.: US 2015/0046229 A1
(43) Pub. Date: Feb. 12, 2015

(54) MANAGING TRAILERS AND SHIPMENTS

(71) Applicant: PINC Solutions, Alameda, CA (US)

(72) Inventor: Aleks GÖLLÜ, El Cerrito, CA (US)

(21) Appl. No.: 14/452,274

(22) Filed: Aug. 5, 2014

Related U.S. Application Data
(60) Provisional application No. 61/862,902, filed on Aug. 6, 2013.

(51) Int. Cl. G06Q 10/08; G06Q 10/06

(52) U.S. Cl. CPC G06Q 10/083; G06Q 10/06393
USPC 705/7.39; 705/337

(57) ABSTRACT

A shipping management system manages trailers and shipments across supply chains, provides universal dashboards for shipment and trailer management and for monitoring meaningful statistics, and provides universal analysis and optimization techniques for shipment and trailer visit management and for analyzing and optimizing meaningful statistics.

### CROSS REFERENCE TO RELATED APPLICATIONS

This patent application claims priority from U.S. Provisional Patent Application Ser. No. 61/862,902, SHIPPING MANAGEMENT SYSTEM, filed Aug. 6, 2013, the entirety of which is incorporated herein by this reference thereto.

### BACKGROUND OF THE INVENTION

1. Technical Field

This invention relates generally to the field of computer-implemented tracking, management, and analysis systems. More specifically, this invention relates to a computer-implemented system for tracking, analyzing, and managing movements of trailers and shipments across a supply chain from various user viewpoints.

2. Description of the Related Art

Today's yard management systems either are based on a four fences, e.g. inside the yard, view of the world or consist of electronic data interchange (EDI) techniques with which interested parties or players can send messages to each other and with which everyone has their own copy of the information. In a four fences view of the world a trailer/shipment is entered into the system when it arrives at the facility and such trailer/shipment leaves the system when the trailer/shipment leaves the facility. In a more integrated world where trading partners share planned arrival and departure information interested parties may include parties at the source of a shipment, at the destination of the shipment, or with the carrier of the shipment, etc. One problem with that is each party may have a slightly different language from another party. For example, shippers may use different terminology than carriers. Thus, systems may need to translate data from one language to another. As well, EDI is not real-time; EDI requires an individual to type in the relevant data. Sometimes the data are processed in batch mode. The net effect is that informational data may arrive six to 24 hours after an important event actually transpires.

One container monitoring disclosure that tracks location and load status of shipping containers within a defined premises and generates container status reports for customers receiving containers, suppliers or shippers of goods, and container carriers is disclosed in U.S. Pat. No. 5,712,789, CONTAINER MONITORING SYSTEM AND METHOD, (Jan. 27, 1998) to Joseph E. Radican. Specifically, carrier and container identifiers are used to track and monitor movements and status of each container from a point of departure to a final destination and return. A combined computer and telecommunications system is also disclosed for executing the tasks of the container monitoring system.

As well, container and inventory monitoring methods and systems that provide detailed logistical control of containers, shipping racks and resident and in-transit inventory are disclosed in U.S. Pat. No. 6,148,291, CONTAINER AND INVENTORY MONITORING METHODS AND SYSTEMS (Nov. 14, 2000) to Joseph E. Radican. In particular, the methods and systems create and maintain accurate real-time records and actionable updates of the location, movement, and load status of containers, racks, and inventory within the facility boundaries and between facilities such as factories, assembly plants, warehouses, shipping yards, and freight switching facilities. Detailed data on container switching, unloading and loading activity is recorded and archived. A virtual inventory accounting is provided by tracking from customer release orders to supplier shipments and rack returns.

Existing Yard Management Systems (YMS) are limited to tracking trailer and shipment status within the four fences of a facility; at best they receive tardy planning data through EDI or similar interfaces. However, shipments are loaded onto a trailer in one facility and are transported to another, where they are ultimately unloaded. That is, clearly there are shipments that are loaded or unloaded at multiple facilities. When tracking shipments within the four fences only, the full status of a particular shipment progress is not available for planning or for monitoring progress across all the players. Because different players may use or need different semantics to depict the shipment and shipment progress, keeping such different players on the same page remains a challenge.

### SUMMARY OF THE INVENTION

Embodiments are provided that overcome the many limitations of shipping, yard, warehouse, or transportation management systems of the status quo. Also provided are techniques for uniform visibility of shipment state data across supply chains with minimal redundant data entry and ability to intervene and plan for positive path operation and for exceptions, resulting in more efficient operation. More specifically, shipping management embodiments are provided that manage trailers and shipments across supply chains, provide universal dashboards for shipment and trailer management and for monitoring meaningful statistics, and provide universal analysis and optimization techniques for shipment and trailer visit management and for analyzing and optimizing related statistics in a meaningful way.

### BRIEF DESCRIPTION OF THE DRAWINGS

FIGS. 1A-1I are schematic diagrams showing possible trailer event states and state trajectories from various source, destination, and headquarter perspectives, according to an embodiment of the invention;

FIG. 2A is a schematic diagram showing a trailer and shipment data model at a high level, according to an embodiment of the invention;

FIG. 2B is a schematic diagram showing how to synchronize trailer and shipment states, according to an embodiment of the invention;

FIGS. 3A-3H is a spreadsheet of the possible combinations of trailer states in combination with shipment states, according to an embodiment of the invention;

FIG. 4 is a chart of particular trailer states or events, load statuses, location, and waiting on labor versus elapsed time, according to an embodiment of the invention;

FIGS. 5A-5K are sample screen shots of different interfaces that different users may leverage for various execution (5B-5F), monitoring (5G-5I), and analysis (5I-5K) capabilities, according to an embodiment of the invention;

FIG. 6 is a chart of asset operations, according to an embodiment of the invention;

FIG. 7A is a sample screen shot of journeys and planned moves page of the system, according to an embodiment of the invention;

FIG. 7B is a sample screen shot of an asset view page in the context of a matching journey for a given asset, according to an embodiment of the invention;

FIG. 7C is a sample screen shot of the planned moves for a particular journey, according to an embodiment of the invention;

FIGS. 8A-8AM are sample screen shots of an exemplary Drop Load work flow scenario, according to an embodiment of the invention;

FIGS. 9A-9O are sample screen shots of an exemplary Live Load work flow scenario, according to an embodiment of the invention;

FIGS. 10A-10G are sample screen shots of an exemplary exceptions and monitoring, according to an embodiment of the invention;

FIG. 10H is a screen shot of an exemplary dashboard at the site level;

FIGS. 11A-11J are screen shots of an exemplary dashboard at the corporate level, according to an embodiment of the invention;

FIGS. 12A-12H are schematic diagrams of exemplary key performance indicators, metrics, and reports according to an embodiment of the invention;

FIG. 13 is a screen shot of an exemplary dashboard at the corporate level, according to an embodiment of the invention;

FIG. 14A is a schematic diagram of main components of the corporate platform architecture at a high level, according to an embodiment of the invention;

FIG. 14B is a schematic diagram of main components from the enterprise perspective, according to an embodiment of the invention; and

FIG. 15 is a block schematic diagram of a system in the exemplary form of a computer system according to an embodiment.

### DETAILED DESCRIPTION OF THE INVENTION

### 1 Introduction

Embodiments are provided which enable a variety of end-users to manage trailers, trailer visits, drivers, driver visits, as well as shipments across supply chains. It is recognized that according to today's status quo, there are multiple conflicting definitions of what precisely these terms, such as for example a trailer visit or a shipment, mean. Herein is described a generalized approach that accommodates and works with existing definitions.

The embodiments are founded upon a unique data model, referred to as the least common denominator model. The model reflects the recognized and leveraged data regarding trailers and shipments which are common to all end users. Importantly, the least common denominator model facilitates the mapping of trailer states to shipping states. An exemplary spreadsheet is provided that illustrates such mapping. The data in the model may be shared among varied types of end users, such as for example shippers, carriers, drivers, persons at headquarters, etc. Thus, the least common denominator model allows for the provision of universal dashboards for shipment and trailer management, because the different type of end users are able to share common types of data and terminology. As well, the novel and inventive least common denominator model allows for and facilitates a vast amount of data regarding trailers and shipments being stored and mined at the corporate level as well as at the local, e.g. yard, level. Thus, the least common denominator data model combined with the vast and varied data stored at the corporate level and even the local level allow for the computing of meaningful, optimized statistics regarding trailers and shipments.

Further, it is recognized that while the least common denominator model is at an appropriate level of detail as a common language among various end-users, each end-user, based on his or her job and role, requires one or more additional levels of information to perform his or her tasks. Embodiments allow such detail at a local level. In an embodiment, each local facility has the ability to extend its trailer model and the embodiment then provides for mapping the local trailer state to the least common denominator model.

Three novel and inventive concepts are described herein. The first may be referred to as “Managing Trailers and Shipments across the Supply Chain.” This novel and inventive concept encompasses the least common denominator model and its numerous applications including but not limited to shipment execution, performance metrics, modeled exceptions, unmodeled exceptions, capturing trailer states, and the like. A second novel and inventive concept described herein may be referred to as, “Generalized Dashboards for Shipment/Trailer Management; Ability to monitor meaningful statistics.” This novel and inventive concept, employing the least common denominator model, provides a universal view of and access to the shipment data, which facilitates planning and real-time remediation regarding planned operation as well as exceptions, both modeled and unmodeled. A third novel and inventive concept described herein may be referred to as, “Generalized Analysis and Optimization for Shipment/Trailer Visit Management; Ability to analyze/optimize meaningful statistics.” This novel and inventive concept, employing the least common denominator model, facilitates monitoring and planning operation based on analysis and statistics as well as facilitating the use of or creating of meaningful metrics and statistics, such as for example, performance metrics.

A novel and inventive corporate platform is provided which is configured to provision the universal dashboard and to perform the analysis and generate the statistics.

Two different type of work flow scenarios are described in detail to illustrate the novel and inventive concepts using screen shots of actual implementation.

Lastly, an example machine overview in the form of a computer system is described in detail.

An overview in summary, bulleted form of embodiments discussed herein is provided herein below. Under each concept, relevant issues, e.g. regarding the status quo of existing operations and yard management systems and environments, are listed. Following the list of items that are considered to be currently status quo are a list of exemplary features and embodiments described herein that address and otherwise improve upon the status quo.

It should be appreciated that such list is illustrative and is not exhaustive and that persons of ordinary skill in the art will understand that embodiments in accordance with this invention may be practiced without such specific details.

### 1.1 Execution:

Execution corresponds to day-to-day activities for Managing Trailers and Shipments across the Supply Chain

### Status Quo/Issue:

Different data models for Trailers across Corporations or within a corporation
Different data models for Shipments across Corporations or within a corporation
Independent management of Trailers and Shipments (by Local Operations and HQ Transportation)
Redundant Trailer/Shipment data entry across locations
Redundant Trailer/Shipment data entry in each location

### Exemplary Embodiments

Least common denominator data model for Shipments (a set of states)
Least common denominator data model for Trailers (a set of states)
Ability to extend the Trailer data model with additional states on a per Location basis
A mapping from “many” Trailer states to “one” Shipment state on a per location basis
Allowing locations to manage trailers and trailer state transitions as they see fit—eliminate local redundancy
Eliminate local redundant Trailer/Shipment data entry—Shipment derives its state
Managing Shipments indirectly across the supply chain—eliminate redundancy across the supply chain and provide visibility
Shipments as conduit to carry information from site to site and provide visibility across the supply chain
One controlled copy of the Shipment, Single Source of Truth
Define valid states for Check-in and check-out states for Trailers/Shipments
If Trailer state is defined by attributes that can take on multiple values, not all attribute-value combinations need to be valid
Ability to define valid/exception Trailer states
On the Shipment not every transition may be valid, some may be modeled exceptions, other unmodeled exceptions

### Status Quo/Issue:

A trailer attribute may not be in the least-common denominator data model across all sites that are relevant in a large subset of Locations

### Exemplary Embodiments

Introducing an extended set of states to Trailers that are relevant to a subset of Locations but not all
Enabling each site to declare extended states it is interested in
Copying extended Trailer attributes/states into the Shipment
Making extended Trailer attributes/states visible at a Location through the Shipment, as per the location's specification

### Status Quo/Issue:

No clear way separating Trailer Visits/Shipments:
   that are performing or have performed to plan
   that failed to perform to “positive path” plan, but have/had modeled/understood exceptions
   that had serious unmodeled exceptions during execution
As a result calculating “average” key performance indicators (KPIs) and performance metrics that are meaningless due to high standard deviation—i.e. a few outliers
Limited ability to adorn Trailer Visits/Shipments by state/type to analyze them separately, e.g. Live/Drop; arrive loaded-left loaded vs. arrived empty-left loaded.

### Exemplary Embodiments

A generalized data model on Trailer Visits/Shipments that includes the notions of:
   positive-path operation
   operations with known/modeled exceptions
   operations with exceptions that are not modeled
Ability to report on the number of Trailer Visits/shipments that fall in each of the three operation categories
Ability to analyze/report KPIs/Performance statistics in each group separately
Ability to capture Trailer Visit/Shipment adornments. For purposes of understanding herein, adornments may mean states:
   as check-in state
   as check-out state
   as visit type
   as Shipment type
   other
Ability to report on the number of Trailer Visits/shipments that fall into adornment categories
Ability to report KPIs/Performance statistics in each adornment group separately
Ability to set performance targets and report Trailer Visits/Shipments/Locations that are within the KPI or outside it

### Benefit:

Uniform visibility of Shipment state across the supply chain with minimal redundant data entry
Ability to have meaningful and detailed numeric KPIs and metrics that are not skewed by outliers

### 1.2 Monitoring:

Monitoring is collective set of activates the progress of Trailer and Shipments in real time with Dashboards, Alerts, and Notifications, observing metrics and KPIs and taking action as appropriate. Access to meaningful statistics is essential for success. Essentially monitoring forms a layer of abstraction on the details of execution details to allow appropriate users to control proper operation.

### Status Quo/Issue:

Information about Shipments scattered across multiple IT systems
No generalized way of monitoring timeliness

### Exemplary Embodiments

Operational Users that operate on the physical Trailer and indicate state change
Shipment state change, direct or derived from trailer state change
Use of “time” attributes that mark state change
Use of “planned” and “estimated” time fields to remain in a given state and to make a state transition at a given time point
Generalized monitoring tool that alerts
   If too long in a given state—more than a percentage/interval above the allowed time in state
   If transition does not take place within an interval after the expected transition time
   Pre-warning within an interval before the expected transition time
Auto-adjustment of estimated transition times based on past progress
Leverage data model that distinguishes Trailers, Trailer Visits, Shipments that have been performing
   positive-path operation
   operations with known/modeled exceptions
   operations with exceptions that are not modeled
Leverage data model that can capture adornments
Ability to report on the number of Trailer Visits/shipments that fall in each of the three operation categories
Ability to monitor/analyze/report KPIs/Performance statistics in each group separately
Ability to monitor/report on the number of Trailer Visits/shipments that fall into adornment categories
Ability to report KPIs/Performance statistics in each adornment group separately
Ability to set performance targets and report Trailer Visits/Shipments/Locations that are within the KPI or outside it

### Benefit:

Ability to intervene and plan both for positive path operation as well as for exceptions for more efficient operation

### 1.3 Analysis:

Analysis looks at past performance with reports and dashboards, looks at metrics and KPIs, planes process changes and resets KPI targets for optimization for Shipment/Trailer Visit Management. Access to meaningful statistics is essential for success.

### Status Quo/Issue:

Information about Shipments scattered across multiple IT systems
No generalized way of analyzing “Trailer Visit”/Shipment timeliness and performance and overall optimization

### Exemplary Embodiments Uniform Analysis

Operational Users that operate on the physical Trailer during the “Trailer Visit” and indicate state change
Shipment state change, direct or derived from trailer state change
Use of “time” attributes that mark state change
Use of “planned” and “estimated” time fields to remain in a given state, and to make a state transition at a given time point
Generalized analysis tool that reports on Shipments/Trailer Visits
   If too long in a given state—more than a percentage/interval above the allowed time in state
   If transition does not take place within an interval after the expected transition time
   Pre-warning within an interval before the expected transition time

### Exemplary Embodiments: Ensuring the Analysis is Targeted at Meaningful Information

A generalized data model on Trailer Visits/Shipments that includes the notions of:
   positive-path operation
   operations with known/modeled exceptions
   operations with exceptions that are not modeled
Ability to report on the number of Trailer Visits/shipments that fall in each of the three operation categories
Ability to report KPIs/Performance statistics in each group separately
Ability to capture Trailer Visit/Shipment adornments
   as check-in state
   as check-out state
   as visit type
   as Shipment type
   other
Ability to report on the number of Trailer Visits/shipments that fall into adornment categories
Ability to report KPIs/Performance statistics in each adornment group separately
Ability to set performance targets and report Trailer Visits/Shipments/Locations that are within the KPI or outside it

### Benefit:

Ability to plan for more efficient operation in the future both for positive path operation as well as for exceptions
Ability to better model exceptions by better understanding unmodeled exceptions and categorizing and modeling them
Ability to modify KPIs, metrics, and standard operation processes for Shipments and Trailer Visits of different type and introduce new ones to increase overall productivity as set by business objectives

### 2 An Exemplary Least Common Denominator Model

### 2.1 Terminology

For purposes of understanding embodiments herein, the following terminology may be defined as follows.
Trailers, Drivers, and Tractors are assets with static characteristics;
Each check-in/check-out of a Trailer or Driver to a Site constitutes a Trailer Visit or Driver Visit;
A Shipment starts in one Site, e.g. From-Site, and ends in another Site, e.g. To-Site;
Visits and Shipments exist for short durations;
During A Trailer Visit, a Trailer is associated with:
   one Inbound Shipment, more specifically the To-Site of that Shipment; and
   one Outbound Shipment, more specifically the From-Site of that Shipment; and
   A Driver which brought it in
   A Driver which took it away
Sites, Trailers, Users, Drivers, may all belong to Corporations

Typically, there are different data models for shipments across corporations. For purposes of understanding herein, a trailer visit is a journey from gate to gate and a shipment is a journey from one yard to another yard. Thus, people who manage the trailers are considered to be inside the yard, sometimes referred to as the “four fences,” whereas people who manage the shipments may be at headquarters.

Typically, there are degrees of redundant trailer and shipment data entry and management both in a given location and across a network. It should be appreciated that one cause of such different data entry and management are a result from having different types of customers. Typically, a user enters the data, ships the shipment to destination at which such data is entered in a destination system.

Thus, to address this issue, the system provides a least common denominator data model for shipments such that the shipping entities, the destination entities, the carrier, and headquarters can all know what is progress on a particular shipment. Importantly, in an embodiment, shipping data or shipping states map to the trailer states. For example, a person managing the trailer may be looking at the data and ask, “Is this trailer empty or loaded?” He is not thinking about shipments. He is asking, “Is there something in the trailer?” Thus, such person needs to be able to know, for example, “No, this is empty now,” without understanding the shipment. Meanwhile, if the trailer just got unloaded, the corresponding shipment gets closed because it just got accepted. As well, if the trailer starts getting loaded with the next shipment, that shipment needs to start in the system. Thus, with the system, users can just look at their work and, at the same time, the big picture viewpoint gets updated.

### 2.2 The Model

As discussed hereinabove, a novel and inventive least common denominator model is provided. To understand the model and, in particular, the schema of the data depicted in the model, a description of basic concepts is provided. Regarding basic concepts, for example, shipment, a typical work flow may include: start with a shipment, select an appropriate trailer, assign the shipment to the trailer, move the trailer to a dock door, load the trailer, have the trailer be picked up, drive the trailer to its destination, unload the trailer at a dock door, and then close the shipment. The trailer visit version of this flow includes but is not limited to the trailer arriving at the source yard, the trailer is emptied, and then such trailer is loaded with the shipment and sent out. The trailer may arrive empty to be loaded and leave loaded. Or, the trailer may arrive loaded and leave empty. As well, there are exception cases. For example, the wrong load arrives or the yard never needed a particular extra empty trailer to send out anything. In general, things are loaded, things are unloaded, and things go wrong.

Such operations may be a matter of perspective in terms of the from-site, the two-site, and the headquarters view of the world. For example, given a trailer, as far as the from-site is concerned, there is a load that is outbound, i.e. it is going out. The from-site recognizes it has a trailer that is empty and assigns a shipment to it. This to-site has the viewpoint that, “a shipment is going to come into me. It's empty in the source facility.” As far as the individual at headquarters is concerned, the shipment is in an empty, unassigned state and knows what trailer the shipment is being placed. Nothing else has started.

Another approach to viewing the above-mentioned activity is the following progression, in accordance with an embodiment. The trailer is outbound loading, outbound loaded, pending departure, and at the checkout. Then, it's en route. it's checking in, recent departure. It should be appreciated that once it's en route, the individual at the from-site knows the trailer or shipment has left; it's going. As far as the individual at the to-site is concerned, the trailer or shipment is coming in. Once it checks in at the to-site, individual at headquarters may say, “Hey, the thing I shipped is actually at the destination.” Such information may be important to headquarters or the individual at the from-site because such person may be getting that trailer back eventually.

In an embodiment, a carrier perspective is addressed. For example, by using one or more embodiments herein, a dispatcher at the carrier headquarters may see the trailer begin loading and ensures that the driver arrives at the site on time or, alternatively, accelerates or delays the driver arrival time at the site as appropriate. The driver may be able to make these adjustments on the ground in real time. The site and the driver coordinate to ensure a most expeditious processing of the driver inside the facility. Once the trailer is picked up, as the driver is driving to the destination, the driver may provide arrival time updates. The destination site itself may participate in the collaboration, may instruct the driver to arrive earlier or later. At the same time they make the preparations to process the driver most expeditiously.

Thus, embodiments herein enable two or more sets of operators inside the facility and at headquarters to communicate in the same language. A least common denominator model (“system”) is provided that enables such operators to perform their roles, their jobs, via one system and one record of the data that are updated in a way that is consistent with each role. That is, embodiments herein determine, model, and use the least common denominator informational data on which everyone agrees. As well, embodiments build in flexibility such that other role players or even the same role players may extend the system by customizing particular aspects to their benefit while maintaining the shared model.

### 2.3 A Plurality of Perspectives

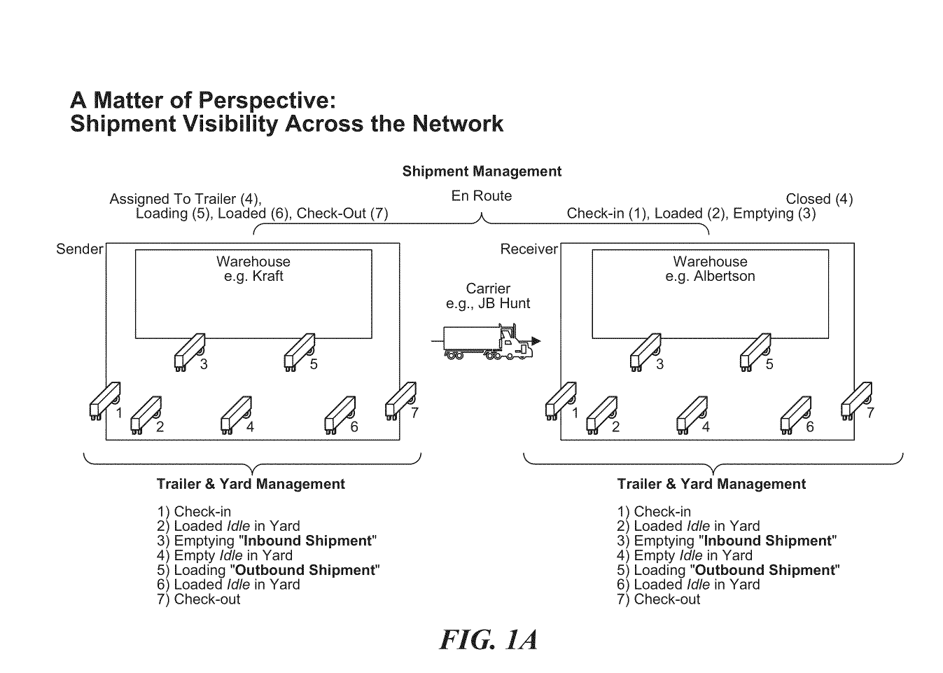

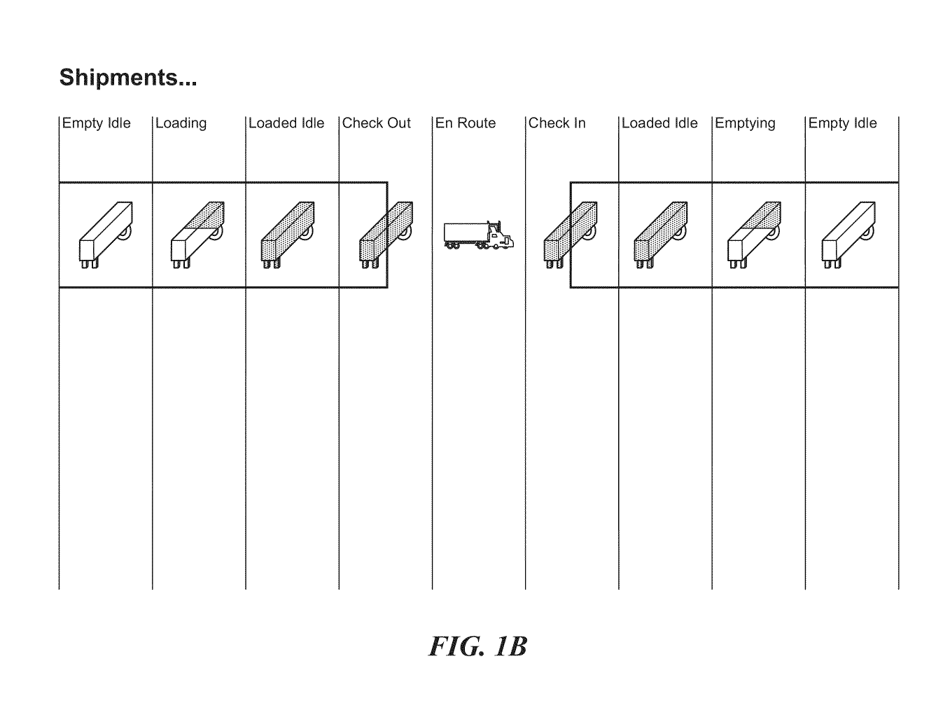

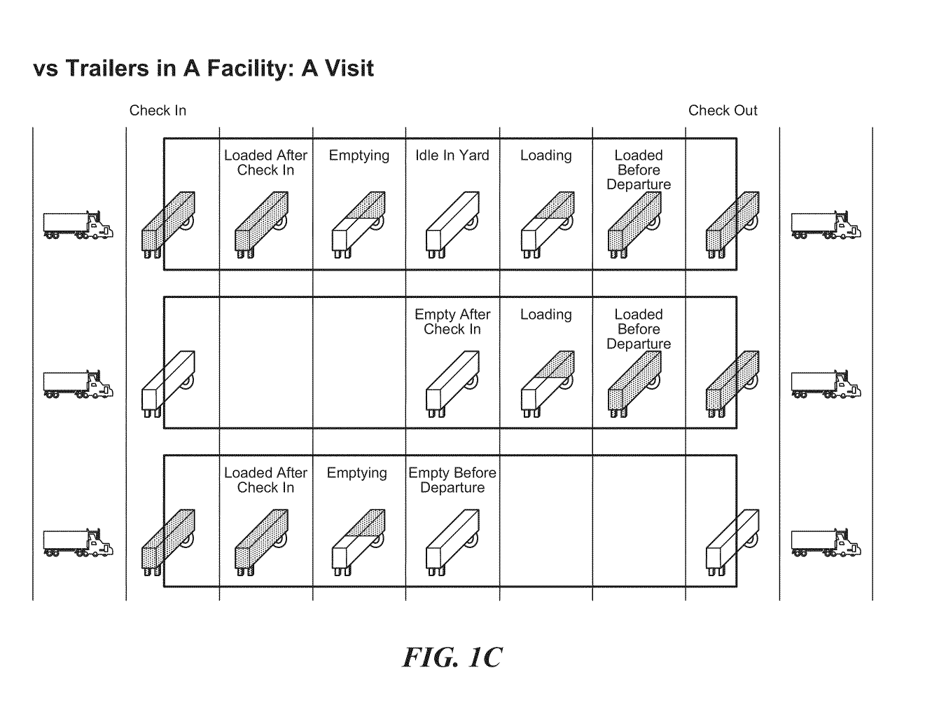

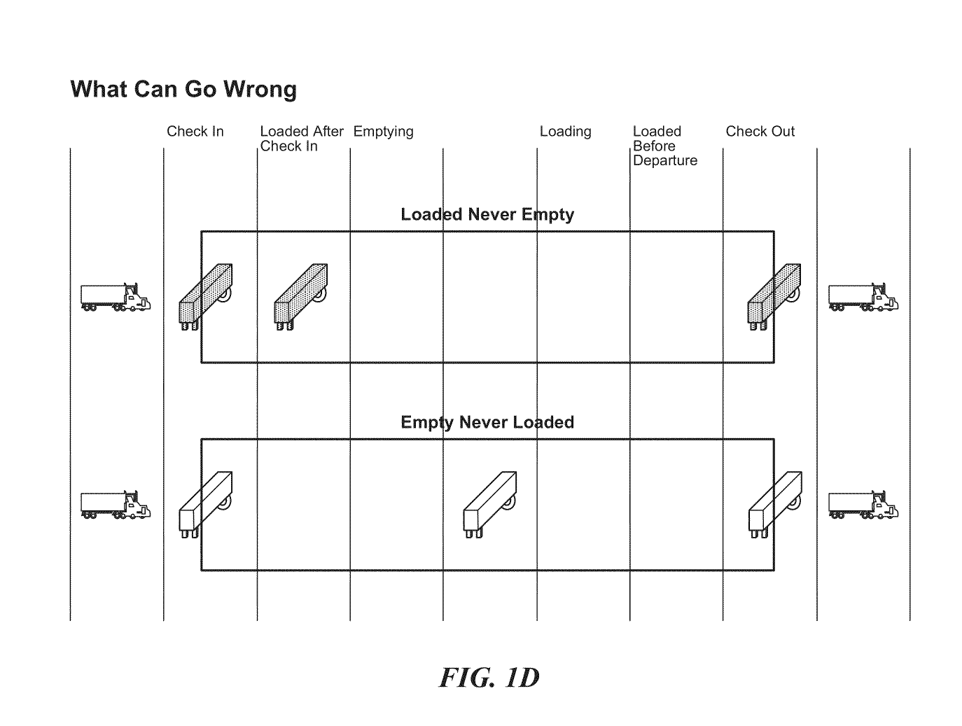

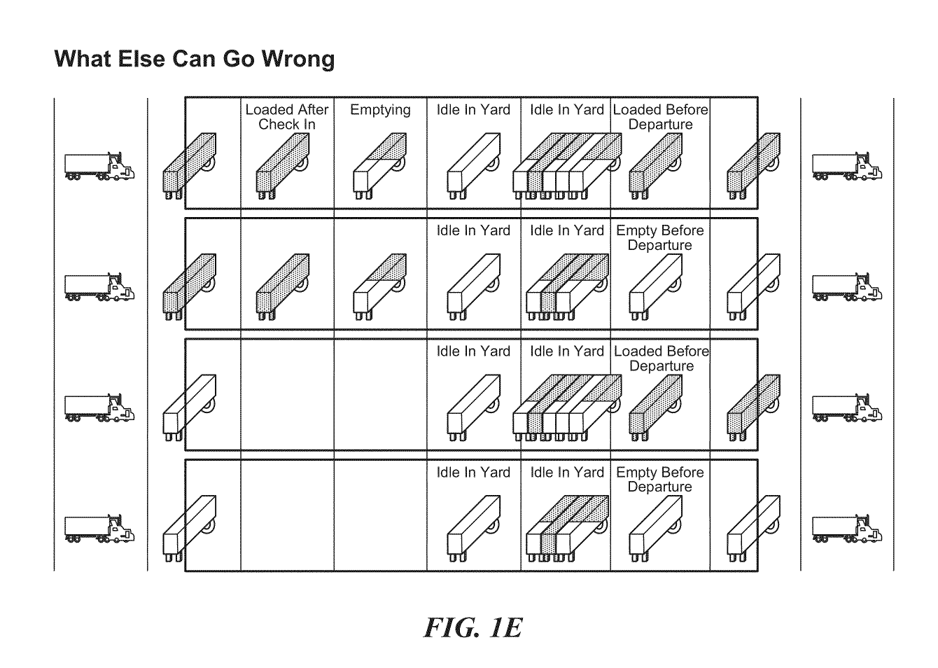

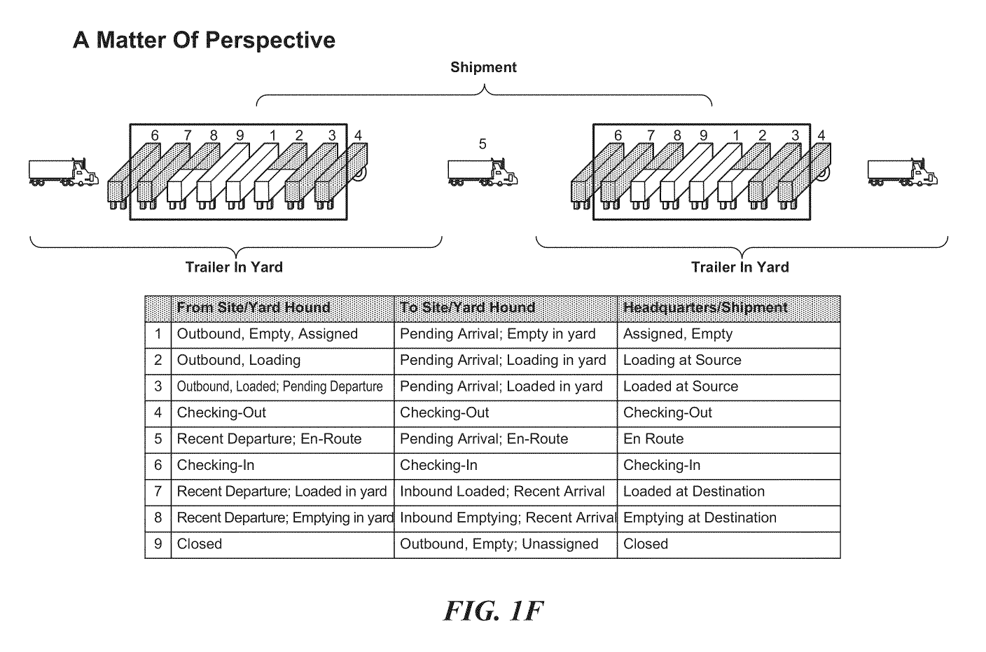

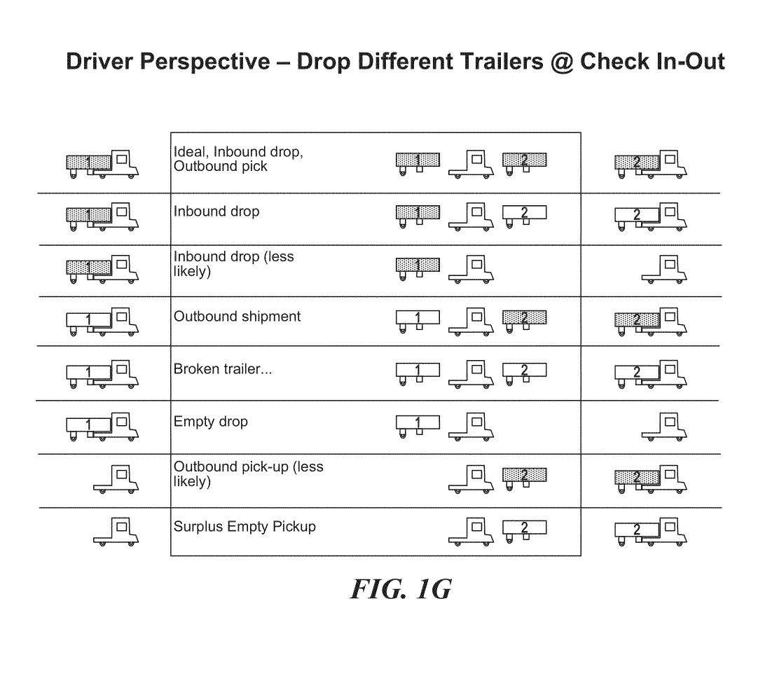

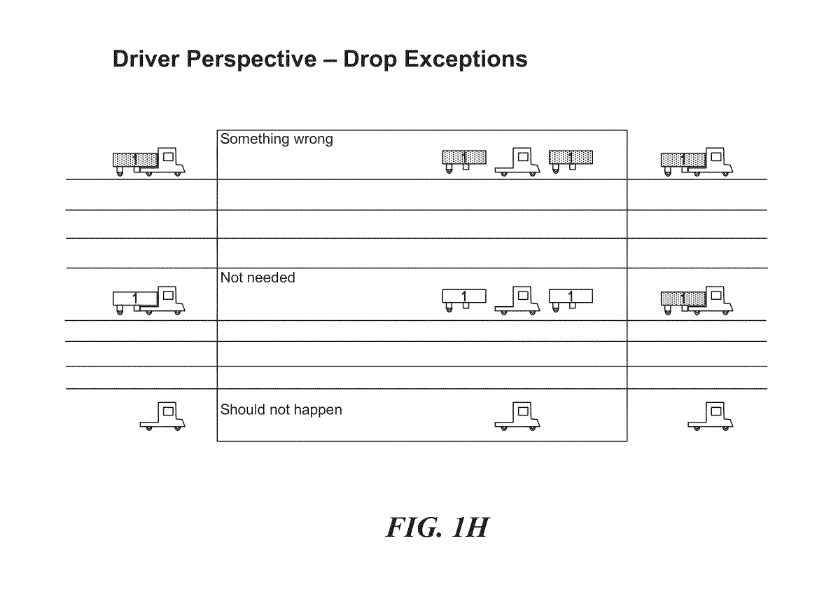

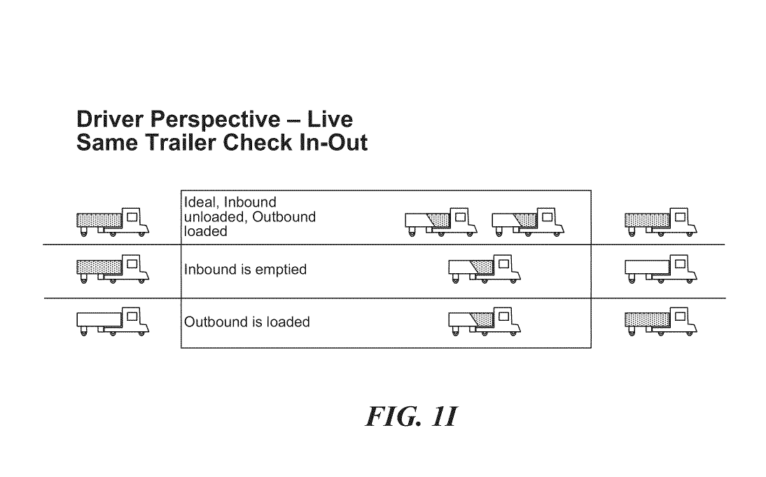

Embodiments of the invention to enable shipment visibility across a shipping network and the different perspectives of different roles thereof may be understood with reference to FIGS. 1A-1I, respectively. FIG. 1A is a schematic diagram showing seven steps from a shipping management perspective of either yard, such as from a headquarters perspective. For example, shipping management steps from Load Status perspective may include but are not limited to: assigned to a trailer (4), loading (5), loaded (6), check-out (7), en-route, check-in (1), loaded (2), emptying (3), and closed (4). As well, the system provides visibility to trailer and yard management activities from Load Status perspective including but not limited to: check-in(1), loaded idle in yard (2), emptying “inbound shipment” (3), empty idle in yard (4), loading “outbound shipment” (5), loaded idle in yard (6), and check-out (7). FIG. 1B is a schematic diagram illustrating the various states of a shipment. FIG. 1C is a schematic diagram illustrating the various sequence of states (state trajectories) of trailers in a facility also referred to as a trailer visit. FIG. 1D is a schematic diagram showing two cases when something undesirable occurs, such as for example, a trailer arrives loaded and is never emptied or a trailer arrives empty and is never loaded. FIG. 1E is a schematic diagram illustrating what else can go wrong during trailer visits inside the yard while loading/unloading. Later, these undesirable trajectories form modelled and unmodelled exceptions. FIG. 1F is a schematic diagram presenting event states and trajectories from the perspective of “from-site/yard,” “to-site/yard,” and “headquarters/shipment.”

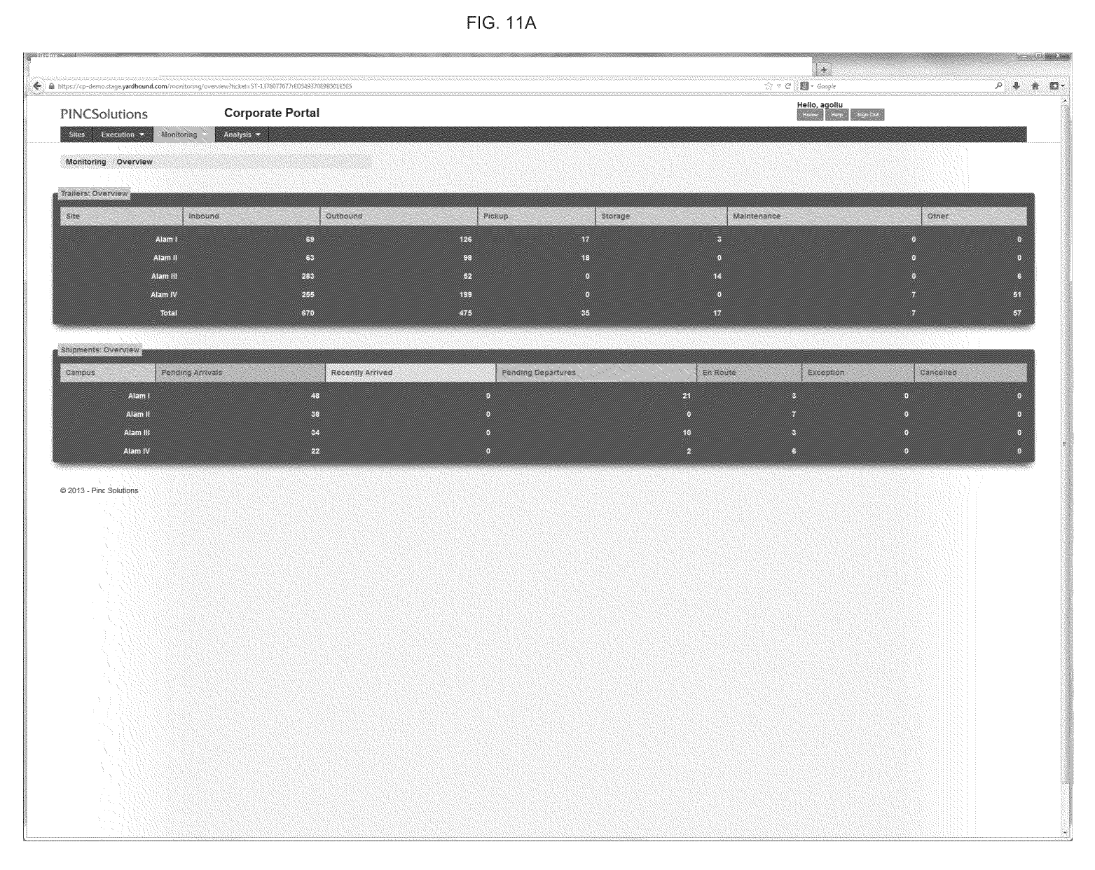

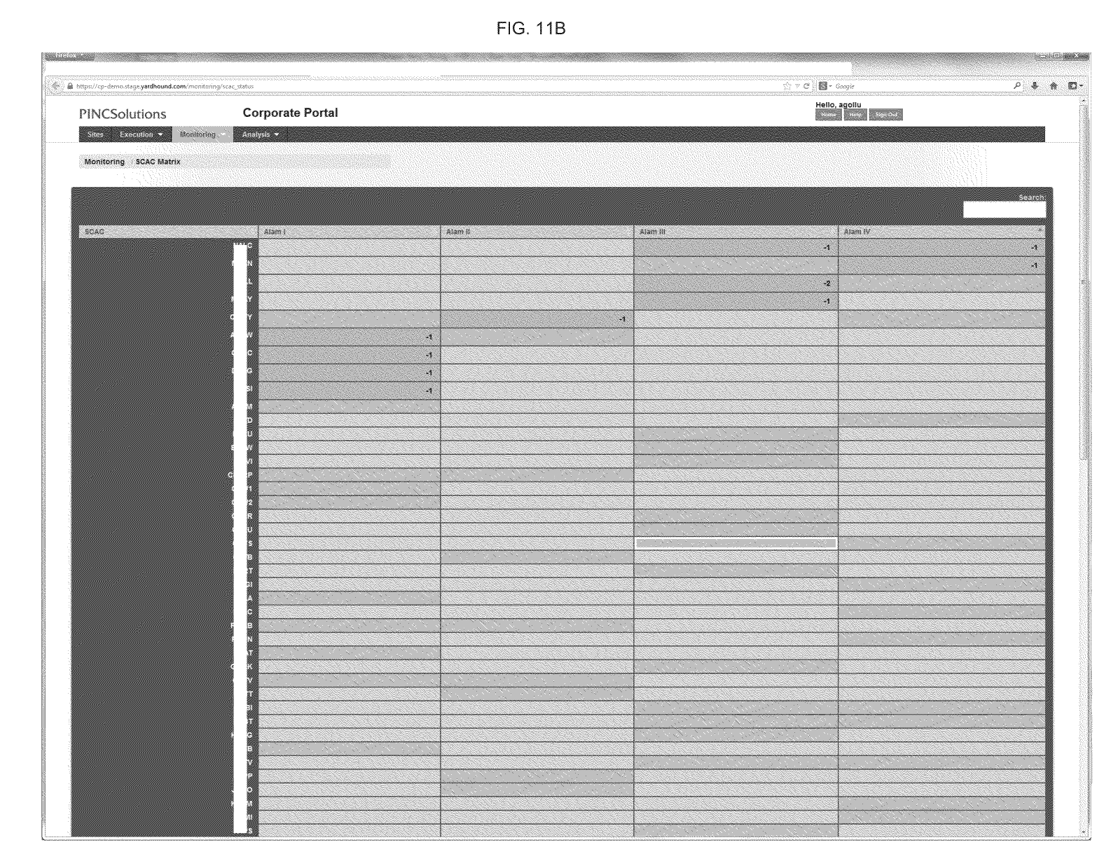

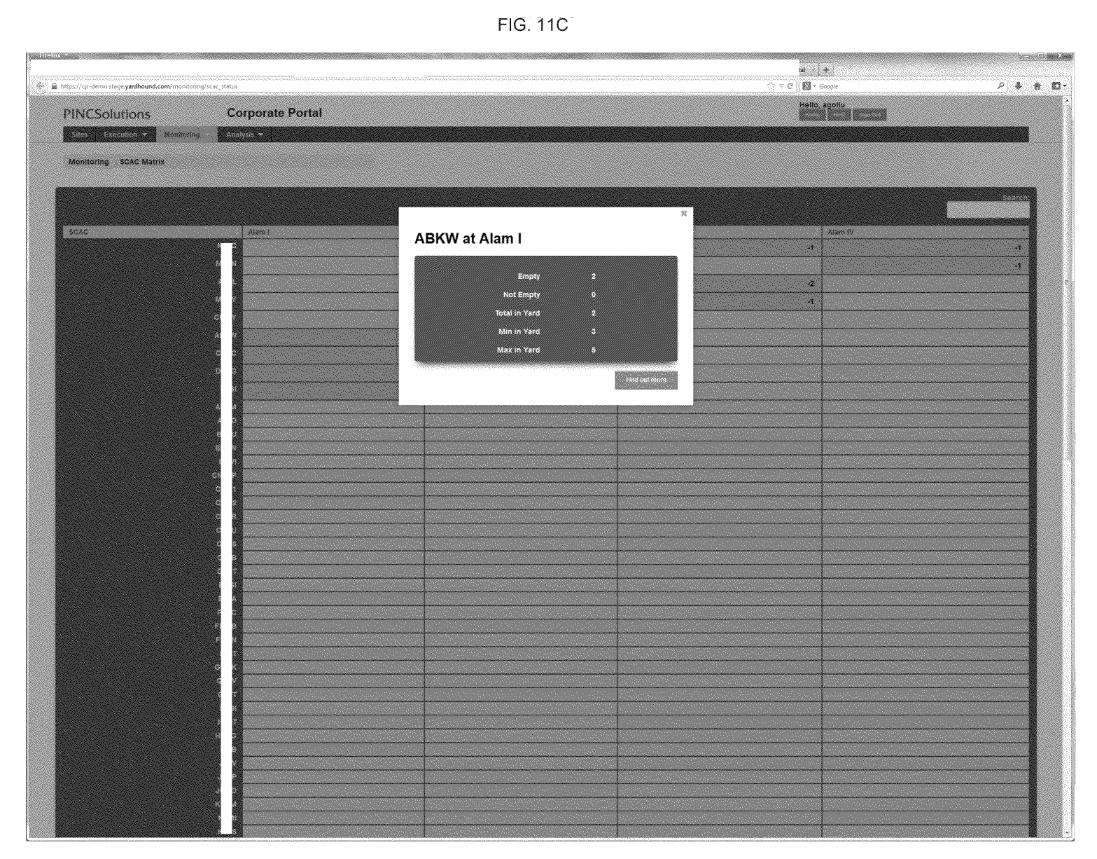

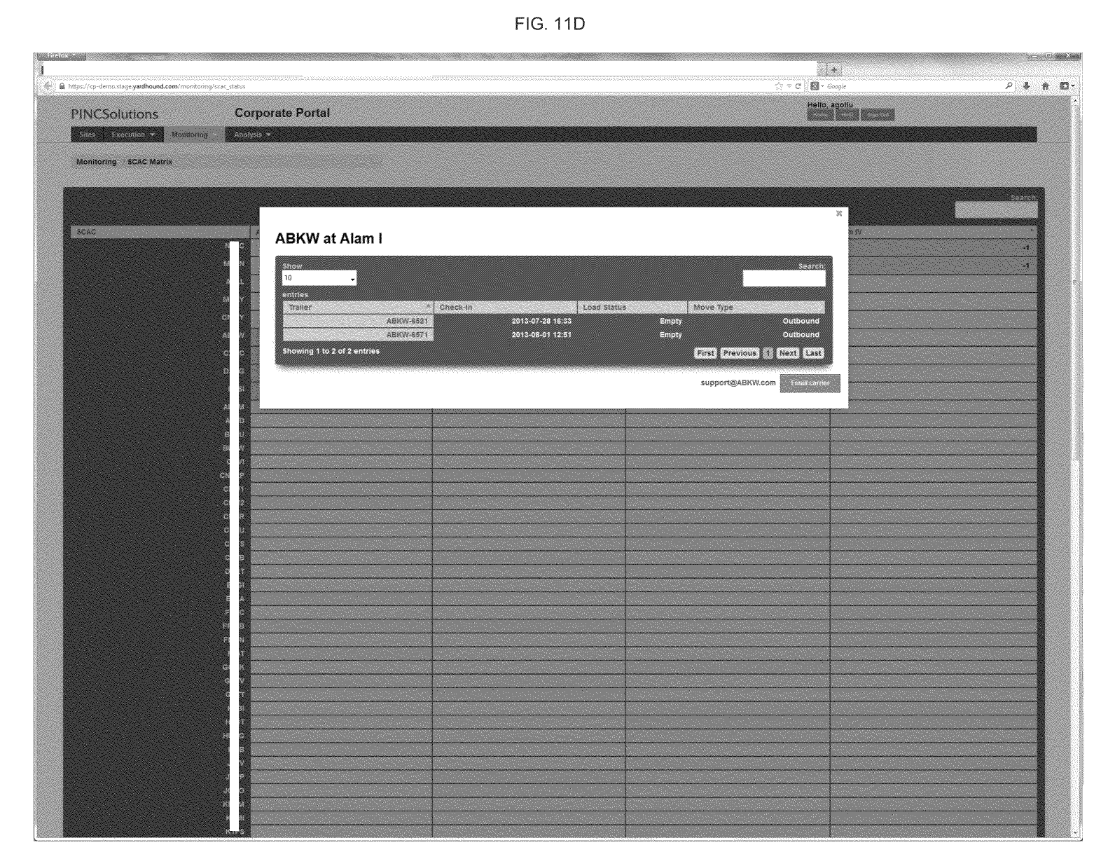

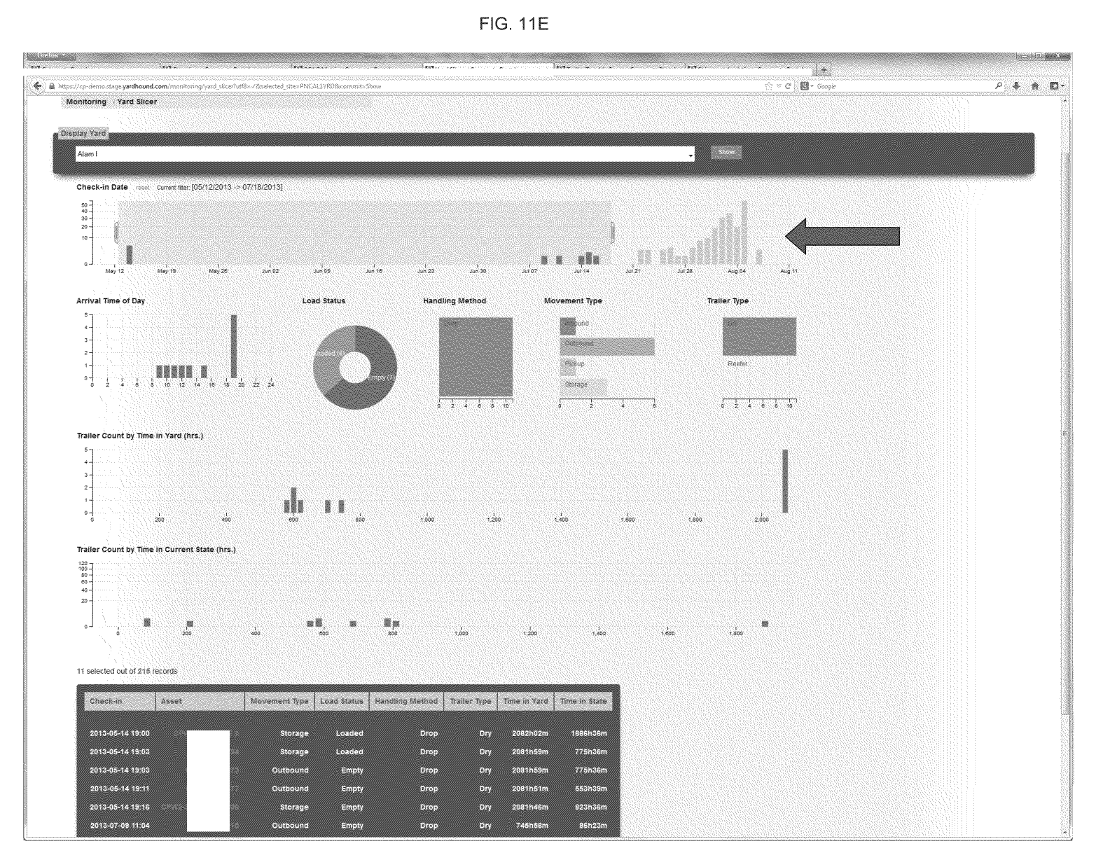

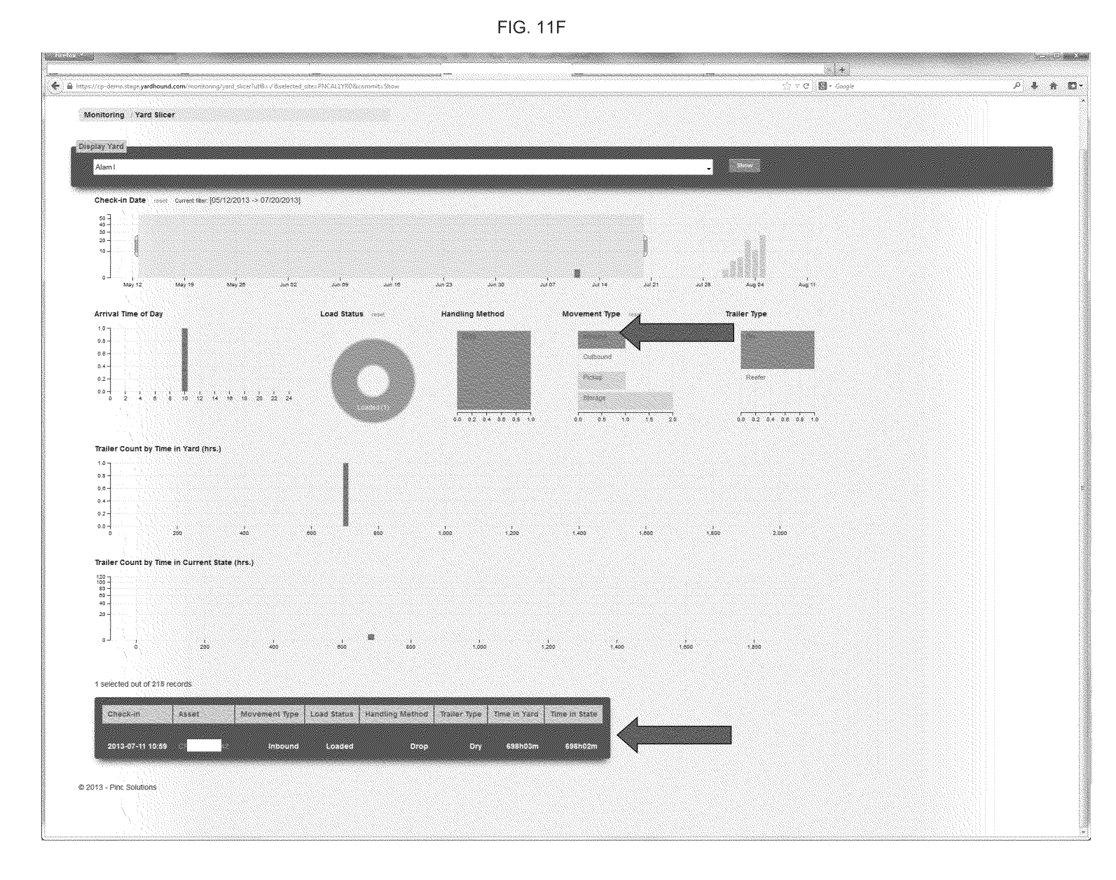

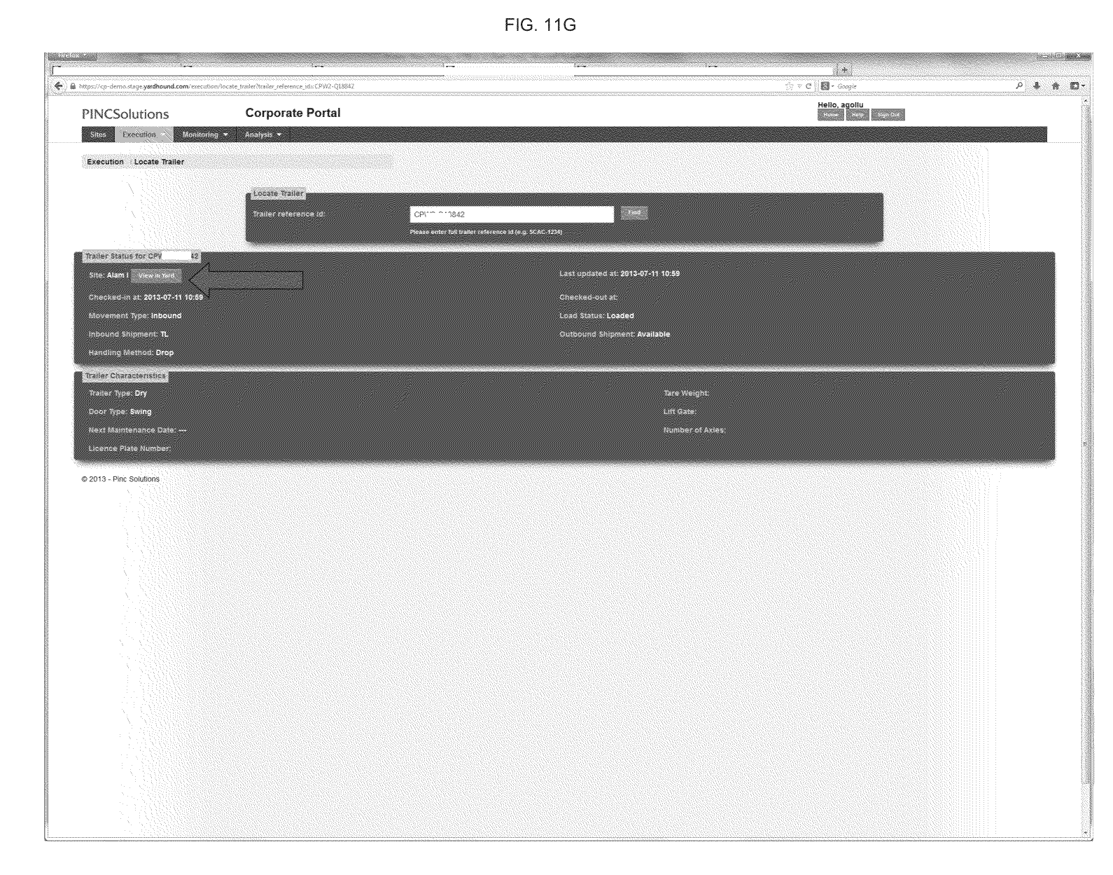

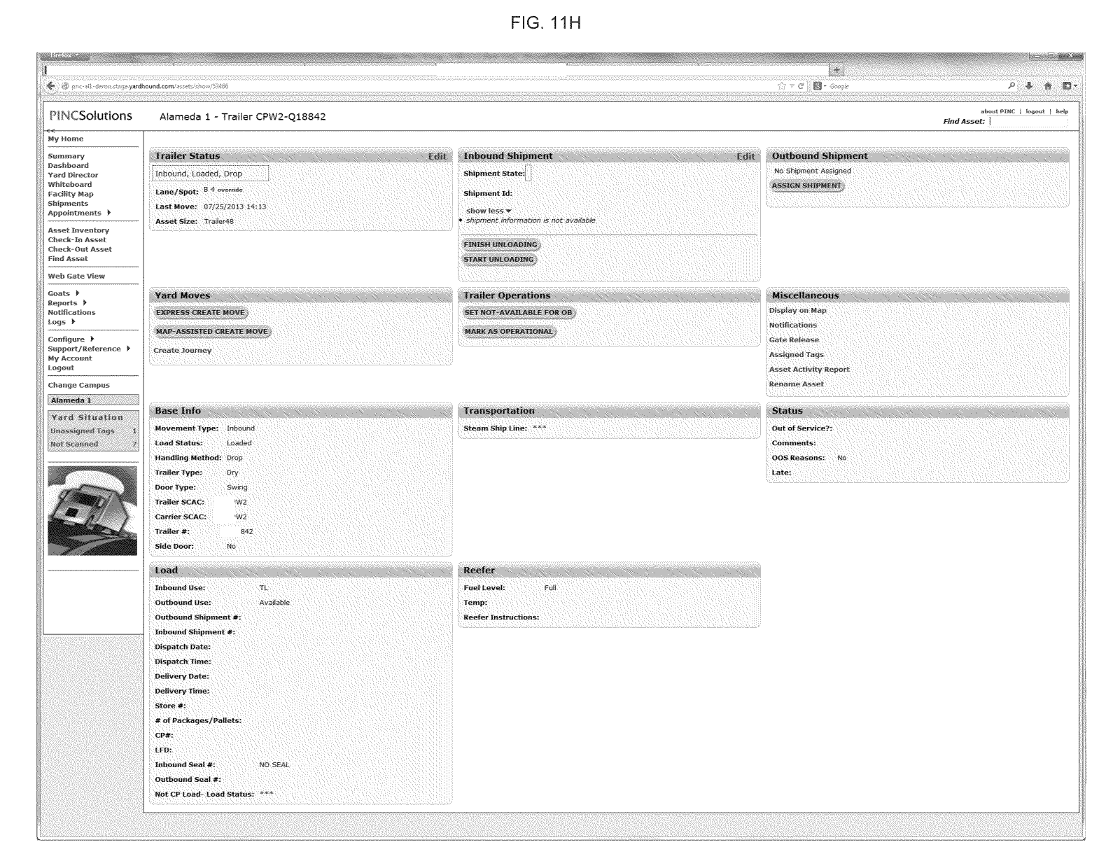

FIG. 1G is a schematic diagram illustrating the different trailer states for a drop load, in which the driver arrives with one trailer and leaves with a different trailer. FIG. 1H is a schematic diagram illustrating drop load exceptions when things went wrong or are undesirable. FIG. 11 is a schematic diagram illustrating live drop event states.

These are the state trajectories from the driver or tractor perspective during the driver or tractor visit.

### 2.4 how Least Common Denominator Provides Common Visibility

Embodiments herein provide common visibility across the supply chain using the least common denominator model, which enables accurate and real time assessment of a shipment from one facility to another as viewed by each facility and headquarters, as follows. As an example, consider a shipment that needs to go from the source facility to the destination. Somebody who is in charge of shipments has to assign that shipment to a trailer. Somebody at the destination views, via the system, that there is progress; shipment is assigned to a trailer. The trailer then is ready to be moved to the dock so that it can be loaded.

In an embodiment, a user may create a move. The user may view a pending move. That is, the user may be the person at the dock door who's going to load the trailer. As well, a person inside the yard truck may view the move. A yard truck is a small truck inside the yard that moves trailers back and forth, very much like a regular truck, but smaller. There may be a person inside the yard truck who needs to execute the move. Thus, via the system, he accepts the move. Subsequently, he completes the move. At that point, in the example, the system shows a trailer that's outbound empty and that needs to leave.

In an embodiment, it is possible to continue operating on such trailer via the system. The system may show that the trailer has started loading and then that it is outbound loaded. It finished loading. A next move may be created. Such move may reflect that the trailer is parked back in the yard and that it is ready to leave. In the embodiment, users of the system at the other end, e.g. destination, are able to view the progress. As well, via the system, users may view that the load is ready to be picked up, the driver arrives with another empty trailer, and the driver is going to drop the empty trailer and pick up this loaded trailer.

Continuing with the example of the embodiment, the carrier picks up the trailer at the gate and leaves. At the destination facility, the users of the system are enables to view such progress. Then there is a check-in when the trailer arrives. Enabled by the system, the source facility now knows that the shipment is at destination. The operators at the destination empty the trailer. And, the shipment is closed.

It should be appreciated that in accordance with embodiments herein the trailer and trailer status inside the facility and the shipment and shipment status have been effectively modeled in such a way that all players understand the model. Thus, even though, for the trailer, people may employ a particular local lingo, the system enables a universal way of approaching communication of a shipment.

Further, in an embodiment, an individual site may employ a much more complex and extended model for the state of the shipment or the trailer. Such local details may be extracted by mapping appropriately the local states to the least common denominator model.

2.5 Shipment Legs vs. Shipment Routes

There are multiple prevailing definitions of the word shipment in the industry today. Sometimes it refers to the goods in the trailer as it is driven from one site to another, sometimes it is a load tendered to a carrier that consists of multiple stops, and sometimes there may be multiple shipments in the trailer.

In practice shipments may often consist of multiple legs. For example, a particular shipment may consist of multiple legs where shipment starts with an empty trailer at a first facility, where items may or may not be loaded onto the trailer, e.g. the facility may be only supplying an empty trailer. Then, over a sequence of facilities, each facility may or may not unload or load items onto the trailer until the trailer arrives at a last facility, where the shipment ends. The last facility may be where the trailer is completely emptied or may be to where the empty trailer is ultimately delivered.

For purposes of understanding herein, a shipment (more precisely a shipment leg) may be limited to a trip between two sites, the source site and the destination site with a given load. As such it is independent of the initial origin and the ultimate destination of the load or shipment route. In a given leg, the source may have added to the load, and the destination may have subtracted from the load.

It should be appreciated that for purposes of understanding herein, a single shipment may consist of multiple bills of lading that correspond to multiple purchase orders.

For brevity, the remainder of the discussion herein may be on shipment legs (referred to as shipments for brevity) and correspond to a trailer load (in the industry referred to as TL) with the understanding that shipment routes may be constructed from shipment legs and that, at each leg, multiple bills of lading or purchase orders (in the industry referred to as LTL) may be processed.

### 2.6 Site Customization

An embodiment provides customization of the system per each location or site. That is, in an embodiment, the least common denominator model may not capture data about every aspect that may be important to a user. For example, a particular site that manages refrigerated trailers needs to be able to say, “Look, there are refrigerated trailers, and there are dry trailers. And my refrigerated trailer has three compartments, and I load my refrigerated trailer across three different dock doors in my facility, because there is the extremely cold, there is the cold, and there is the zero degree Celsius stuff. I will pick them up from different parts of my warehouse.” Another user at another site with refrigerated trailers may not have that; for example he may ship out everything at minus-4 degrees Celsius. Such person may just park such trailer at the dock door and load it.

It may well be that the source facility consists of a very large warehouse, where goods that must be shipped at different temperatures are loaded across different dock doors. In this case, the loading sequence and related process flows through operations may be modeled to track progress across multiple loads. The loading sequence across doors may be strict or one may load the trailer at an arbitrary sequence. In an embodiment, at the destination facility, tracking such detail may be unnecessary, when using the least common denominator model, the destination facility knows that the loading has started and that there is an estimated time of departure, and hence an estimated time of arrival, for the trailer. Conversely once such trailer arrives at the destination facility, the facility may have a smaller warehouse, which may unload the trailer at one single dock door and distribute the goods appropriately in the warehouse. Again, to the source the relevant piece of information is the acceptance of the delivery of the shipment, not the detailed sequence of the unloading of the trailer, which is addressed by embodiments herein. Across the network, the receiver of such shipments may not care about such level of detail, while that level of detail, i.e. in the way the trailer is handled, may be important at the yard. The person at the yard may need to move such trailer from dock door to dock door. Thus, an embodiment extends the trailer data model. That is, from the system point of view, the trailer entity has a more detailed state space than the shipment entity.

### 2.7 An Exemplary Data Model

In an embodiment, the following guidelines are incorporated into the data model:
One simple Shipment Data Model across all sites;
One Core Trailer Data Model across all sites;
   Plus: Each site can extend their Trailer data model;
One Core Driver/Tractor Data Model across all sites;
   Plus: Each site can extend their Driver/Tractor data model;
Individual Yards continue managing Trailers;
“Keep it Simple” for local yard operational users, because without such users, the situation may be “Garbage In Garbage Out”; and
Central personnel gains visibility to and manages Trailers and Shipments.

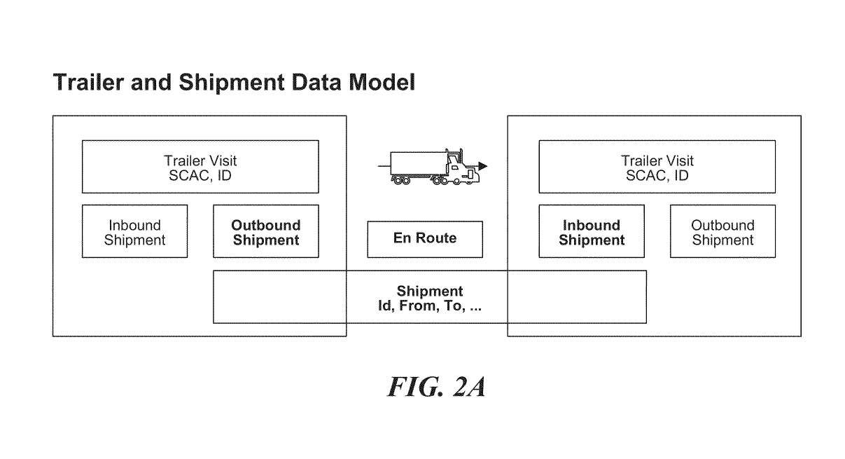

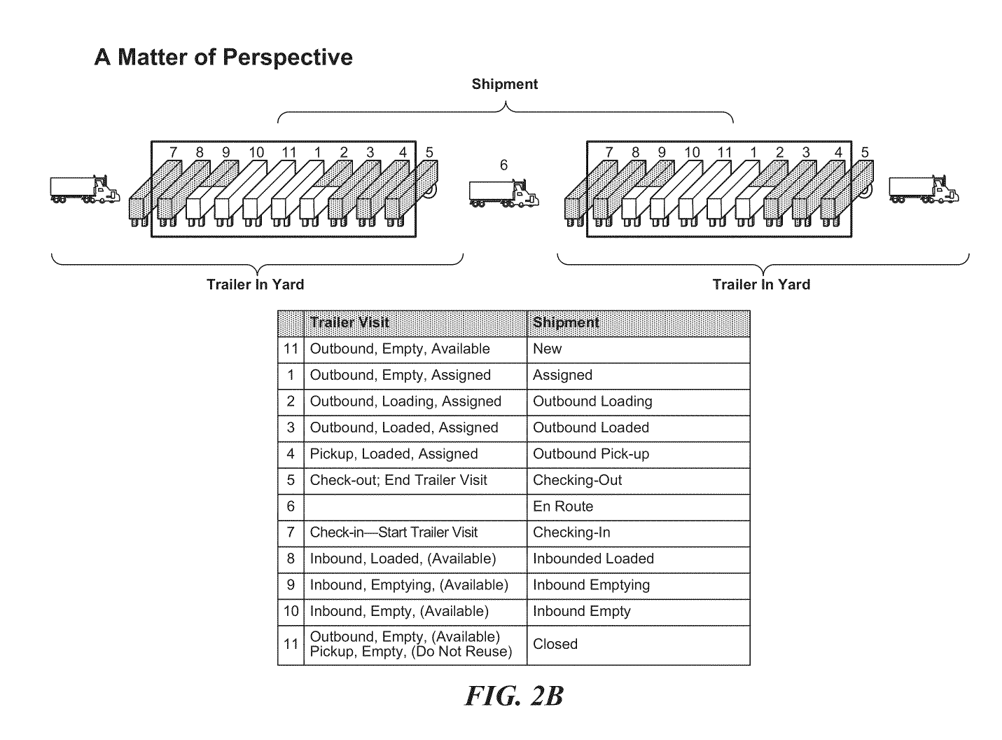

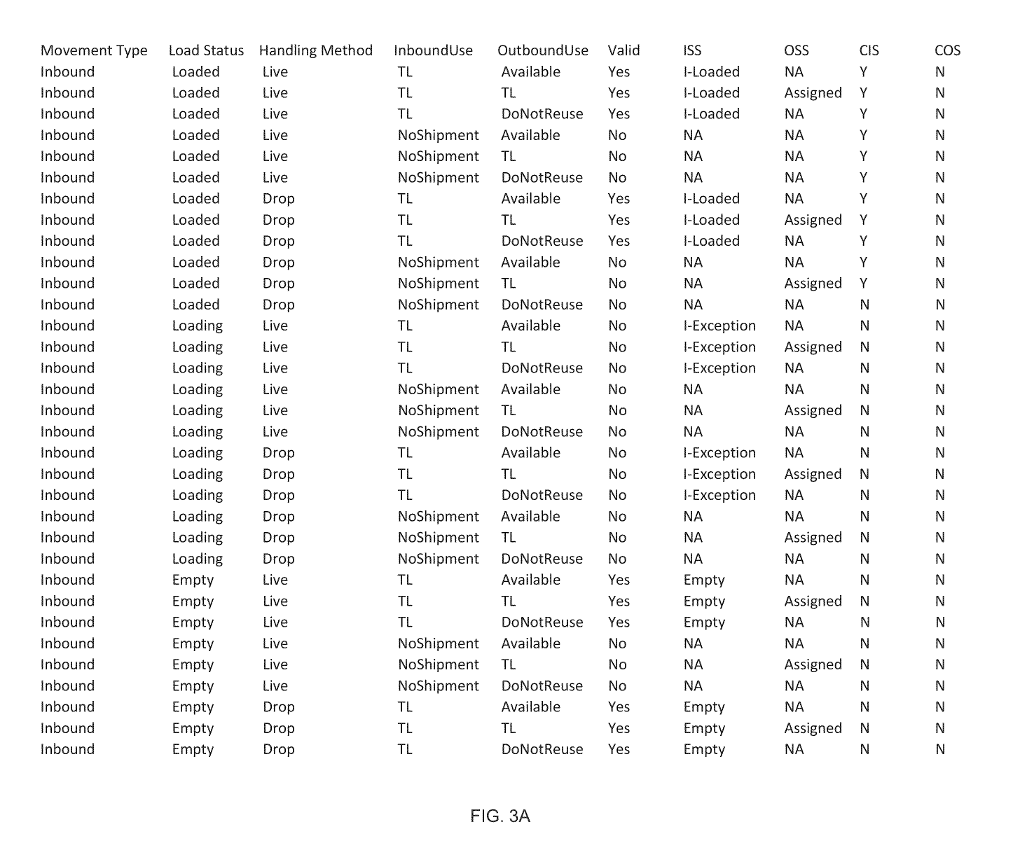

An embodiment can be understood with reference to FIG. 2A, a schematic diagram showing a trailer and shipment data model at a high level. At each gate/yard, particular data pertaining to that gate/yard are required. Examples of such data include but are not limited to trailer visit data, inbound shipment data and outbound shipment data. Example of required trailer visit data may include but are not limited to Trailer ID and Standard Carrier Alpha Code (SCAC). Data that pertain to across the network or when the shipment is en route may include but are not limited to shipment ID and data about the from-site and the to-site.

2.8 Trailer vs. Trailer Visit

One model in accordance with an embodiment differentiates between the actual Trailer and its Visit to a facility. A trailer has a lifespan of years whereas a trailer visit has a much shorter life span, e.g. hours for a live load, days for a drop load, longer if the trailer is used for storage in the facility.

While the static characteristics of a trailer play a role in its use during a Trailer Visit, typically they do not change during the Trailer Visit. As such the model uses different elements to describe the state and state trajectory of a Trailer Visit.

### 2.9 Trailer Visit—Data Model

In an embodiment, the trailer visit data model may include but is not limited to the following characteristics or attributes:
Trailer Static Characteristics (Does not typically change per visit);
   ID, Tare Weight, Permanent Tag if any, Size, etc.;
System Attributes (Read Only);
   Check-in Time, Check-in agent, etc.;
Trailer Visit Core Attributes (Picklists, where Site cannot add values);
   Load Status, Movement Type, etc.;
Predefined Attributes;
   In the data dictionary, and required
   In the data dictionary, but optional; and
Custom Attributes (Site Defined).

It should be appreciated that in an embodiment some of the above-cited characteristics or attributes may be required by all sites, e.g. some system, static, or core attributes, or that others may not be utilized by all sites.

It should be appreciated that in an embodiment the system is configurable to add trailer state attributes at and for any particular site. The system enables a user to manage an entire evolution of the trailer and count the amount of time spent in each state.

### 2.9.1 Trailer Visit State—Core Attributes

In an embodiment, trailer visit state core attributes may include but are not limited to the following:
Load Status;
   Empty, Loaded, Unloaded, Loading, Partial
Movement Type;
   Inbound, Outbound, Pick-Up, Storage, Maintenance, Overweight, Shuttle, Relay; and
Handling Method;
   Live, Drop.
Out of Service
   Yes, No

### 2.9.2 Trailer Visit State—System Managed Elements

In an embodiment, trailer visit state system managed elements may include but are not limited to the following:
Yard Movement;
   Location: Dock, yard, spot, etc.; and
   Move: None, Pending/Active/Planned Move;
Shipment Relationship;
   Inbound Shipment;
      No-Shipment, Trailer Load (TL); Less than a trailer load (LTL), No Op;
   Outbound Shipment;
      Do not Reuse, Available, TL, LTL, NoOp;
Driver and Tractor Relationship
   Driver/Tractor at Check-in
   Driver/Tractor at check-out

### 2.10 Driver and Tractor Data Model

As with the Trailer, Drivers and Tractors also have static, system, core, predefined, and custom attributes. As with Trailers, the static characteristics of a Driver or Tractor are unlikely to change during a Driver Visit or Tractor Visit. Similarly the state of a Driver Visit and Tractor Visit and their relationship to Trailer and Shipment are modelled with different elements.

In one embodiment the Driver static attributes are given by:
Name
Last Name
Driver License
Birthday
Cell Phone Number
Employer.

In one embodiment the Driver system managed state attributes are:
Check-in Time
Check-out Time.

In one embodiment the Driver relationship attributes are:
Check-in Trailer
Check-out Trailer
Tractor.

Also, as depicted above in FIG. 1G and FIG. 11, the state trajectories of a Driver-Tractor pair differ for drop (different check-in and check-out trailers) and live loads (same check-in and check-out trailer). Otherwise in one embodiment the Driver Visit state may be described as:
At Gate
In Yard w/ Inbound
In Yard w/o Trailer
In Yard w/ Outbound
At Gate
Checked Out.

In one embodiment the Tractor static attributes are given by:
License Plate
DOT Number
Carrier
Number of Axles.

In one embodiment the Driver system managed state attributes are:
Check-in Time
Check-out Time

In one embodiment the Driver relationship attributes are:
Check-in Trailer
Check-out Trailer
Driver.

### 2.11 Shipment Data Model—Identifiers, i.e. a Shipment Leg

In an embodiment, shipment data model identifier information may include but are not limited to the following data:
Basic
   Shipment #;
   From Site; and
   To Site.
Additional
   Master PO #;
   Master BoL #;
   Inbound Appointment #;
   Outbound Appointment #; and
   Etc.

### 2.11.1 Shipment Data Model—Relations

In an embodiment, shipment data model relations may include but are not limited to the following data:
Trailer;
Driver;
Carrier;
Tractor; and
Shipper.

### 2.11.2 Shipment Data Model—System

In an embodiment, shipment data model system functions may include but are not limited to the following:
Create Time;
Create Agent;
Actual Departure Time;
Actual Arrival Time; and
Etc.

### 2.11.3 Shipment Planning

In an embodiment, shipment data model planning attributes may include but are not limited to the following:
Planned Arrival Time;
Planned Departure Time;
Estimated Arrival Time;
Estimated Departure Time;
Inbound Comments;
Outbound Comments;
Planned Loading Time;
Planned Unloading Time; and
Etc.

### 2.11.4 Shipment Statuses for Full Trailer Loads

In an embodiment, characteristics or attributes for shipment statuses for full trailer loads may include but are not limited to the following:
Outbound
   New;
   Assigned;
   O-Loading;
   O-Loaded;
   O-Pick Up; and
   O-Exception.
En route
   Exception—Overweight
Inbound
   I-Loaded;
   I-Emptying;
   I-Empty;
   Closed; and
   I-Exception.

FIG. 2B is a schematic diagram showing how an embodiment synchronizes trailer and shipment states across the From Site and To Site. Trailer states are correlated with Shipment-In states and Shipment-Out states. For example, Check-In Inbound/Loaded is correlated with Shipment-In: Shipment Set, Inbound-Loaded. Regarding Shipment-Out, Check-In Inbound/Loaded is correlated with “Available.”

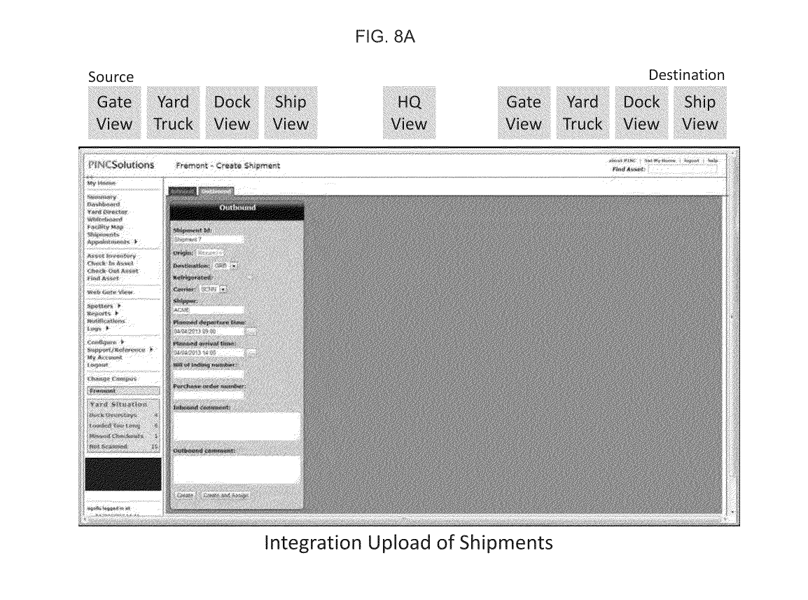

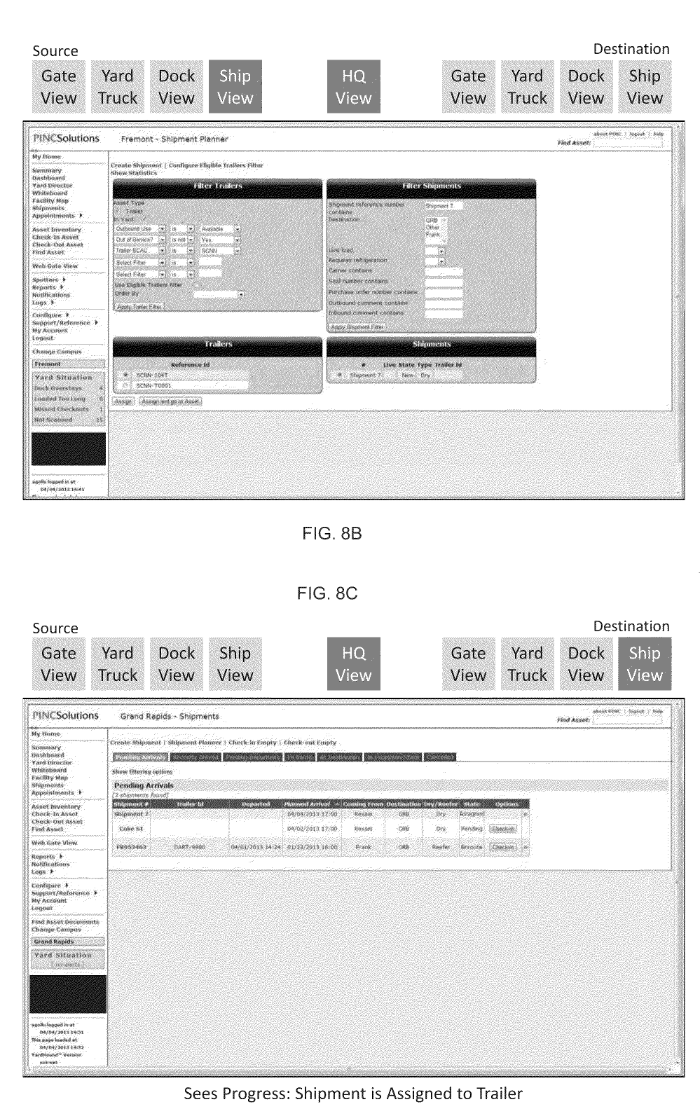

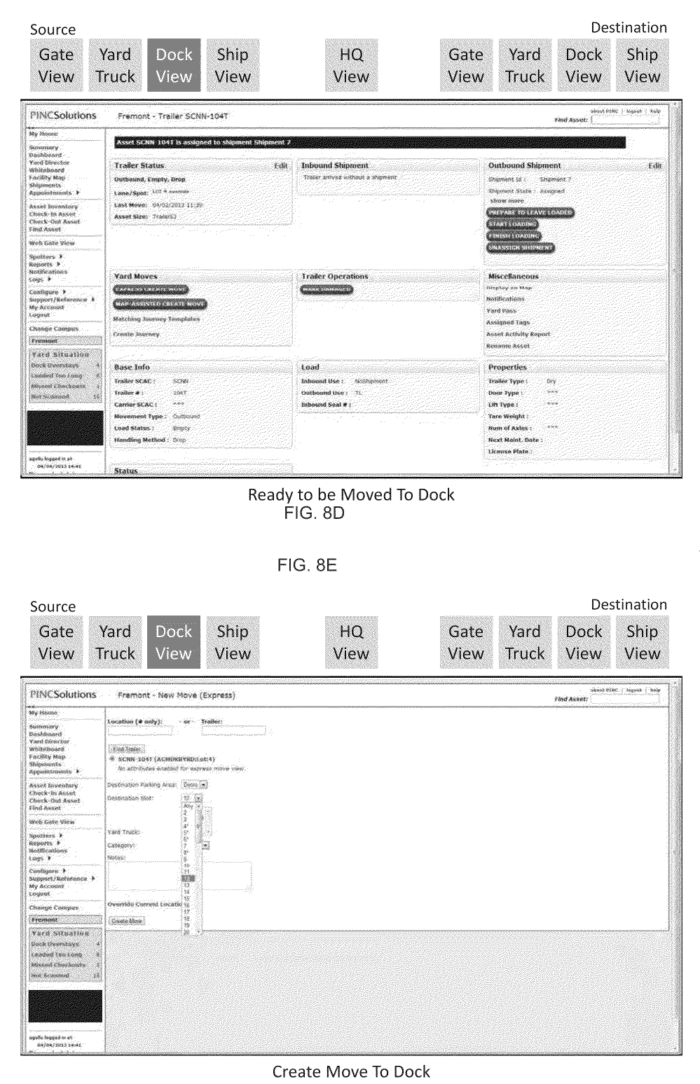

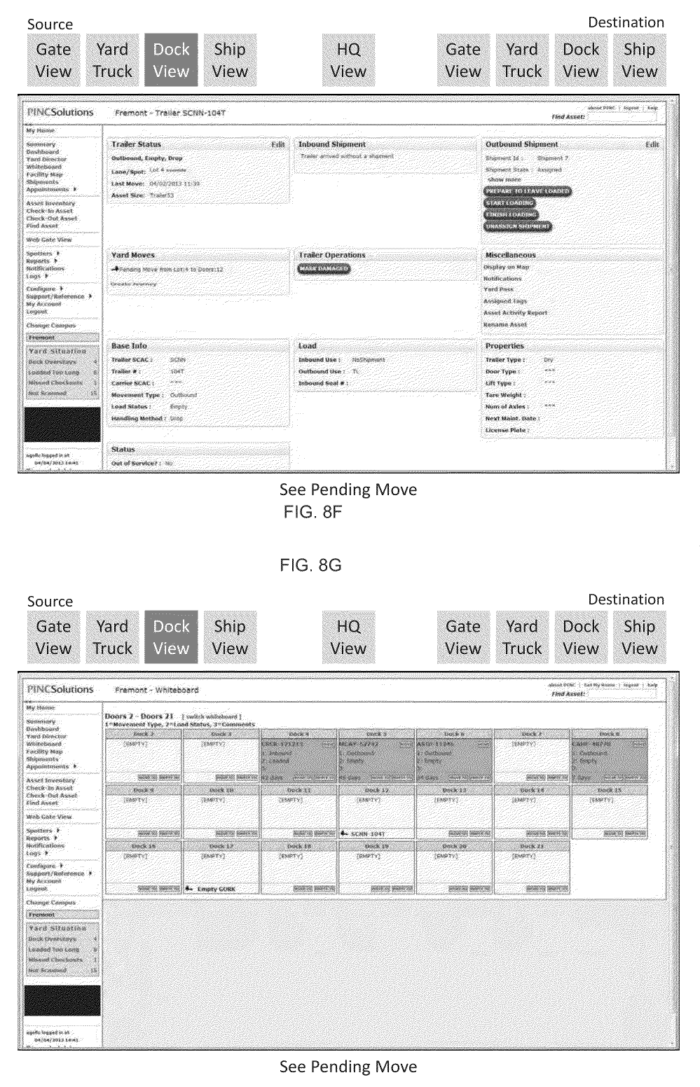

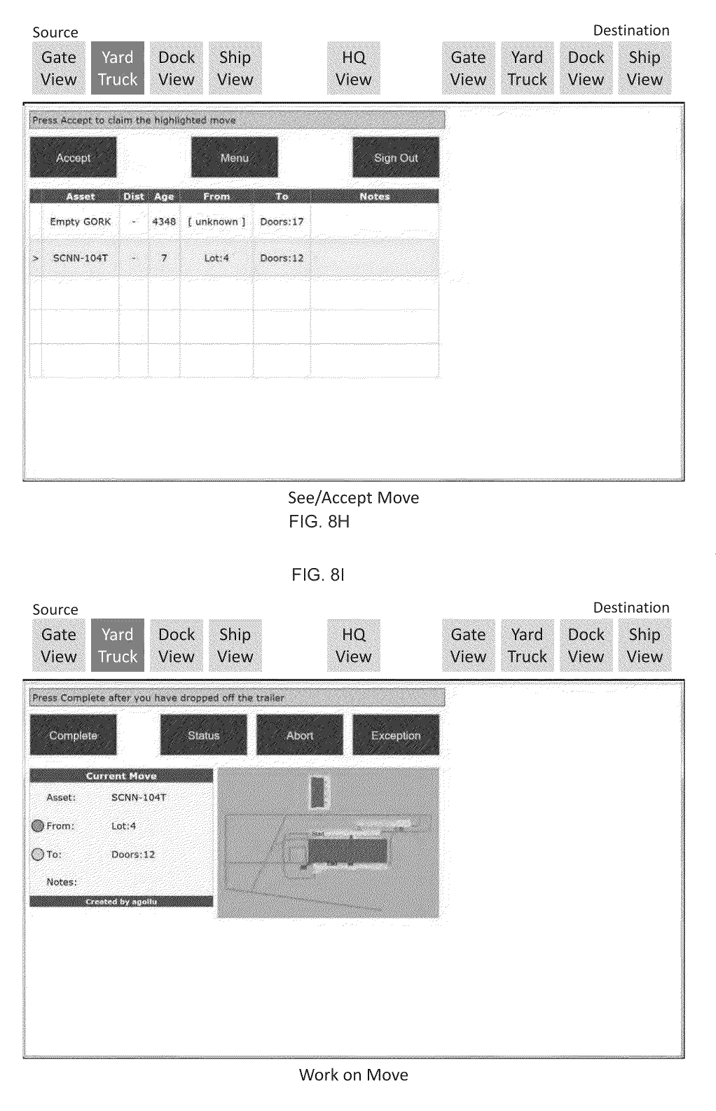

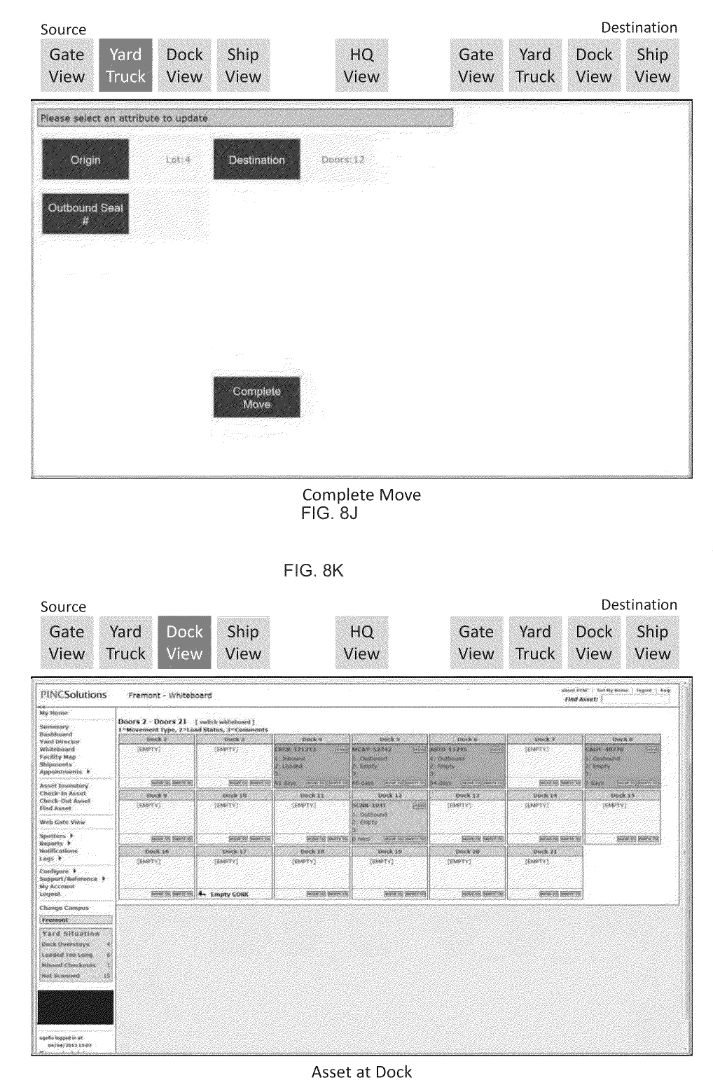

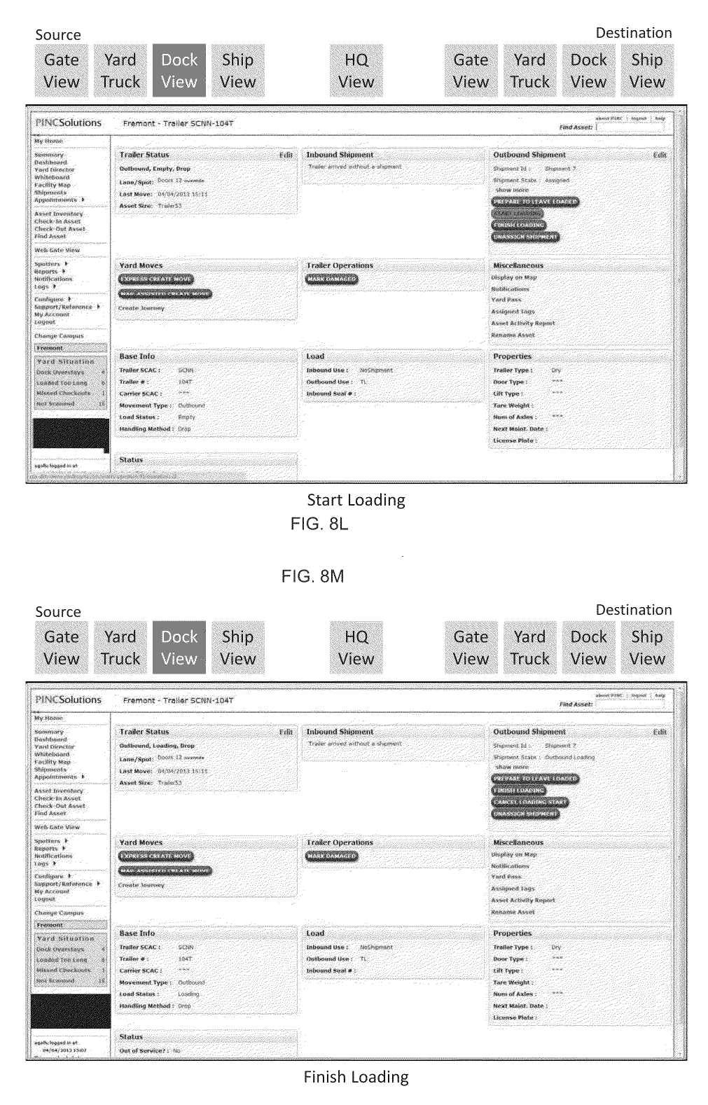

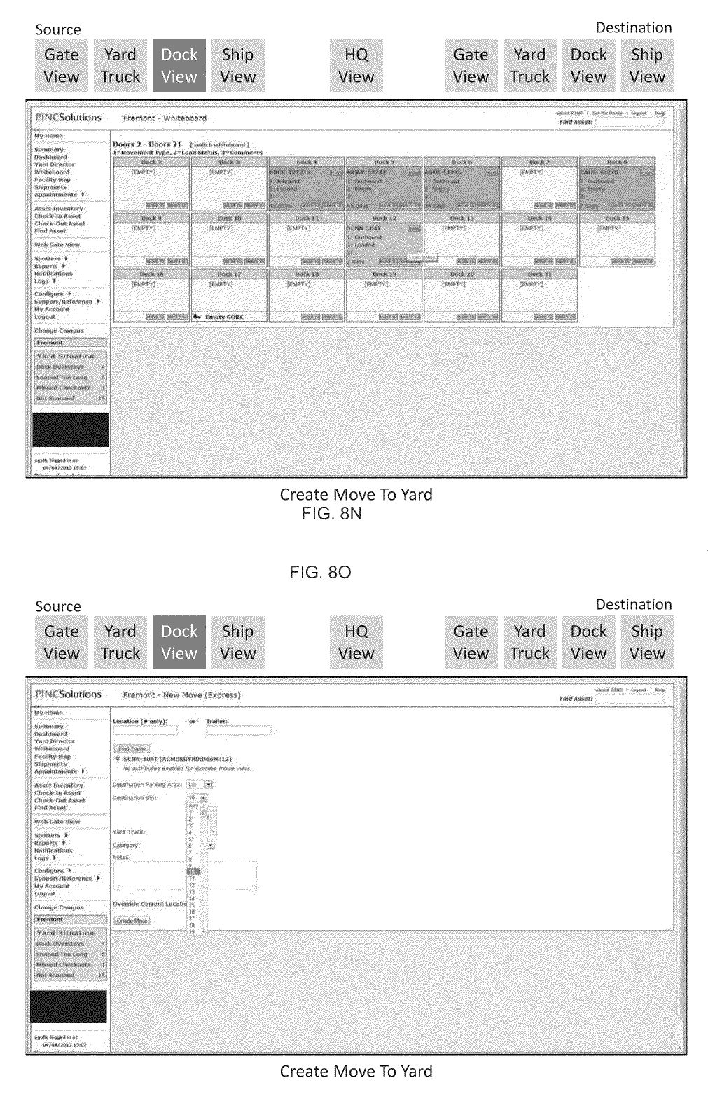

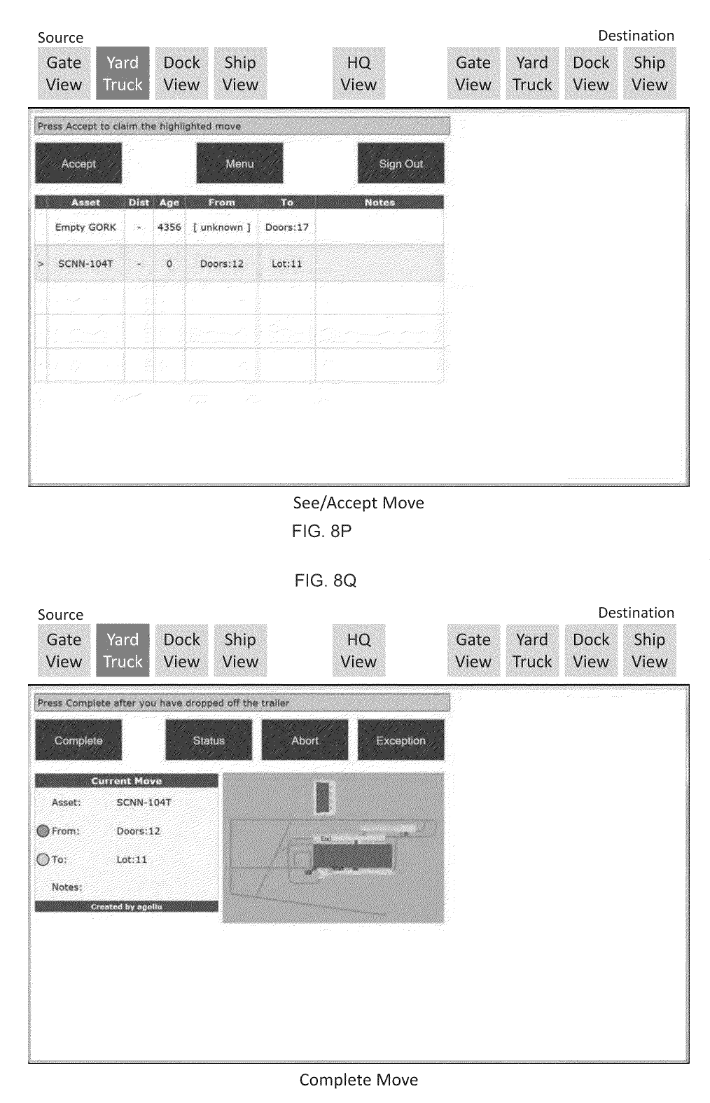

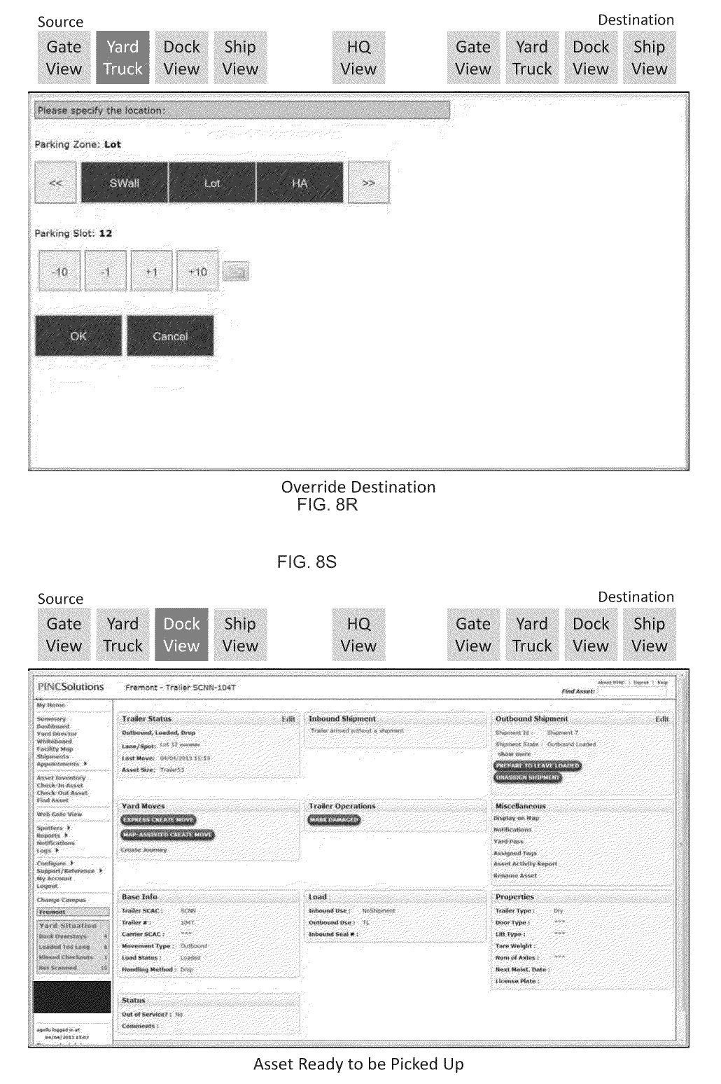

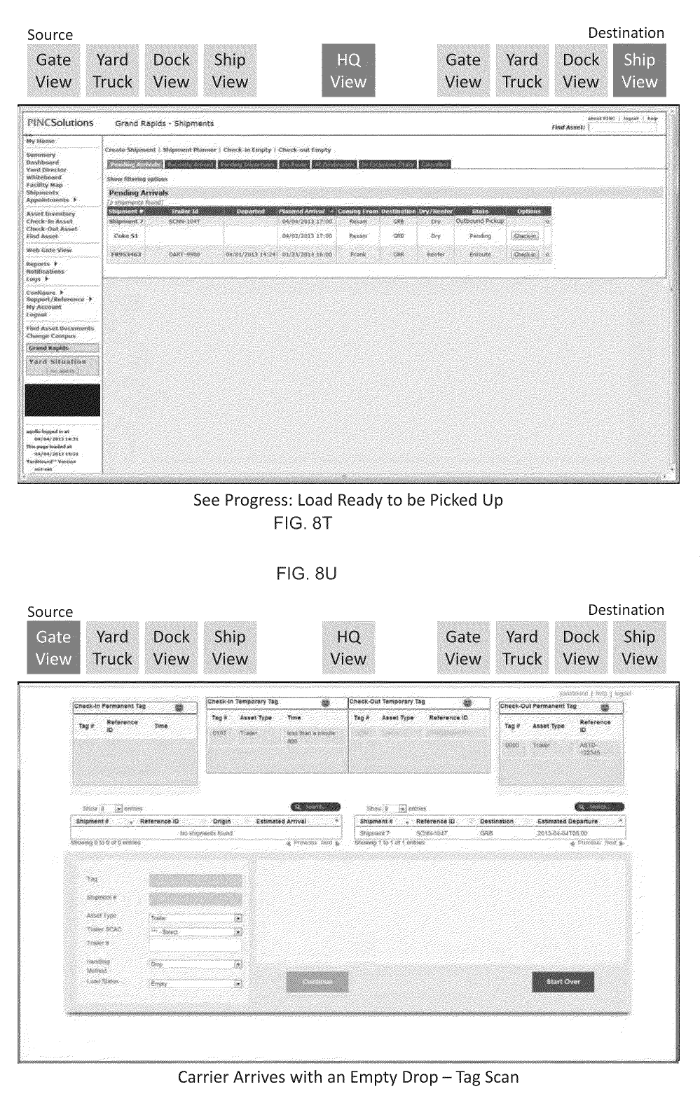

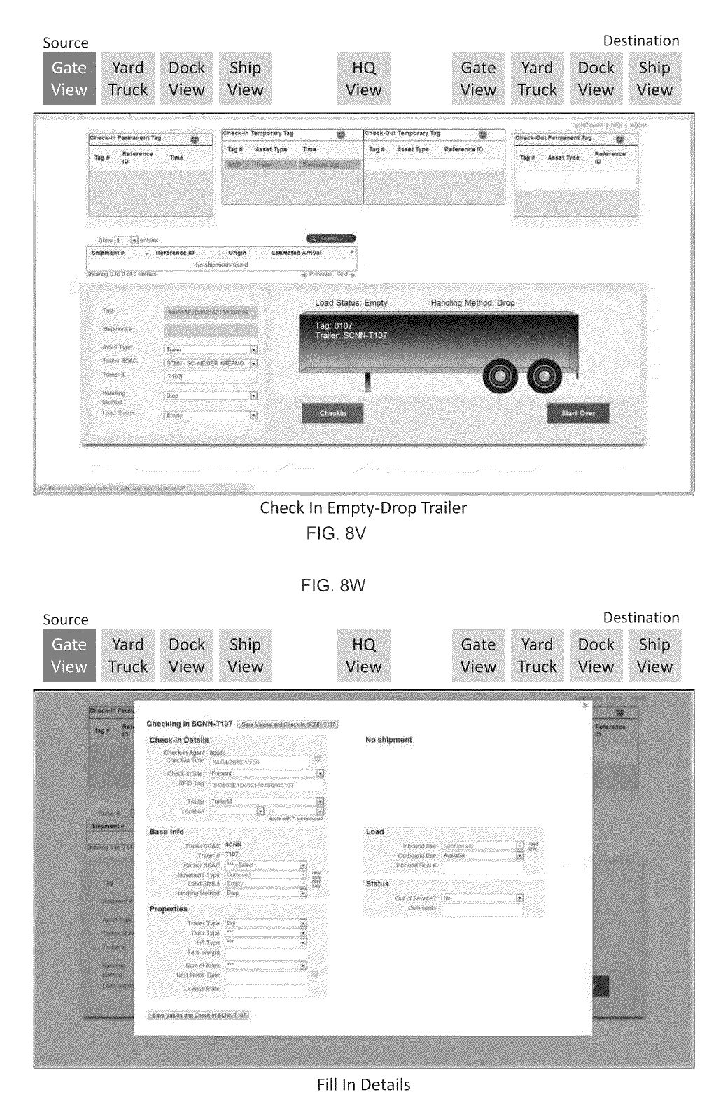

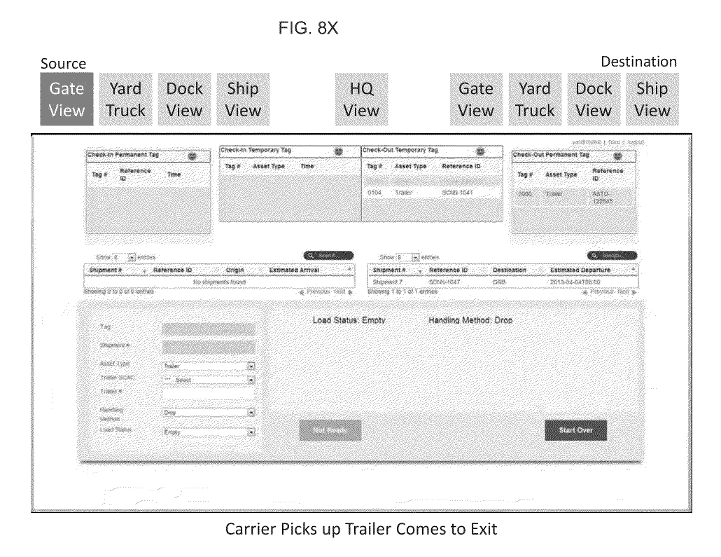

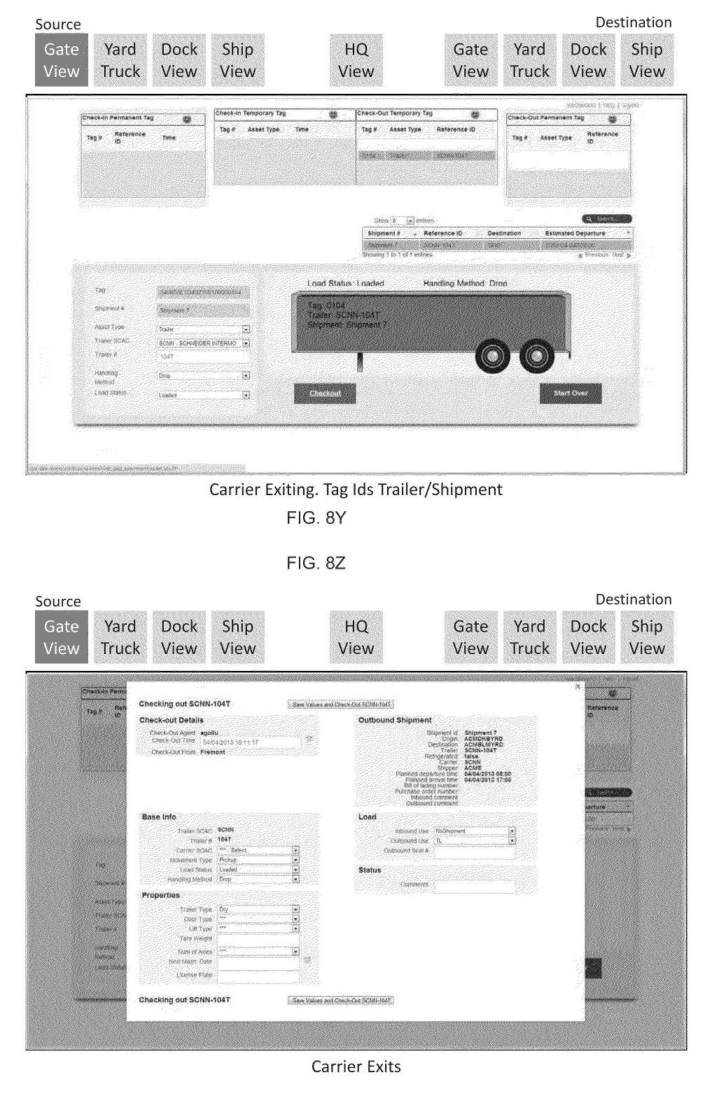

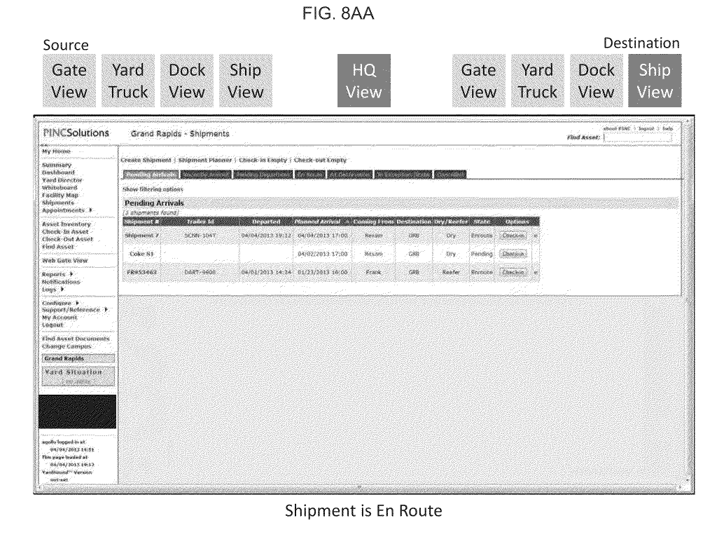

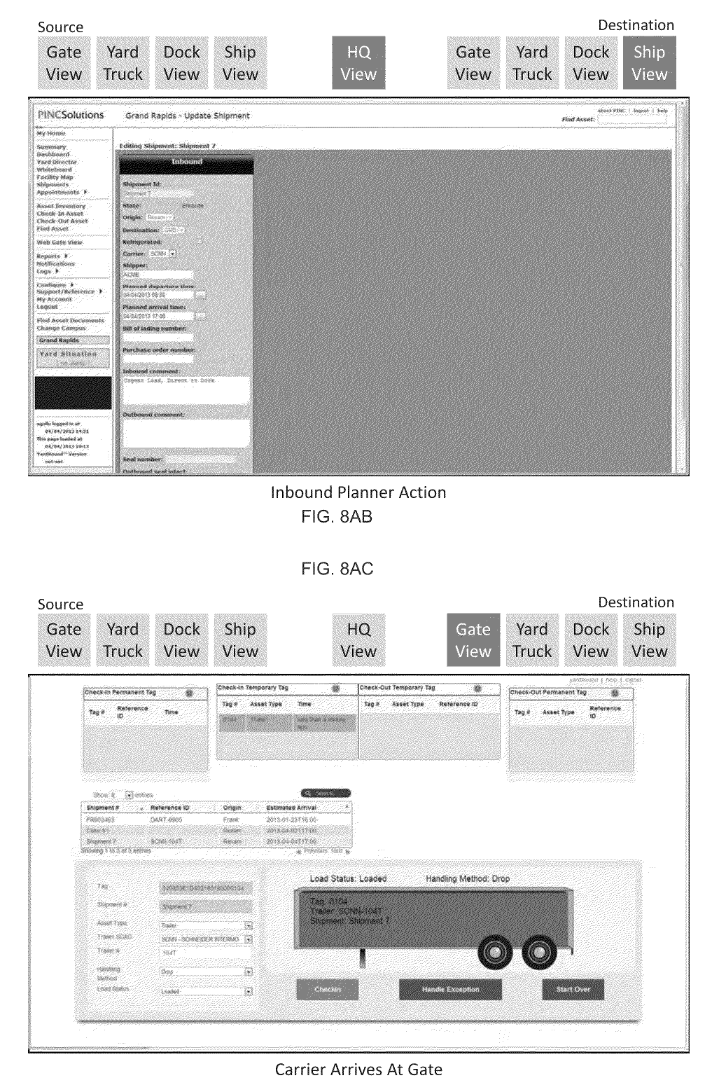

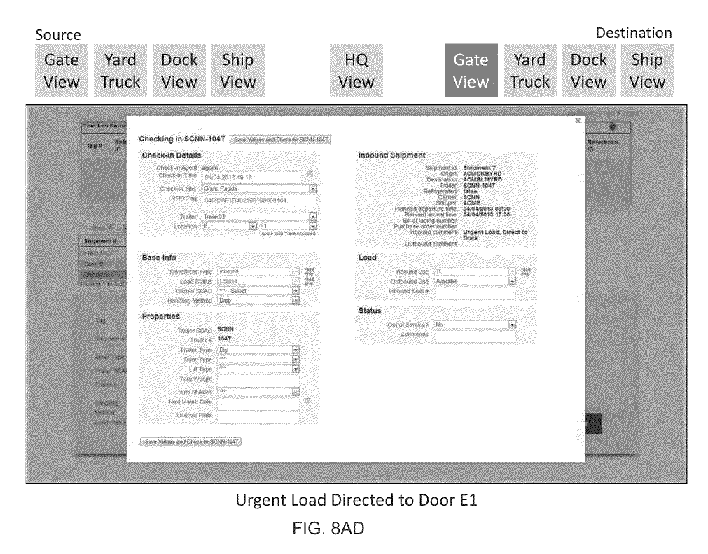

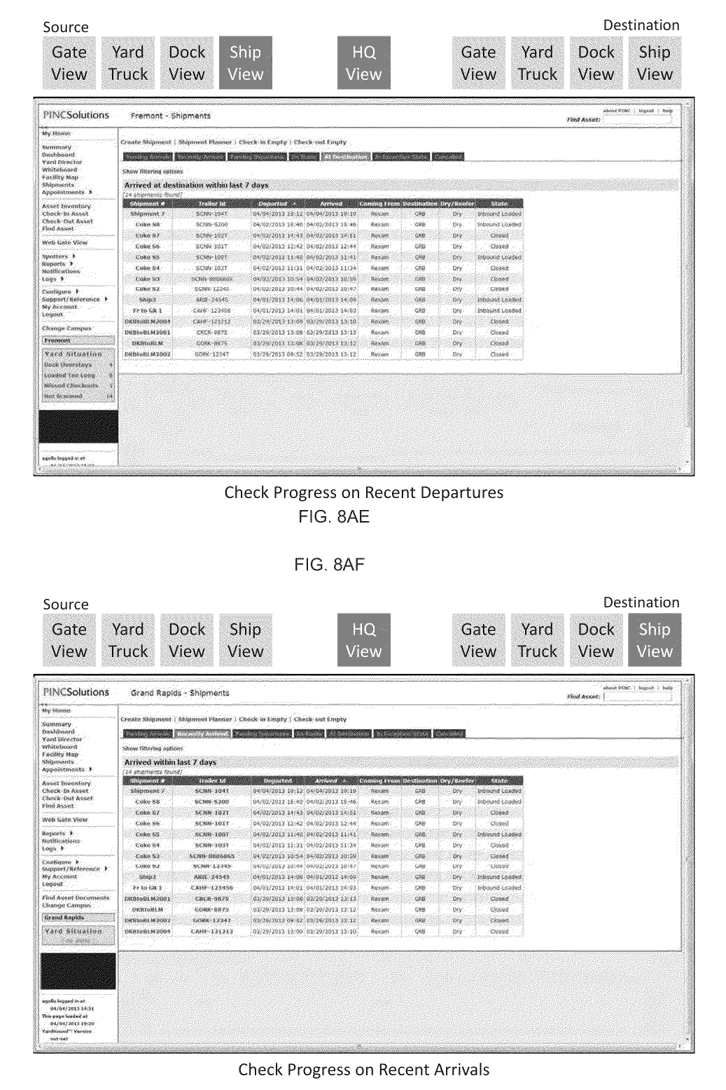

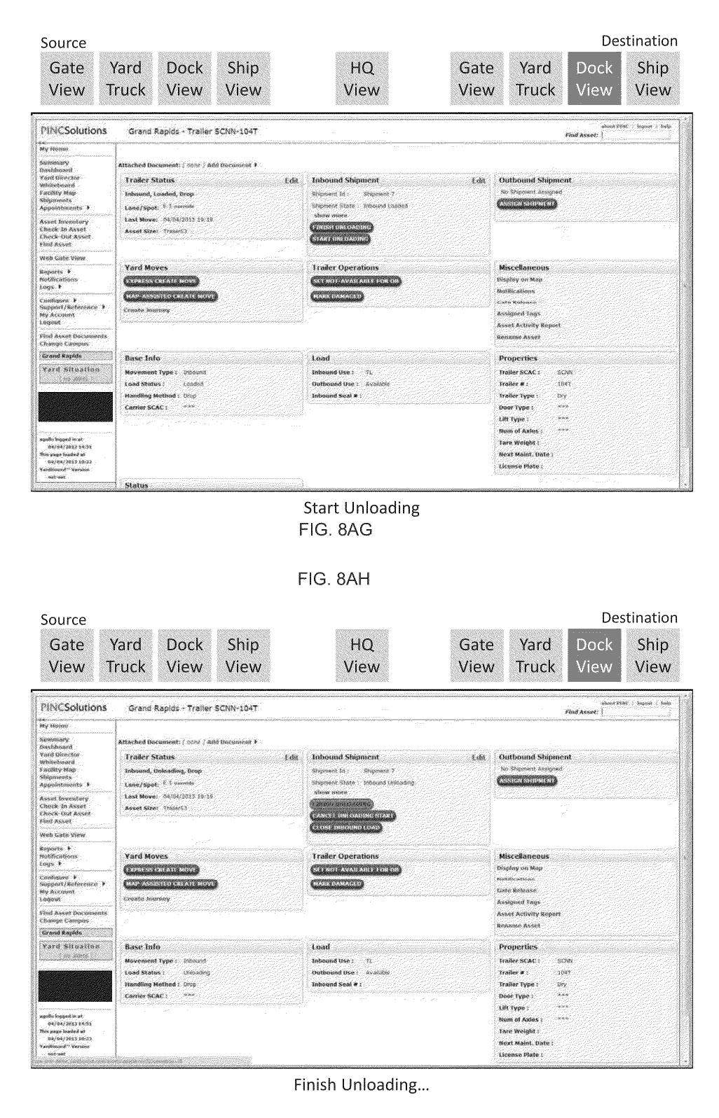

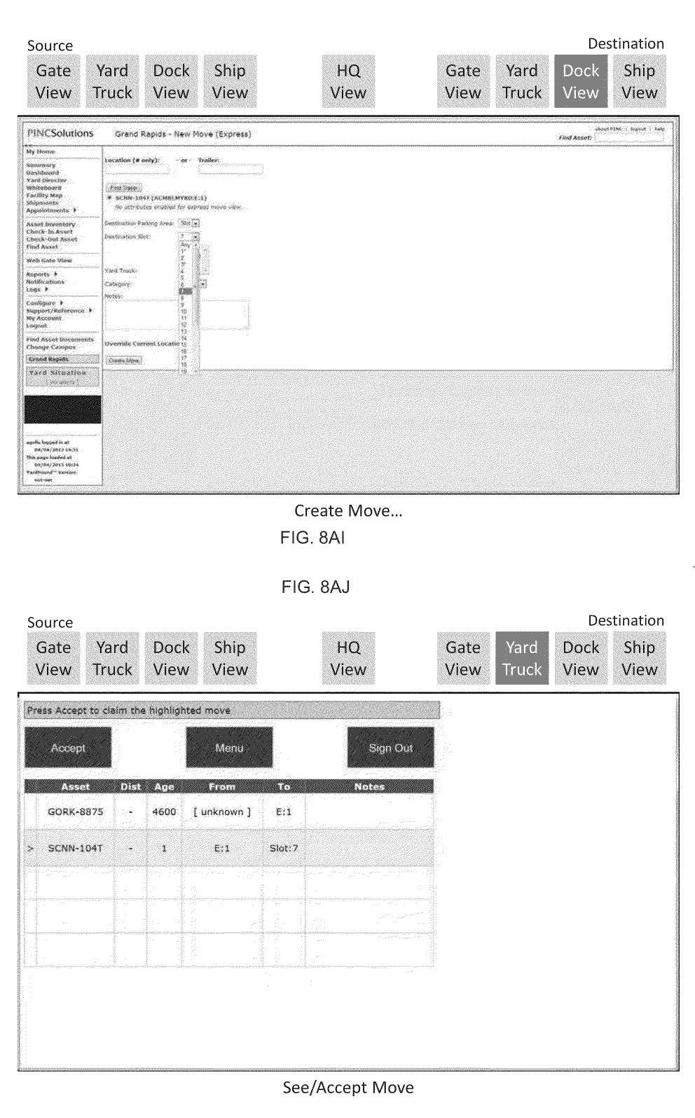

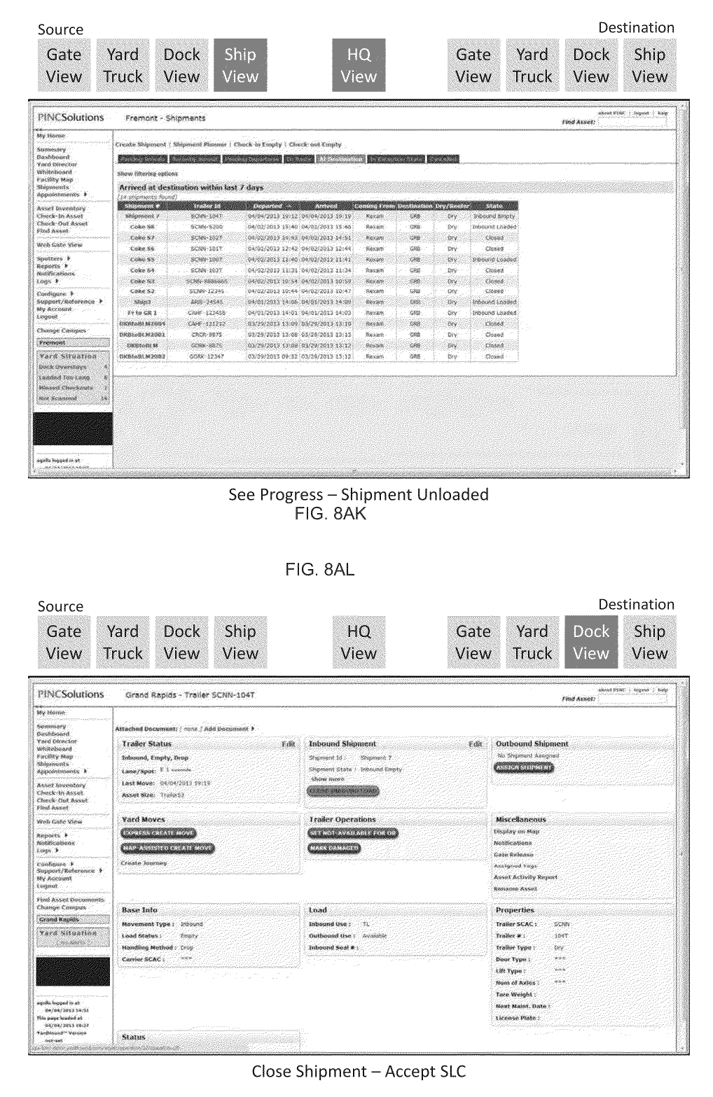

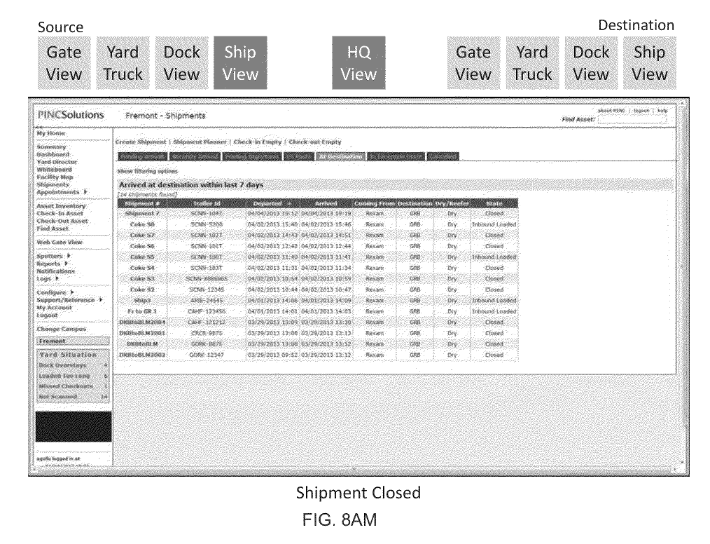

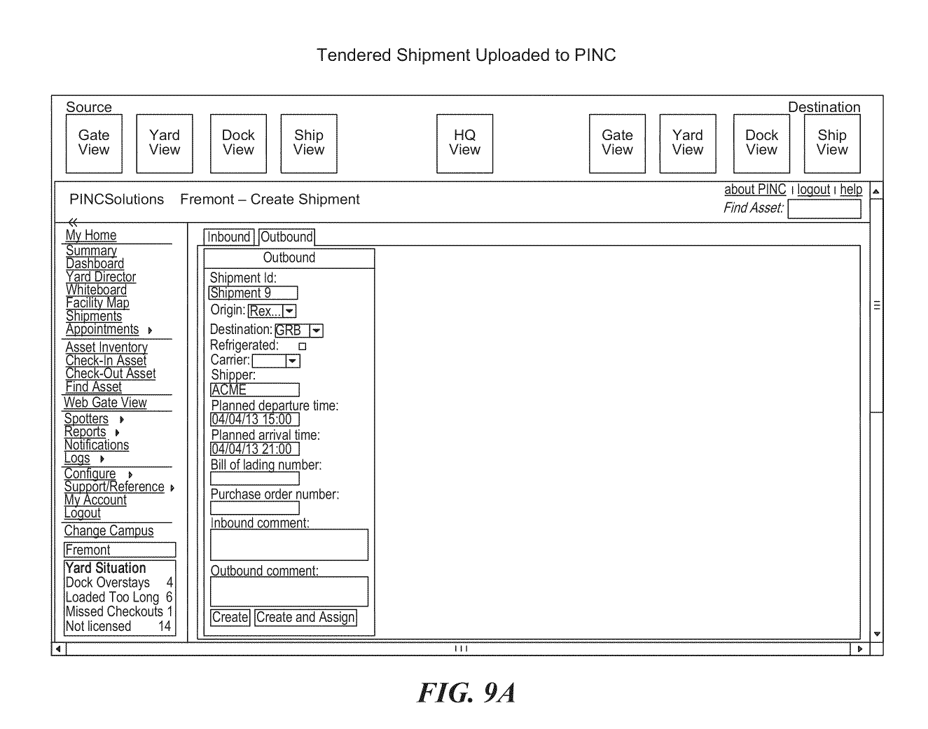

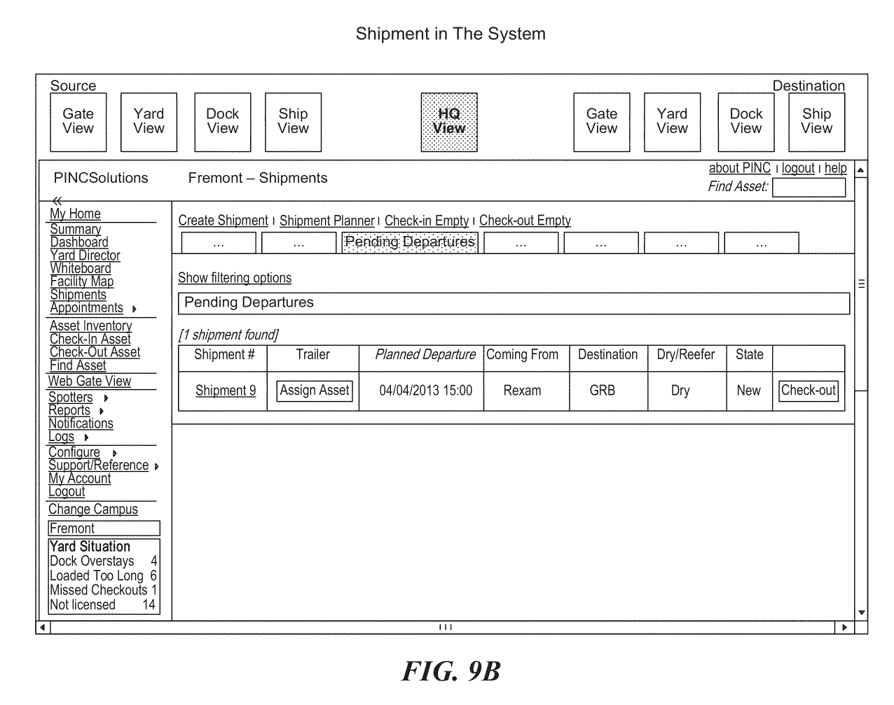

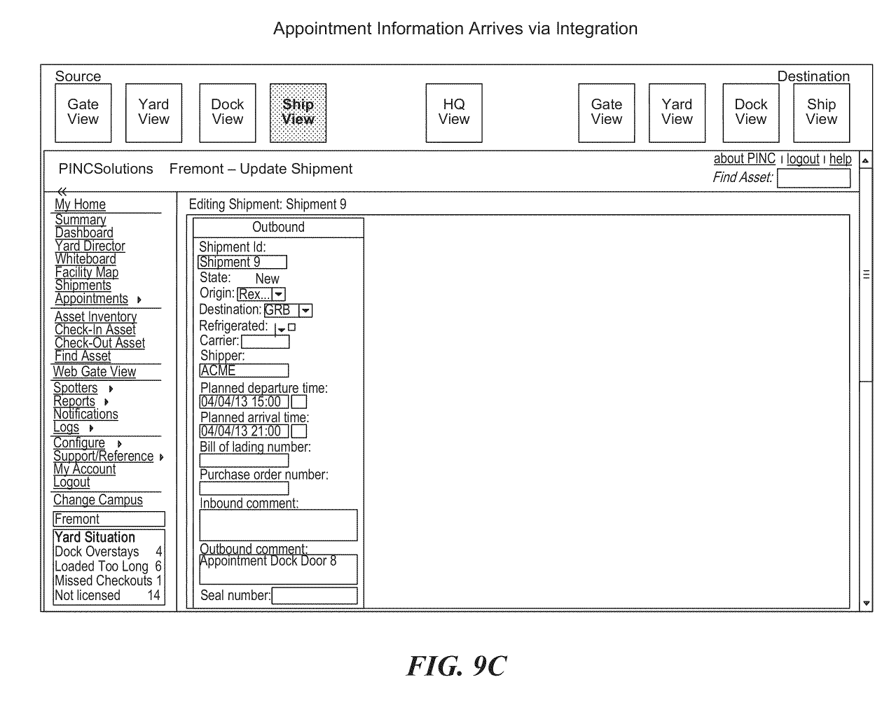

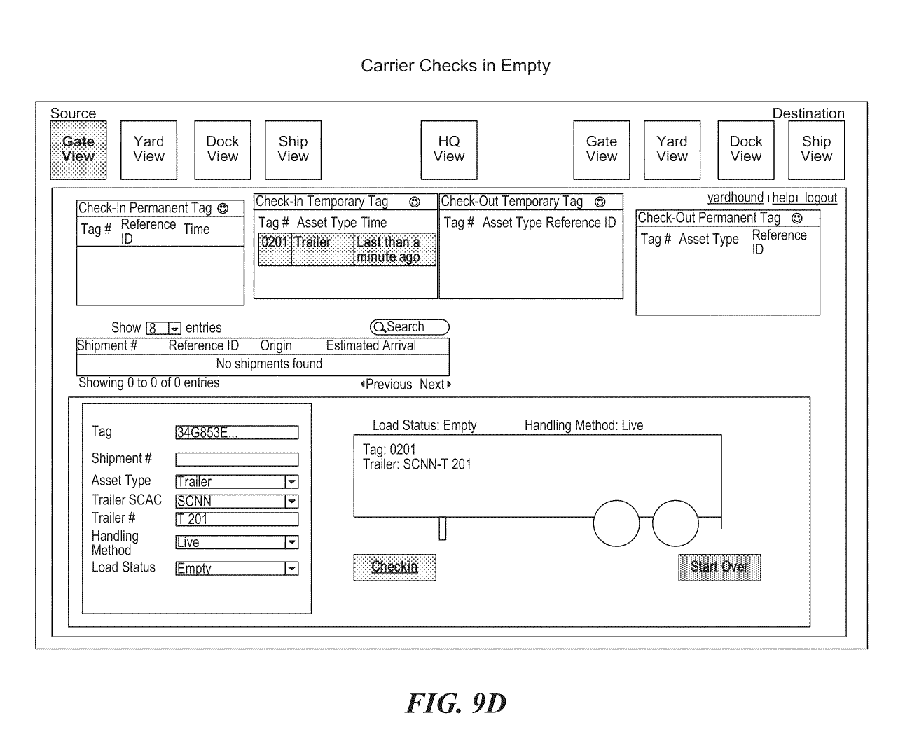

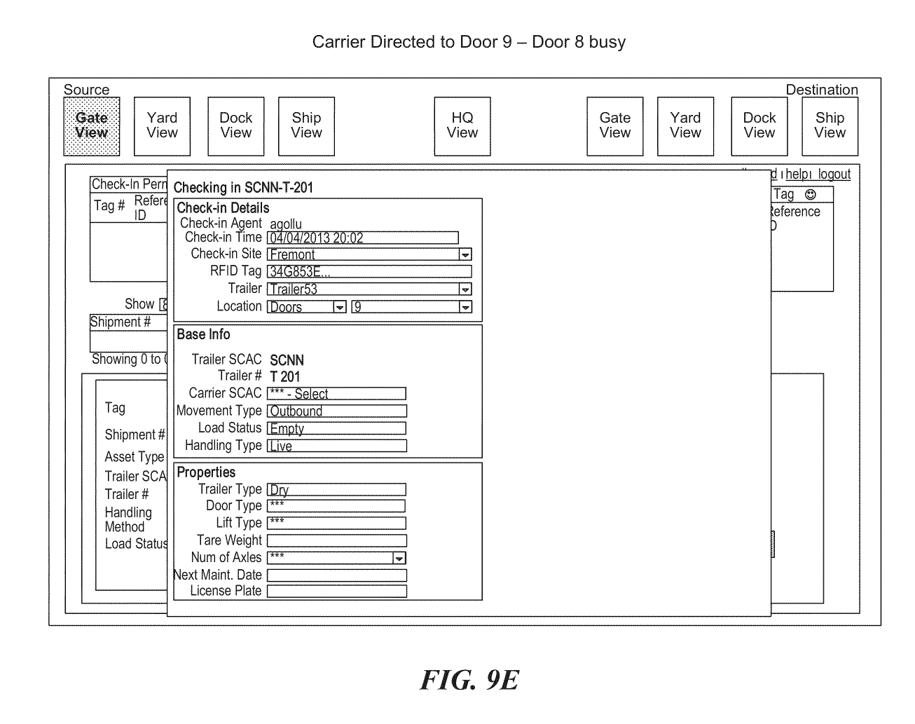

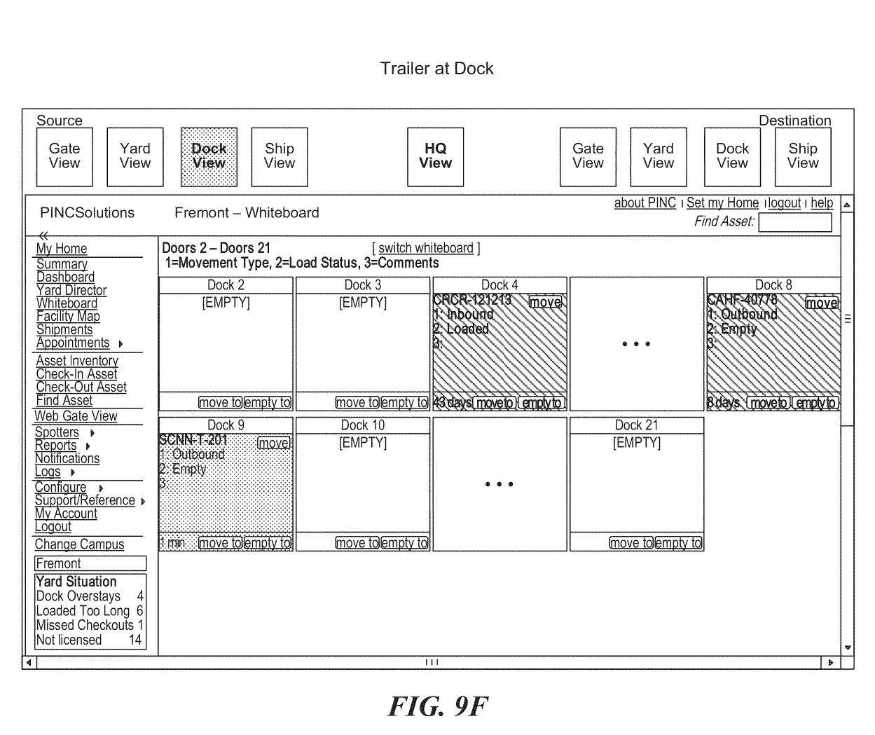

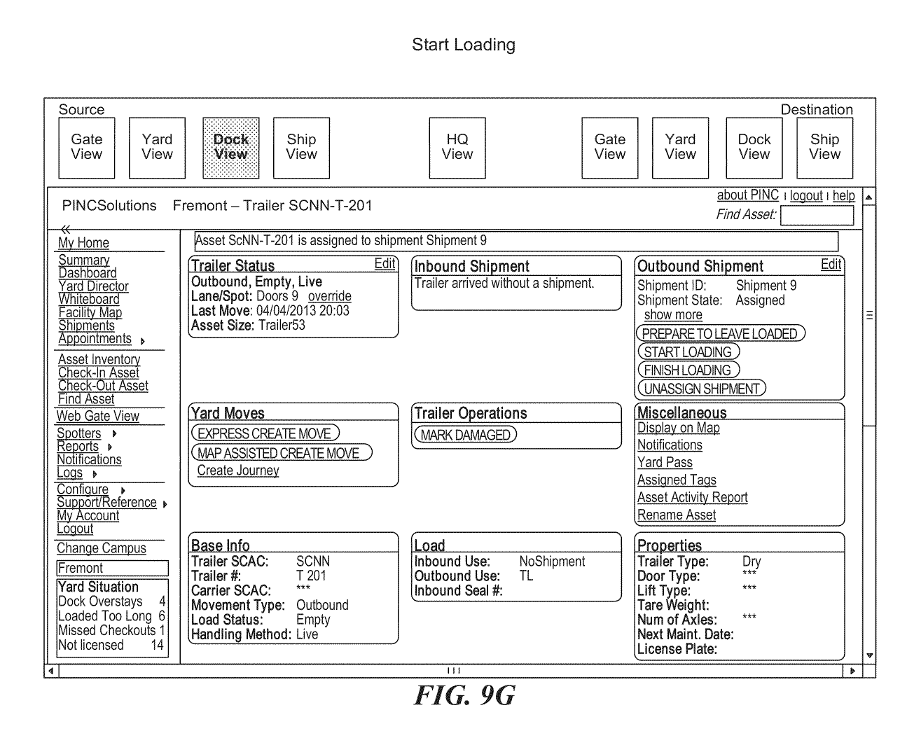

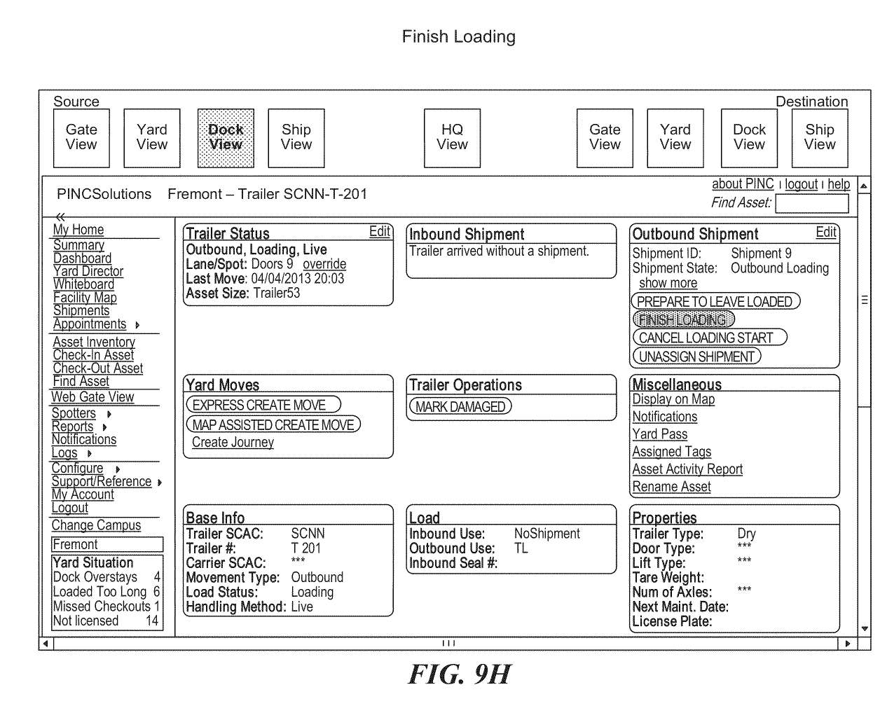

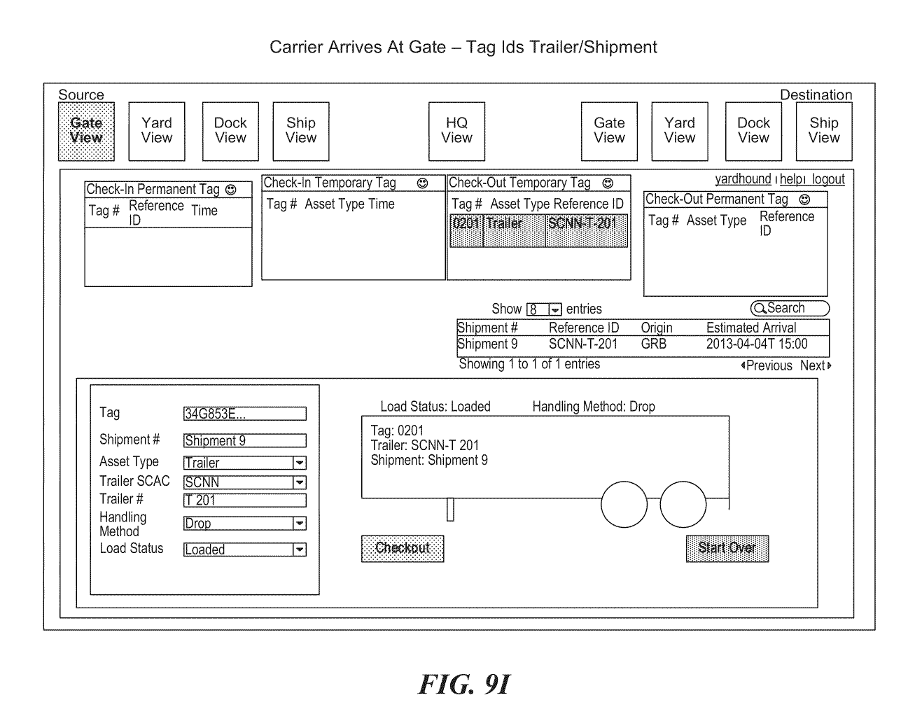

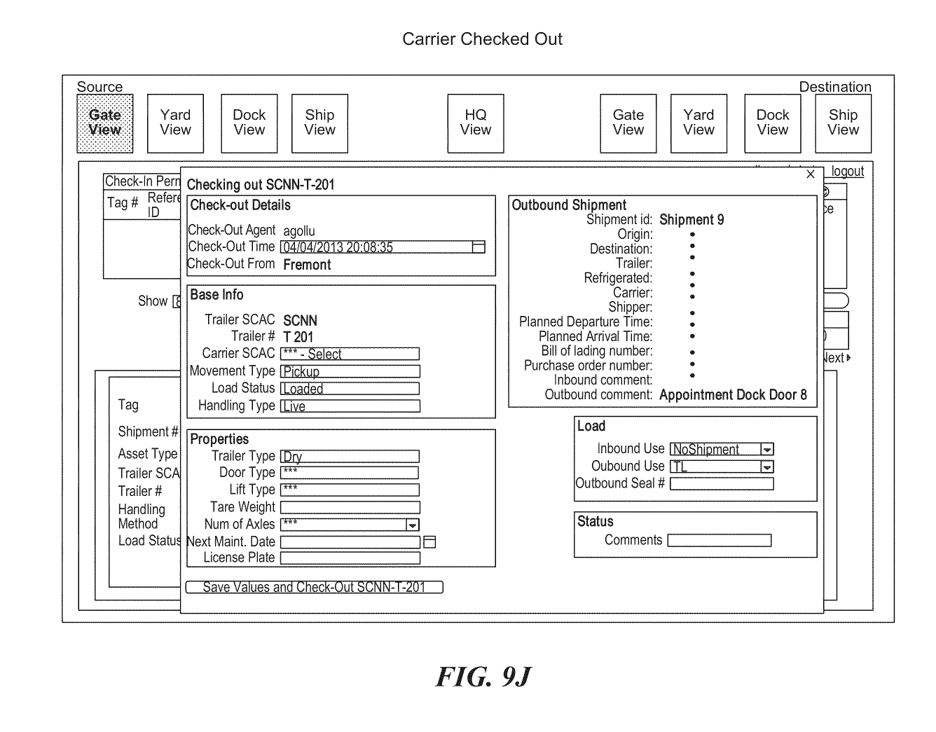

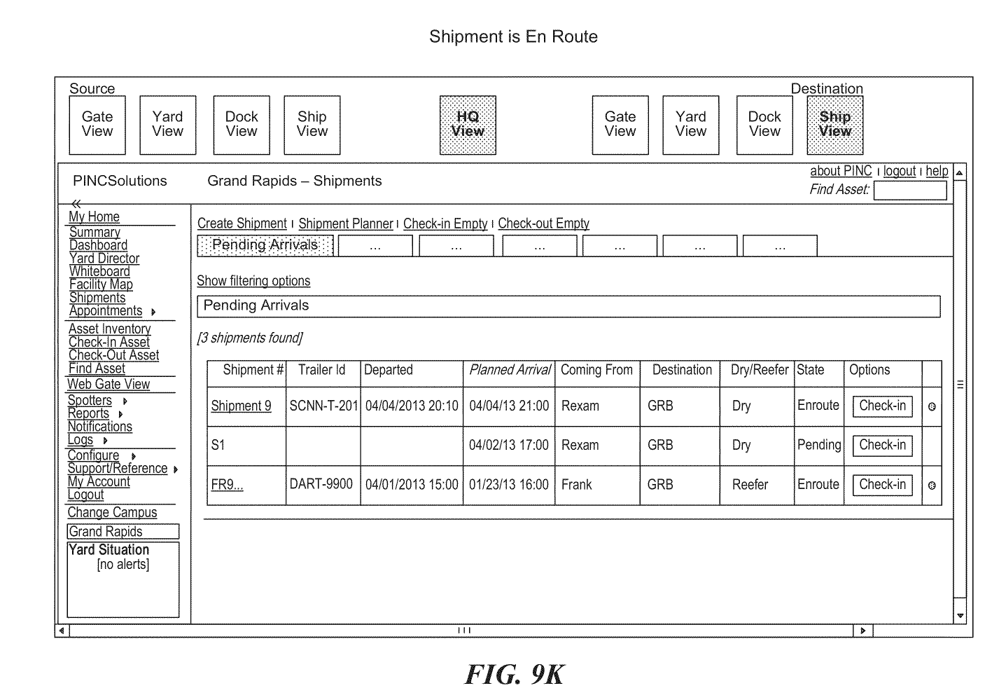

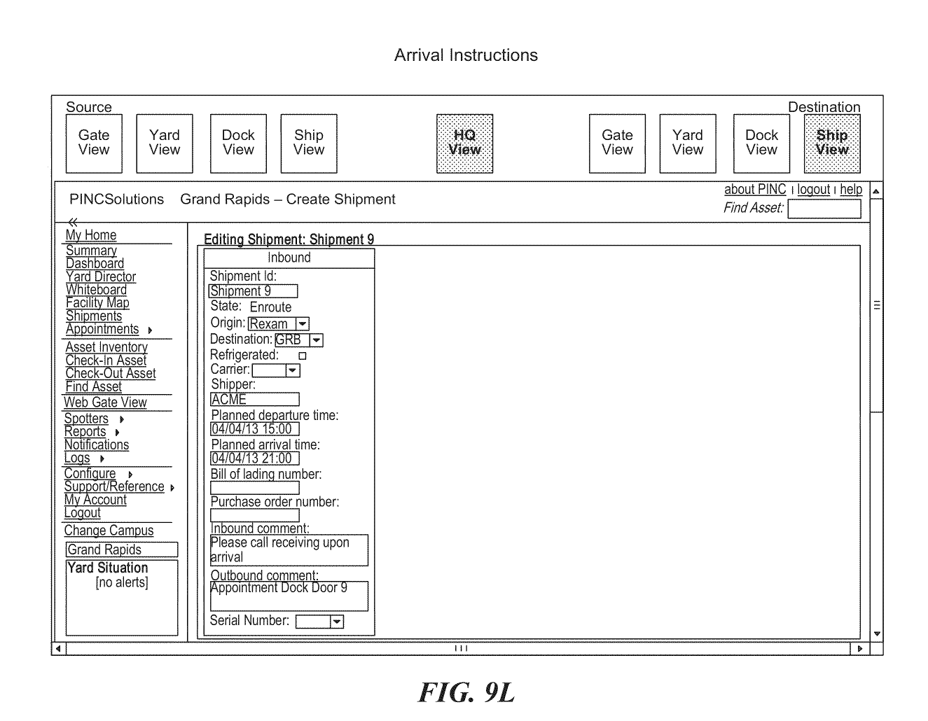

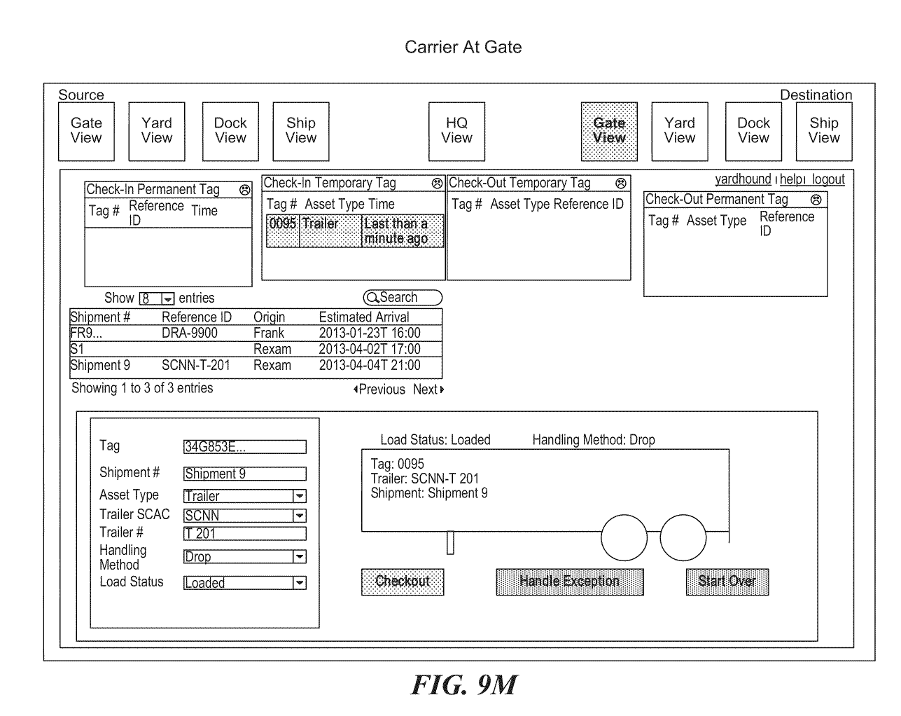

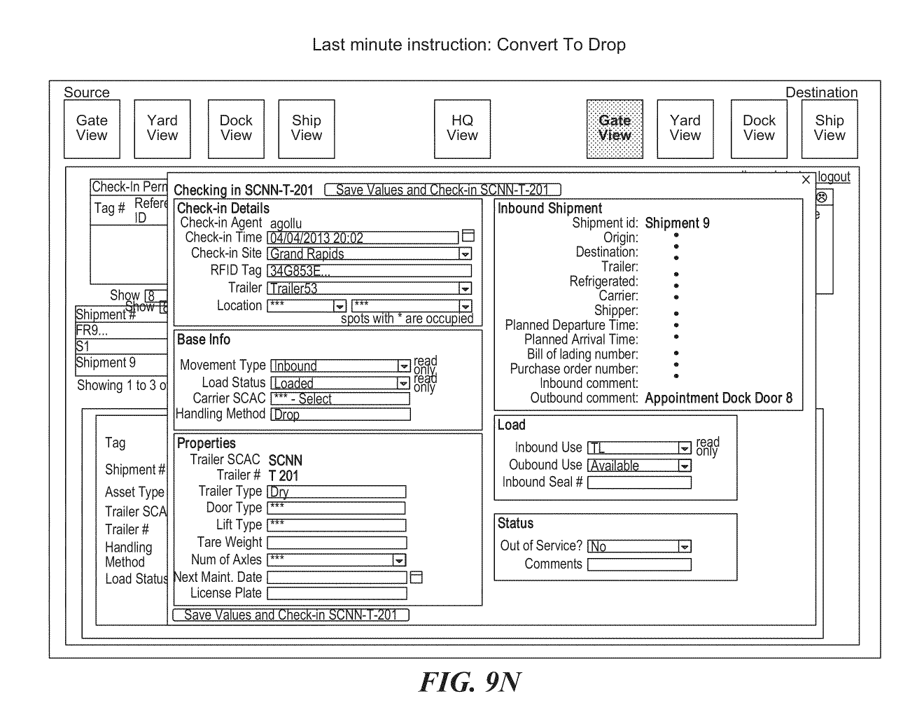

For example, via the system, a user can perform the following operations, i.e. typically physical actions on the trailer and shipment, which result in the trailer and shipment state trajectory to evolve in synch, as depicted in FIG. 2B. For example, assume the load status was loaded and the user started unloading the trailer. Now, the trailer is empty. The trailer was in the yard. The user created a move. Now the trailer actually got moved to the dock door. The trailer stayed at the dock door. The move completed. Another move is created and the trailer goes from dock to yard. Eventually a Driver comes with a Tractor, picks up the trailer and shipment, and transfers it to another facility (the to-site). FIG. 2B(b) then illustrates the state trajectory in the to-site. Another move may be created for the trailer to go from yard to dock. Start move to dock. Finish move to dock. Start unloading. Finish unloading. Create move to yard. Start move to yard. Finish move to yard. And, finally the movement is done and the Shipment is closed. Execution sequences are discussed in more detail below and in the context of FIG. 8 and FIG. 9.

Thus, the system is configured to enable such user to manage the time, e.g. measuring and shortening the time for greater efficiency. For example, the person at the dock may be waiting. The trailer is in movement and so forth. Thus, the user may want to know all of this timing.

### 2.11.5 Shipment Characteristics

In an embodiment, some characteristics of a shipment may be primarily related to a particular stop of the shipment, or the en-route portion. That is, such characteristics may apply as the shipment is being driven from source to destination. As well, other characteristics may apply to an end or a stop of a particular leg.

In an embodiment, shipment leg characteristics may include but are not limited to the following characteristics:
Load Type (e.g. Dry, Refrigerated);
Shipment Type (e.g. Dry, Reefer);
Weight;
Volume;
Seal Id;
Load Type; and
Etc.

In an embodiment, shipment stop characteristics may include but are not limited to the following. It should be appreciated that each type below has an inbound and outbound value.

At the source stop
Outbound Handling Method: (Live, Drop);
Outbound Action: (TL, . . . , LTL, NoOp); and
Etc,

At the destination stop:
Inbound Handling Method: (Live, Drop);
Inbound Action: (TL, . . . , LTL, NoOp); and Etc.

One skilled in the art may readily recognize that some of the planning and system attributes are shipment stop attributes, e.g. planned or estimated arrival time, inbound appointment time, etc.

### 2.12 Flexible Interoperability

As discussed above the least common denominator model can easily be extended to track additional information necessary in local operations. In an embodiment, the below conditions are incorporated into the system:
Sites can define additional Trailer attributes and manage “local” trailer actions, e.g.: Loading Stage {Dry, Conditioned, Reefer}
“Load Status==Loading” in this case abstracts such “stage” information and only reflects the fact that loading has started
Local site can develop the necessary work-flows/operations to manage the loading stages
When all load stages have completed loading, then and only then, is the “Load Status” set to “Loaded”
The generalized shipment state “0-Loading” works for everyone.

It should also be noted that, in an embodiment, additional Trailer Attributes can actually be copied into the Shipment at the from-site during check-out for it to make it available to the to-site at check-in. While from a least common denominator data model perspective this data may not be shared globally, however, this allows sites to share data selectively.

### 2.13 an Exemplary Trailer to Shipment State Mapping

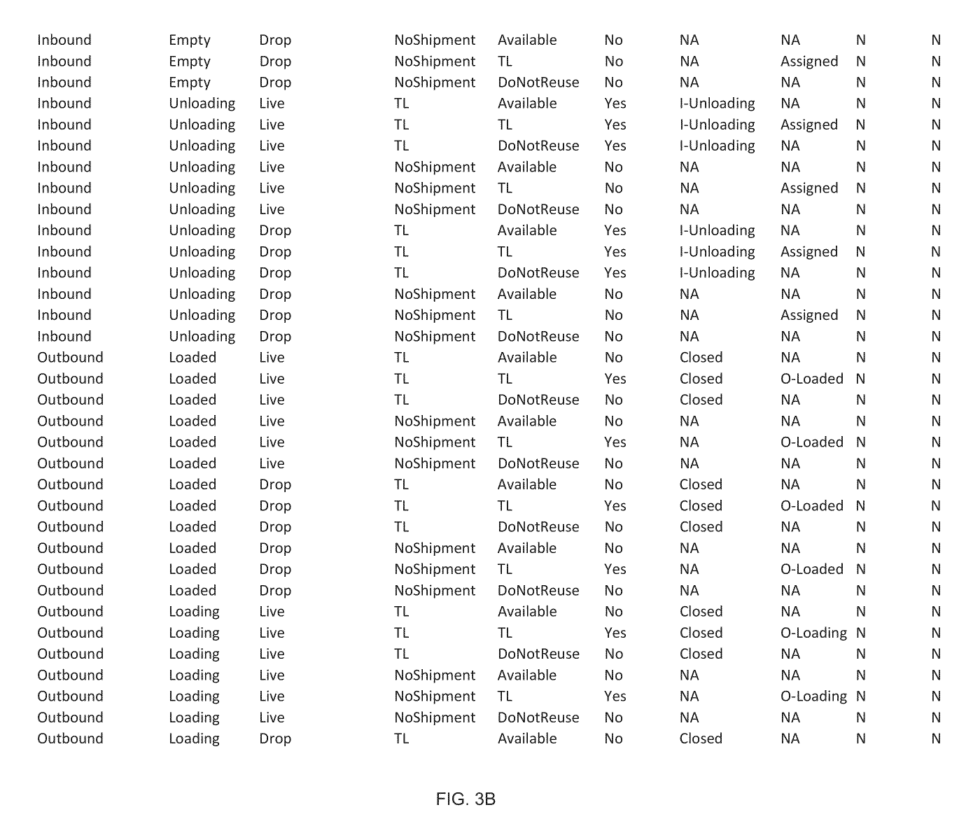

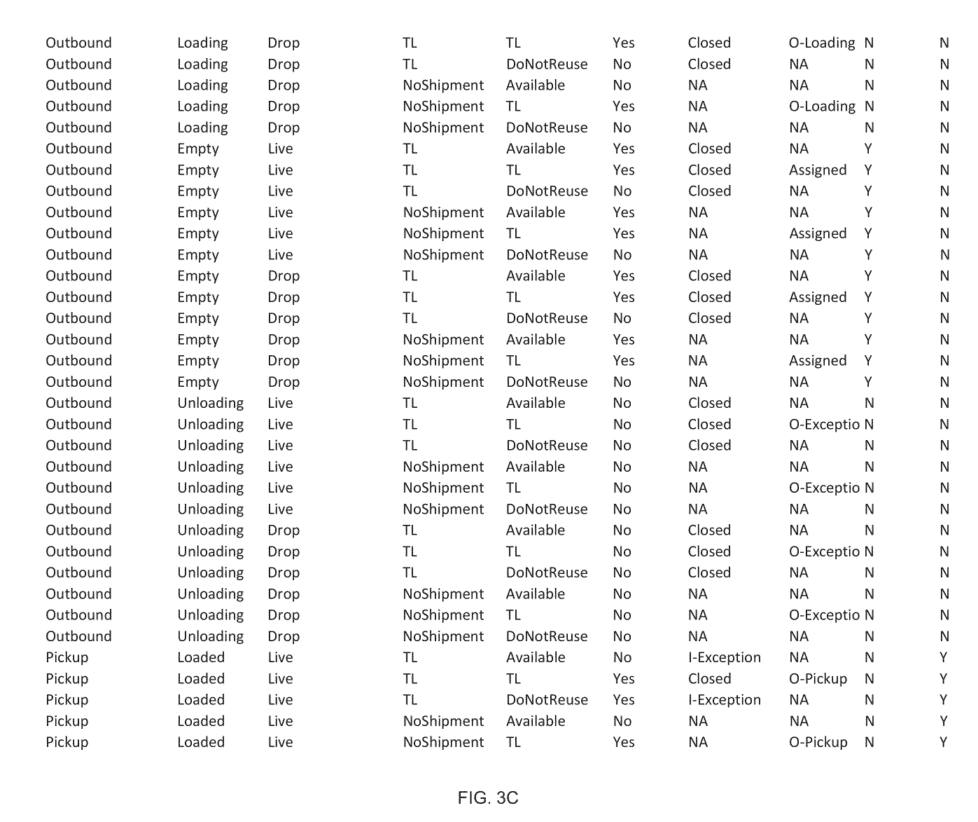

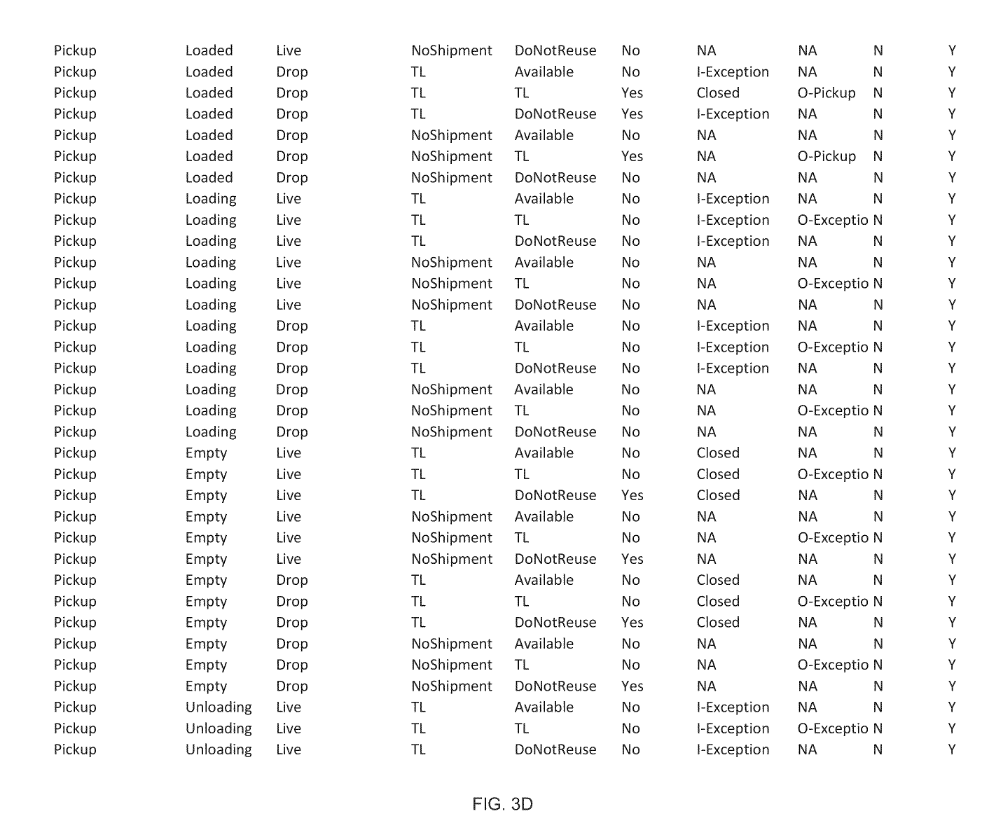

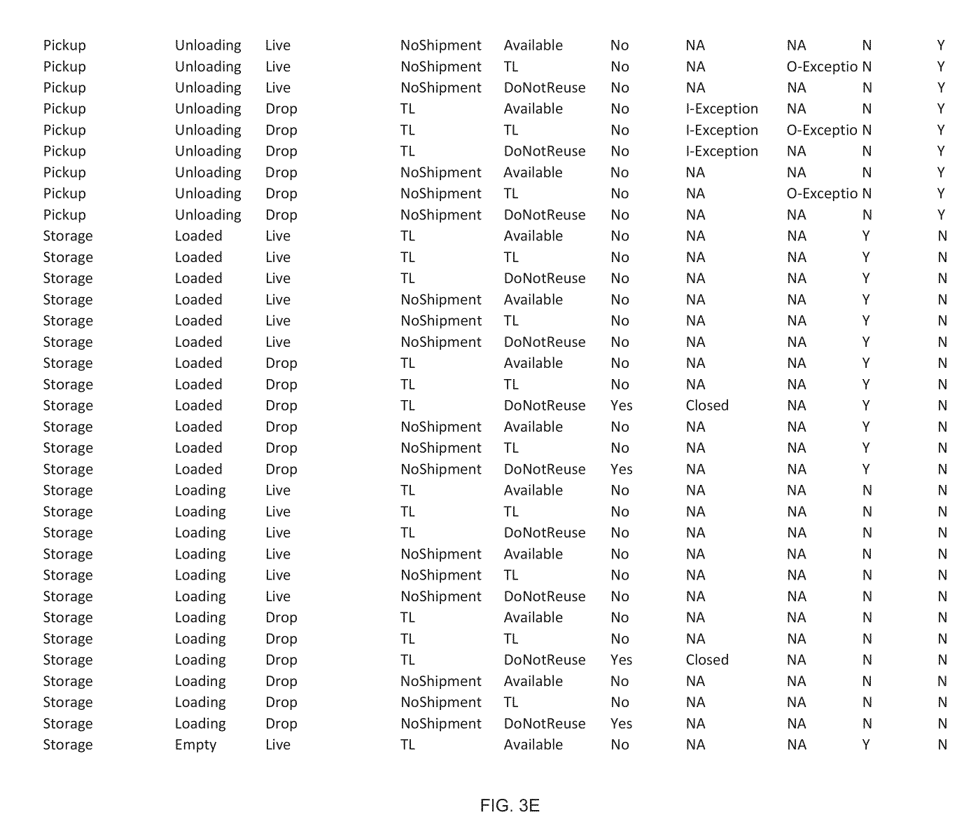

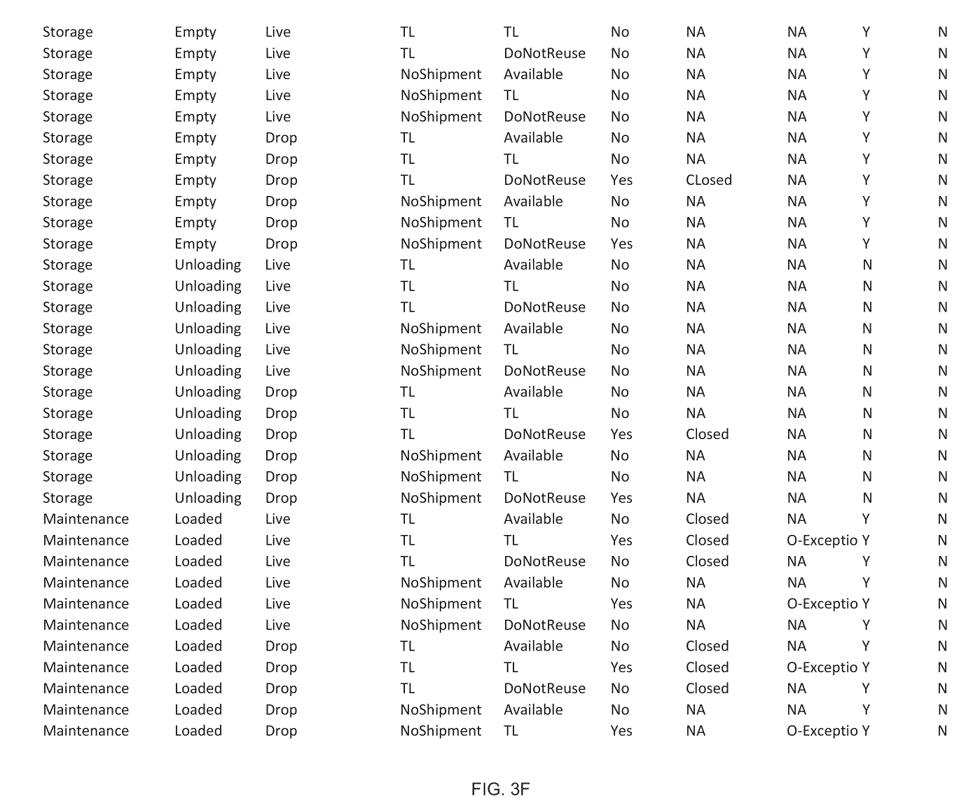

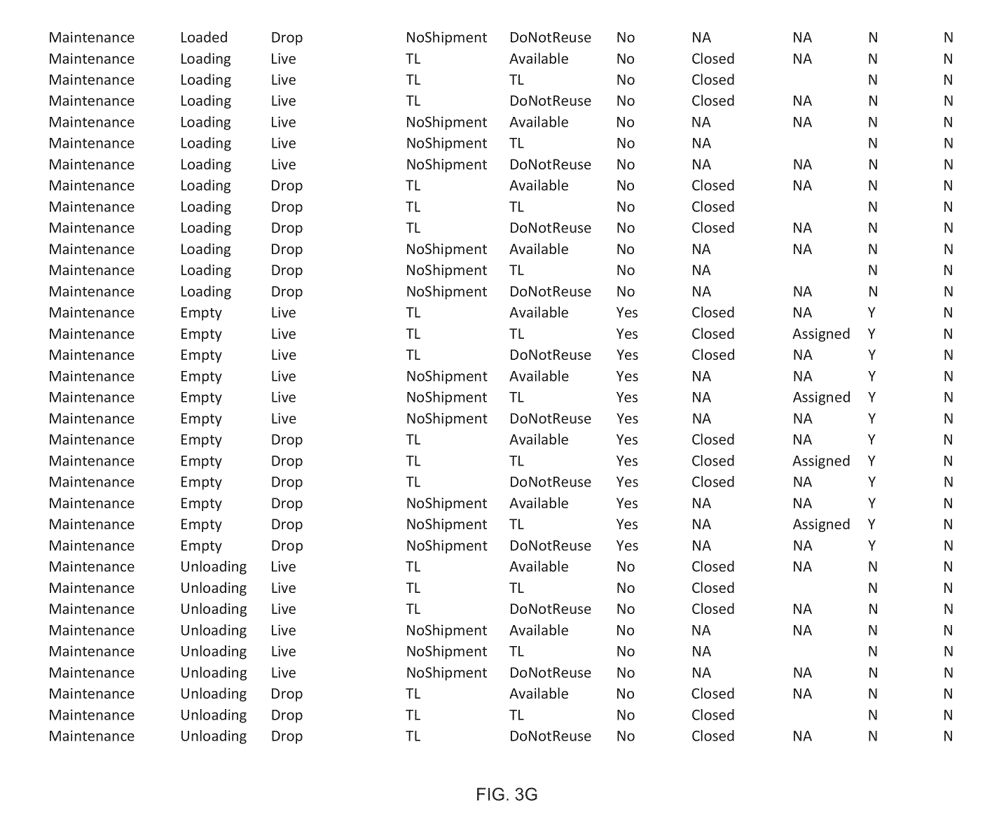

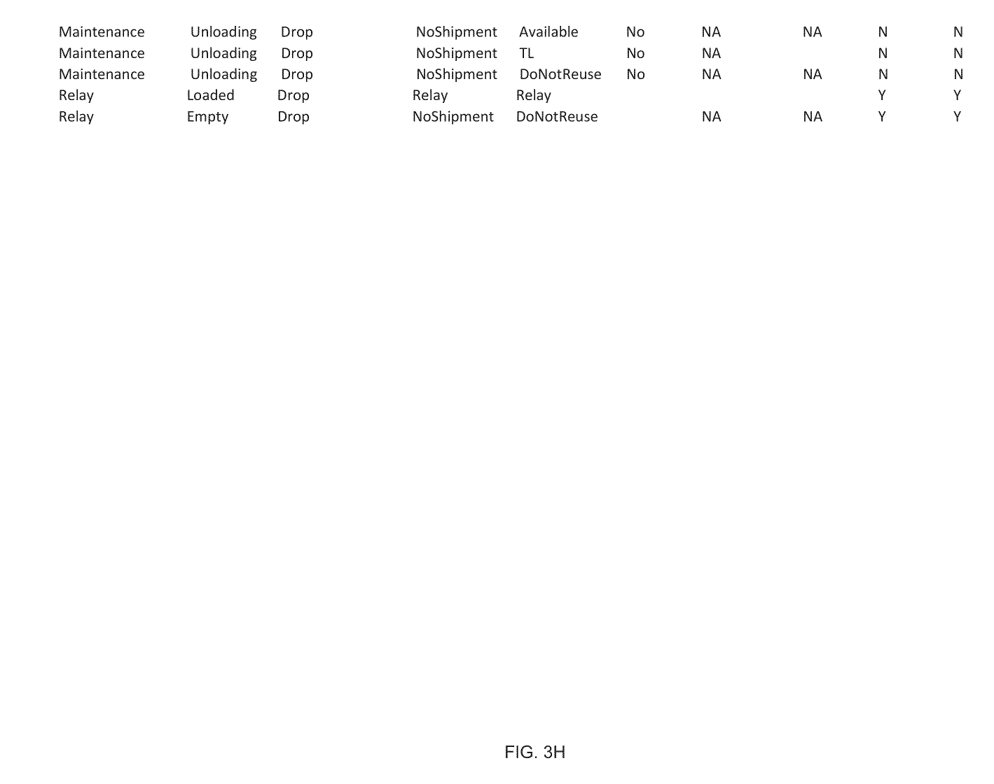

An embodiment of mapping trailer state to shipment state can be understood with reference to FIG. 3A-3H. FIG. 3A-3H is a spreadsheet of the possible combinations of trailer states in combination with shipment states in accordance with an embodiment.

It should be appreciated that while the discussion of the mapping of trailer states to shipment states concerns an implementation of such mapping in a spreadsheet, the spreadsheet paradigm is by way of example and is not meant to be limiting. One skilled in the art would readily recognize that embodiments may include and indeed implement the mapping using technologies other than a spreadsheet. For example, such mappings can be stored in volatile or non-volatile memories in the form of tables, etc. Thus, discussions herein using “spreadsheets” are meant for purposes of understanding only and are not meant to be limiting.

The first column is Movement Type, the entries of which include but are not limited to: inbound, outbound, pickup, storage, maintenance, and relay. The second column is Load Status, the entries of which include but are not limited to: loaded, loading, empty, and unloading. The third column is Handling Method, the entries of which include but are not limited to: live and drop. The fourth column is InboundUse, the entries of which include but are not limited to: Trailer Loads (TL,) NoShipment, and Relay. The fifth column is OutboundUse, the entries of which include but are not limited to: available, TL, DoNotReuse, and Relay. The sixth column is Valid, the entries of which include but are not limited to: Yes, No, and blank. The seventh column is Inbound Shipment State (ISS), the entries of which include but are not limited to: I-loaded, NA, I-Exception, empty, I-unloading, closed, and blank. The eighth column is Outbound Shipment State (OSS), the entries of which include but are not limited to: NA, Assigned, O-loaded, O-loading, O-exception, and O-pickup. The ninth column states whether this is a valid Checkin State (Valid CIS), which describes whether a trailer can be checked in in this state, the entries of which include but are not limited to: Yes and No; acceptable errors may be modeled over time. The tenth column indicate whether a trailer in the given state can be checked out Checkout State (Valid COS), the entries of which include but are not limited to: Yes and No; various error scenarios may be introduced over time.

In an embodiment, to configure the system, a user may go through each of or some of the rows and columns combinations in a given spreadsheet such as the spreadsheet described above and decide whether each row and column combination is valid. For example, regarding an inbound shipment and the inbound shipment states mapped thereto, a user may determine that he is not even allowed to have an inbound state without an inbound shipment. Because if the state is inbound loaded without a shipment, it may not make any sense. Thus, such may not be a valid state. That is, if it is an inbound loaded state, then the user needs such state to have a trailer and it probably would be loaded. Thus, in an embodiment, the spreadsheet is completed with consideration for the needs of a particular business.

This mapping also lays the foundation of normal (positive path) operations vs. modeled and unmodelled exceptions.

2.14 Meaning of Map from One Location to Another

An embodiment provides a way for a map, e.g. spreadsheet, to have meaning from one location to another. In an embodiment, each player at each facility has access to the spreadsheet. Examples of players may be the shipper, the truck driver, and the person at the destination. None of the players share the trailer visit data directly. The trailer visit data are not visible, more importantly they not modifiable across the network. However, the shipment data is visible across the network. There is one shipment and there is knowledge of where is the shipment. For example, if the shipment is in a particular yard (source stop or destination stop), then that facility is operating on the shipment and the corresponding shipment stop attributes. The others players cannot act on such data. If the shipment is en route, the driver may act on the data. And, if the shipment is at the destination, the destination can act on the data. That is, there is a clear ownership of who can change what data on the shipment and when based on Shipment state and location. Because as a player operates on the trailer visit data, if the shipment state is a function of the trailer state, wherever is the trailer, is the only place where the trailer visit data can change. Thus, whoever has access to the trailer, physical trailer, is the one enabled to make trailer state changes from one place to another and who then as a result is changing the shipment data.

In an embodiment, not every interested party, e.g. driver, user at source, user at destination, user at headquarters, etc., is required to get the same spreadsheet. For example, interested parties may use totally different trailer attributes and trailer attribute values. However, it has been found to be beneficial in an embodiment for interested parties to have the same set of values for inbound and outbound shipment states. For example, in an embodiment, interested parties use the same movement type; use the same load status, handling method. Such users use a set of core trailer attributes, i.e. the same spreadsheet. However, in an embodiment, users may customize by basing their customization on such spreadsheet. Such users may add other trailer attributes and therein have their own mapping of trailers states to shipment state.

In an embodiment, headquarters does not have a spreadsheet. Because headquarters typically requires to view the shipment, which may be the least common denominator, plus other information that may be relevant.

In an embodiment, the spreadsheet is local. The facility owns it. Thus, at a particular facility, the users own their particular spreadsheet that does the mapping in accordance with the least common denominator and with the particular trailer states.

In an embodiment, there are four players: the source facility, the destination facility, the headquarters, and the trucker. And each of those has a dataset that is personal to them by which they keep track of the shipment. Each of them has a different set of data, because different data is pertinent to them. They do not need the information the other players need necessarily, and vice versa. Thus, they each have their own subset of the total dataset, however they all have something in common, which is the data from the least common denominator model.

In an embodiment, local trailer attributes are not available outside the local environment. In another embodiment local trailer attributes can be shared with other parties without meaningful, guaranteed semantics such as name value pairs.

### 2.15 Managing Idle Time

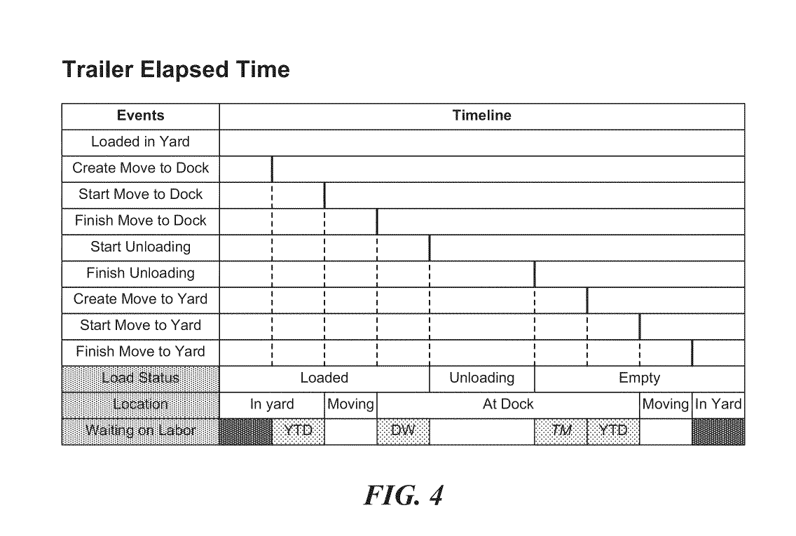

FIG. 4 is a chart of particular trailer states or events, load statuses, location, and waiting on labor versus elapsed time, in accordance with an embodiment. It illustrates how the model is used to focus on idle time. FIG. 4 captures a trailer loading sequence and highlights where one is waiting on some specific physical labor or a human intervention. In one embodiment, the sequence starts with a loaded trailer in the yard. A traffic manager (TM) creates a move for the trailer to be moved from yard to dock. At this point, the wait starts for the yard truck driver (YTD) to accept and then to complete the move. Until the move is completed, there cannot be progress on this shipment. Once the trailer is parked at the dock door, the onus is on the dock worker (DW) to unload the trailer most expeditiously. Until the trailer is unloaded there is no progress. Once the trailer is unloaded the system must be notified that the unloading is completed. Such responsibility may lie with the dock worker or a traffic manager (TM). At such time, in one embodiment, it may be desirable to move the trailer back to yard. In another embodiment it may be desirable to move the trailer to another dock door. In yet another embodiment, the trailer may stay at such dock door and be loaded with an outbound shipment. Once the new move is created, it is up to the yard truck driver to move the trailer back to the yard. Until such move is completed, the unloading of a subsequent shipment cannot be started.

### 2.16 Modeled Exceptions

It should be appreciated that given a mapping from trailer states to shipment states, in an embodiment, not every state, combination of states, or mapping of states may be valid, for example, from an operational point of view.

While one may have standard operating processes for a positive path operation, there are some exceptions that occur frequently that one has to include them in “typical system behavior.” For example, a person at the yard may have unloaded a shipment to realize that such shipment wasn't supposed to be for that person. For instance, it may have been meant to go across the street. However, the person had opened the shipment and started unloading it and then realized the error. Thus, in this example, the person closes the shipment, puts everything back in, and then sends the shipment back.

In an embodiment, the system is configured to model exceptions, for example, that occur with a predetermined acceptance of frequency. In an embodiment, the system is configured to provide rules for handling the modeled exceptions.

### 2.17 Unmodeled Exceptions

As mentioned above, it should be appreciated that given a mapping from trailer states to shipment states, in an embodiment, not every state, combination of states, or mapping of states, or state transitions may be valid, for example, from an operational point of view. An embodiment can be understood by the same example described in the section above, Modeled Exceptions.

It should be appreciated that sometimes there are exceptions that occur, however they are not modeled. Given the limited frequency and limited impact of some exceptions, for sake of simplicity, it is more beneficial to lump some exceptions that occur into one “unknown exception” and then delegate its resolution to entities outside the model. For example, a particular exception may not occur frequently enough to warrant modeling. For example, modeling such exception may incur costs that are not justified given a cost benefit analysis, such as incurring an expensive programming cost plus roll-out to production costs, or even training cost at all employee levels. In an embodiment, the system is configured to handle exceptions that are not modeled exceptions. For example, the system is configured to provide a notification, which may cause a person to obtain assistance, such as calling a supervisor who calls IT tech support, who then corrects the problem. In an embodiment, the system is configured to provide rules and guidance for handling the unmodeled exceptions but delegate to the “qualified” users to resolve the exception.

In an embodiment, a user may, as unmodeled exceptions happen, go back to the system and modify the system such as to prevent such unmodeled exceptions from happening. Or, the user may determine that if the unmodeled exception is going to keep happening, to make it into a modeled exception. In essence, embodiments herein provide users with the ability also to evolve and improve their business over time.

As the context of discussion is monitoring an analysis, it should be appreciated that an ultimate goal is to prevent exceptions from happening. As a user is able to reduce the frequency of some main “modelled” exceptions the user can over time focus on less frequent exceptions, model them, and then focus on preventing them.

### 3 Exemplary Functional Categories and Users

### 3.1 Exemplary Capabilities

In an embodiment, the system is configured to provide, but is not limited to provide the following functional categories:
Execution
   Steps taken to handle a Trailer and Shipment which in the process provide the data for Monitoring and Analysis;
Monitoring
   One or more processes that look at present data, focus on immediate issues, and accelerate Trailer Visits and Shipments;
Analysis
   One or more processes that look at past data to understand and improve performance, develop score cards, measure KPIs, and the like;

It should be appreciated that in an embodiment, planning is part of each functional category. One skilled in the art may readily recognize that the categories may be viewed, respectively, as operational (execution), tactical (monitoring), and strategic (analysis) planning.

### 3.2 Exemplary Users

In an embodiment, users of the system may include but are not limited to gate personnel, yard truck drivers, traffic managers, dock operators, transportation managers including those at headquarters, shift supervisors, general managers (GM) and so forth.

Table A illustrates site users of the system, their execution functions, what they monitor, and relevant analysis informational data, according to an embodiment.

TABLE A

| | Execution | Monitoring | Analysis |
|---|---|---|---|
| Gate personnel | Check-in/out | Missed in/out | — |
| Yard truck drivers | Move completion | (tags) | — |
| | Status updates | | |
| Traffic managers | Move creation | Trailer pools/aging | — |
| | Status updates | Move aging | |
| Dock operators | Status updates | Trailer aging | — |
| | Move creation | | |
| Transportation | Assign | Trailer/Shipment | — |
| managers | trailer and | aging | |
| (can be HQ) | shipments | Trailer Pool | |
| Shift supervisors | Exception | Dashboard | Performance/ |
| | corrections | | KPIs |
| GMs | Exception | Dashboard | Performance/ |
| | corrections | | KPIs |

Table B illustrates particular headquarters site users of the system, their execution functions, what they monitor, and relevant analysis informational data, according to an embodiment.

TABLE B

| | Execution | Monitoring | Analysis |
|---|---|---|---|
| Transportaion | Assign Shipment | Trailer/Shipment | Performance |
| Planners | and Trailers | aging | |
| | Provide handling | Trailer Pools | |
| | instructions for | | |
| | Trailers, Shipments, | | |
| | Drivers | | |
| Sr Management | — | Drive | Drive |
| | | Efficiencies | Efficiencies |

Table C illustrates other users of the system, who are from the site's perspective guest users, their execution functions, what they monitor, and what relevant analysis informational data they look at, according to an embodiment. A guest user may be a user that works for another corporation or is a private fleet driver.

TABLE C

| | Execution | Monitoring | Analysis |
|---|---|---|---|
| Carrier | NA | Trailer Pools | KPIs |
| | | Appointments | |
| | | Demurrage/Detention | |
| Customer | NA | Pending Arrivals | KPIs |
| OTR Driver | Check in/out | NA | NA |
| | Drop/Pick Up Trailer | | |

Table D provides a perspective of operational execution functions, according to an embodiment and illustrates local and central focus area.

TABLE D

| | Local Focus | HQ Focus |
|---|---|---|
| Check-in; Check-out | Gate Operations | Ensure pre- |
| Trailer, Shipment, | | population |
| Driver, . . . | | of data |
| Shipment Creation & | Inbounds get emptied . . . | Outbound planning; |
| Assignment | Outbound assignment! | Creation; |
| | | Assignment |
| Status Changes | Load Status, Movement | Can only monitor |
| of Trailer | Type, . . . | |
| Movement of | More creation and | Dock door planning; |
| Trailers | assignment | Creation of Journeys |
| Other: | | |
| Storage Trailers | Inventory Management | |
| Maintenance Trailers | Maintenance Management | |

Table E illustrates operational monitoring functions, according to an embodiment.

TABLE E

| | Local | HQ | Trading Partner |
|---|---|---|---|
| Check-ins + Integrity | Completeness | Progress | Progress |
| Check-outs + Integrity | Completeness | Progress | Progress |
| Aging empty Trailer | Accelerate | Progress | Progress |
| in yard/dock | | | |
| Aging loaded Trailer | Accelerate | Progress | Progress |
| in yard/dock | | | |
| Trailer pool availability | Plan ahead | Plan ahead | Plan ahead |
| Shipment Aging | Accelerate | Progress | Progress, |
| | | | Plan ahead |
| OTR Driver Aging | Accelerate | Progress | Progress |
| Move Queues/Aging | Accelerate | Progress | NA |
| VT Driver Productivity | Accelerate | Progress | NA |
| Exceptions | Intervene | Intervene | Plan Ahead |

### 3.3 Exemplary Execution Workflow

A preferred embodiment can be understood by the following example of operational site users and their tasks for unloading a trailer with minimum intervention due to the network aspect of the system. Such example is for illustrative purposes and is not meant to be limiting.
Integration
   Shipment IL011 in Pending Arrivals
Head Quarter Manager/WTM (or as part of Integration)
   Specify that Load will empty at Dock 12—set Journey “Dock 12 Round-Trip Unload”
Check-In by Gate Personnel
   Verify information upon trailer arrival, correct as necessary
   Request Drop in Zone 3
   Start Journey (Journeys are discussed below)
Yard Management System
   Create move to Dock 12 (as specified by the Journey)
Yard Truck Driver
   See, accept the move
   Drive and perform the move
   Complete the move
Dock Operator
   Specify (WMS or Tablet interface at Dock) that unloading started
Dock Operator
   Perform the unloading
   Specify (WMS or Tablet interface at Dock) that trailer is empty
Yard Management System
   Trigger move creation when trailer is set to empty
Yard Truck Driver
   See, accept the move
   Drive and perform the move
   Complete the move
Warehouse Traffic Manager/Yard Truck Driver/HQM
   Verify actions, Close Shipment (Sets movement type=Outbound)

### 3.4 Exemplary Implementation of Capabilities for Users

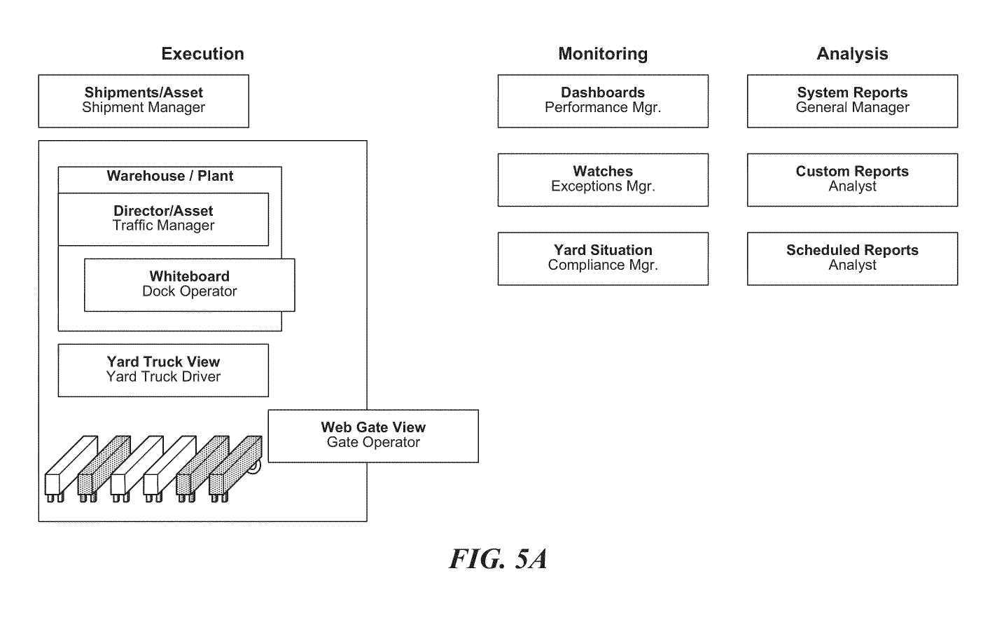

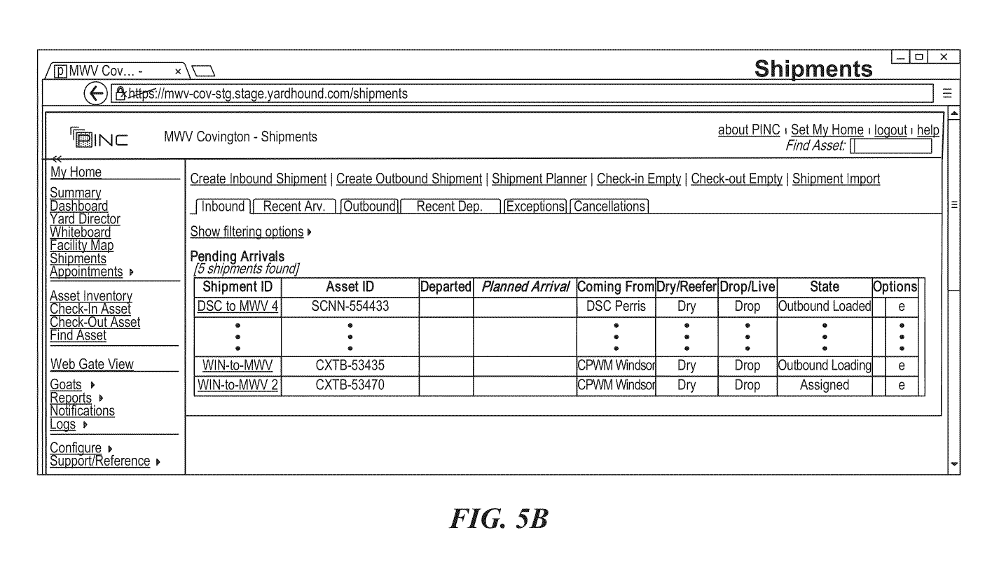

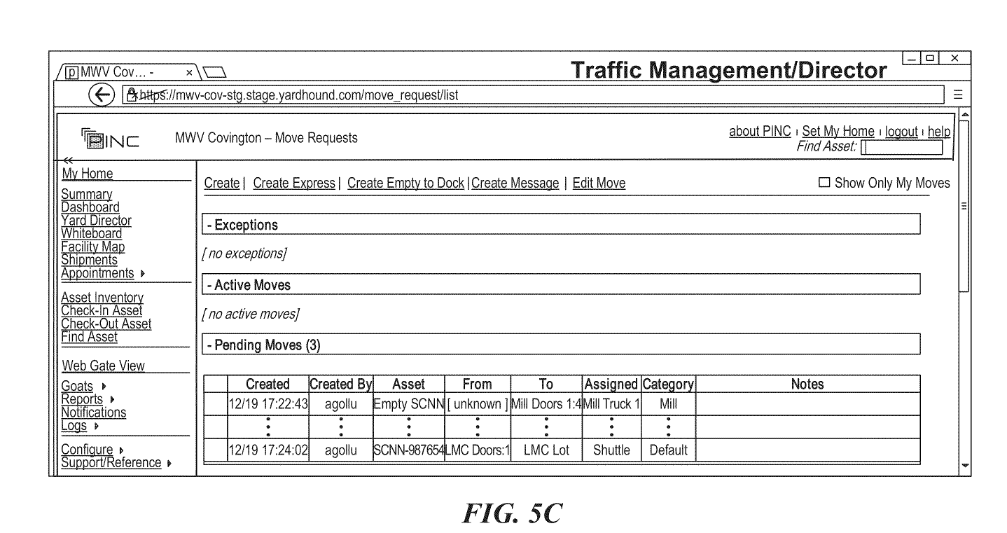

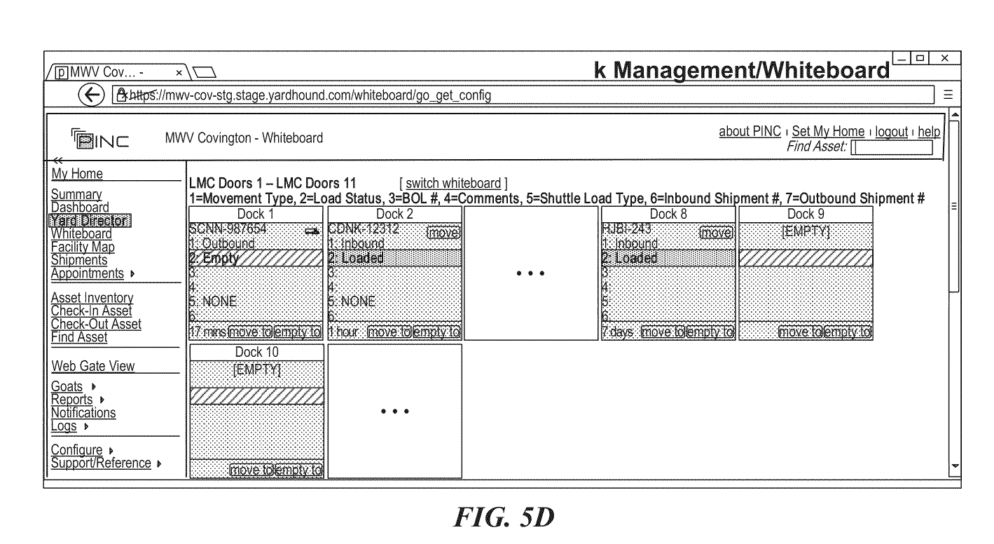

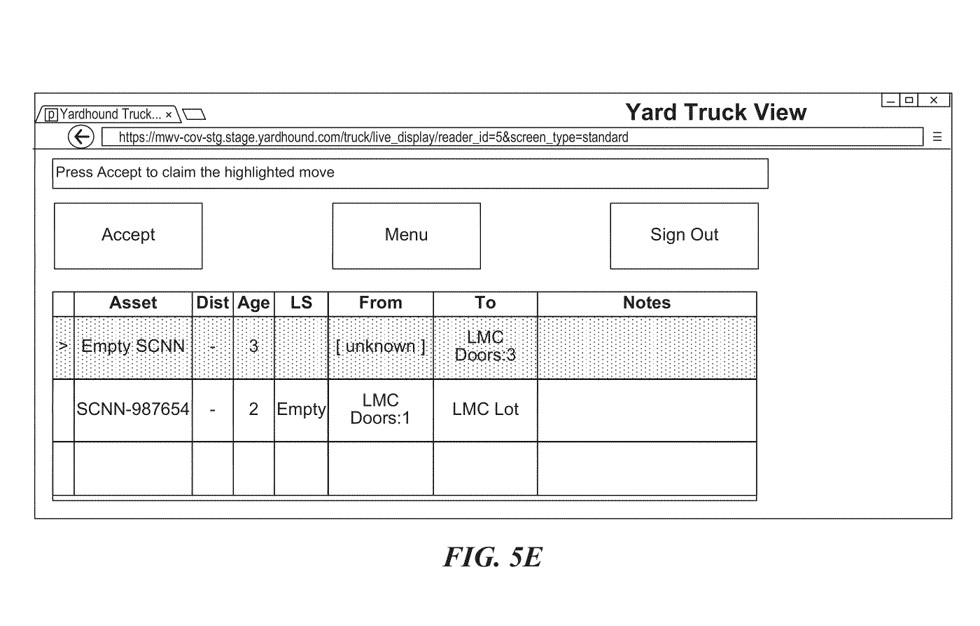

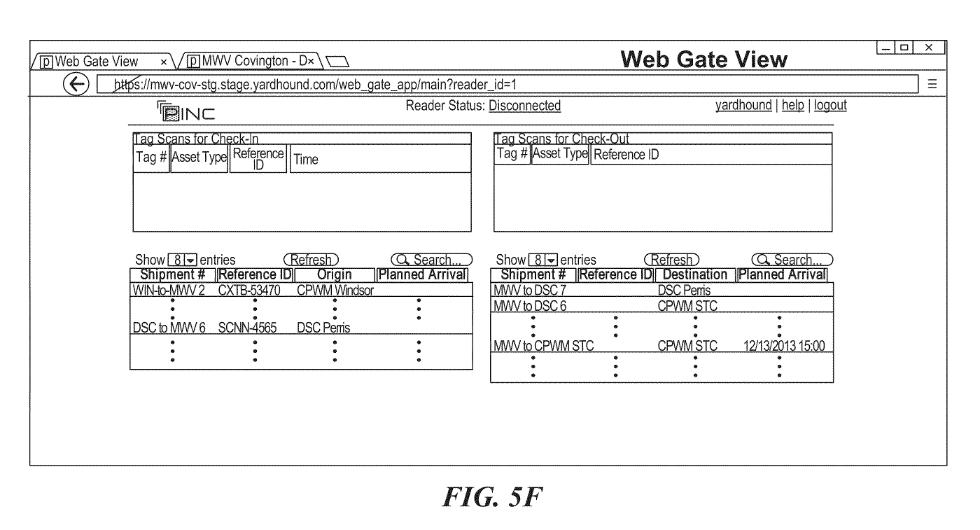

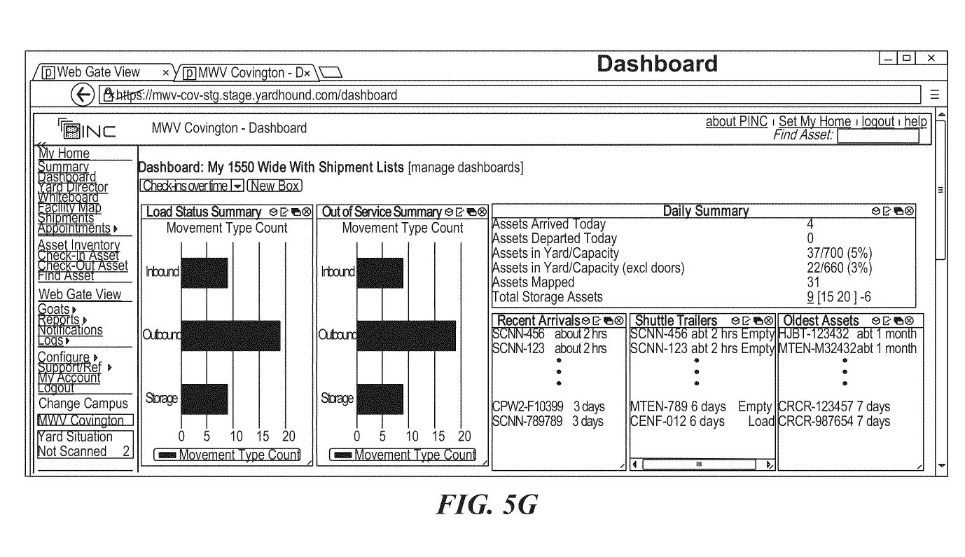

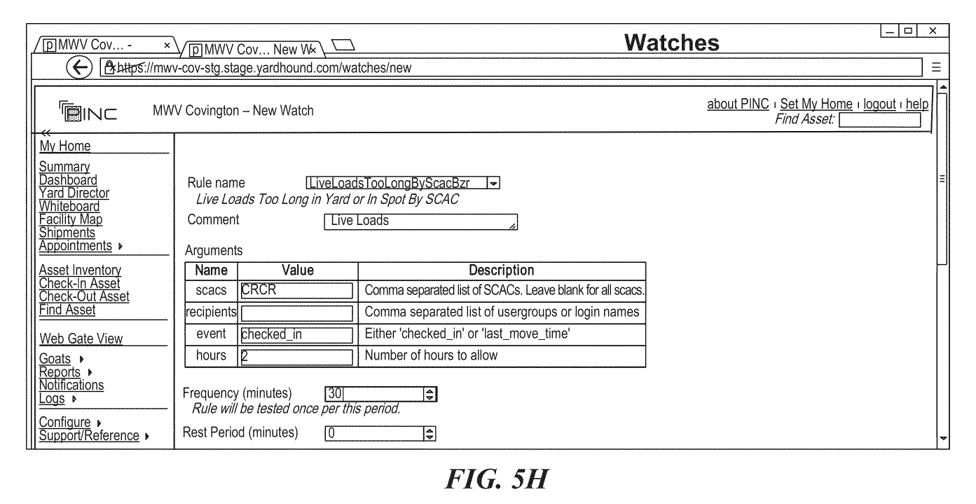

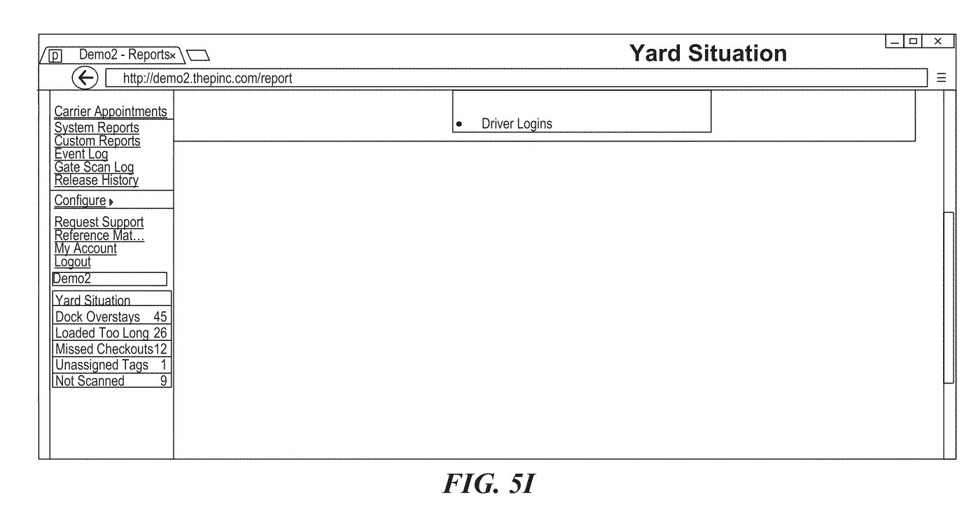

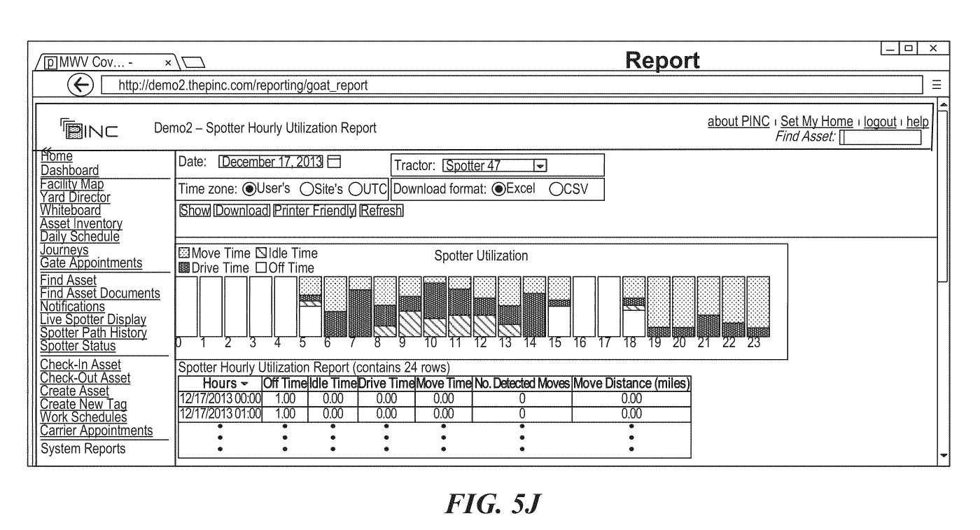

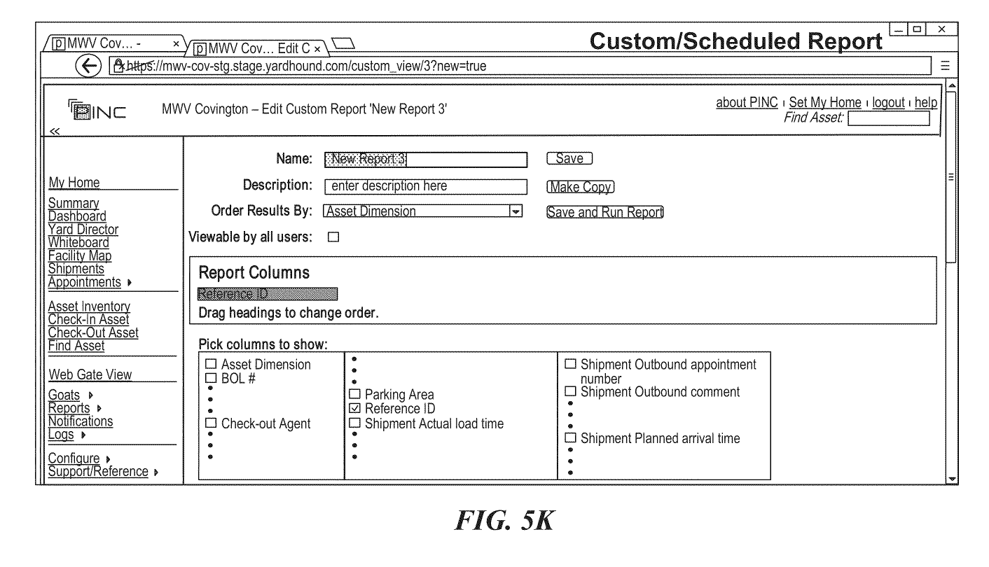

The sequence of Figures FIG. 5A to FIG. 5K show different exemplary interfaces that different users may leverage for various execution, monitoring, and analysis capabilities. FIG. 5A shows a high level outline of the different user views for execution, monitoring, and analysis. FIG. 5B shows a sample view for shipments that a Shipment Manager may use. FIG. 5C shows a sample view for a traffic manager that is overseeing the trailer movement in the yard. FIG. 5D shows a sample view for a dock manager which uses a “whiteboard” to manage the trailers at the dock doors. FIG. 5E shows a sample yard truck view that yard truck driver uses to interact with the system. FIG. 5F shows a sample web gate view that a person at the main gate uses to check a trailer and a driver, in and out. The figures FIG. 5B-5F are sample execution users and their interfaces. FIG. 5G shows a sample dashboards view. FIG. 5H shows a sample view for watches. FIG. 5I shows a sample yard situations view. These three are monitoring capabilities to observer the system and intervene where necessary. FIG. 5J shows a sample reports view. FIG. 5K shows a sample custom/scheduled reports view. These two are analysis users who need to assess past performance and modify future processes and KPIs.

### 4 Implementation Examples

### 4.1 Preliminaries

Before we get into implementation details of a possible embodiment we discuss some additional constructs that increase the value of the invention.

### 4.1.1 Supporting Constructs: Operations

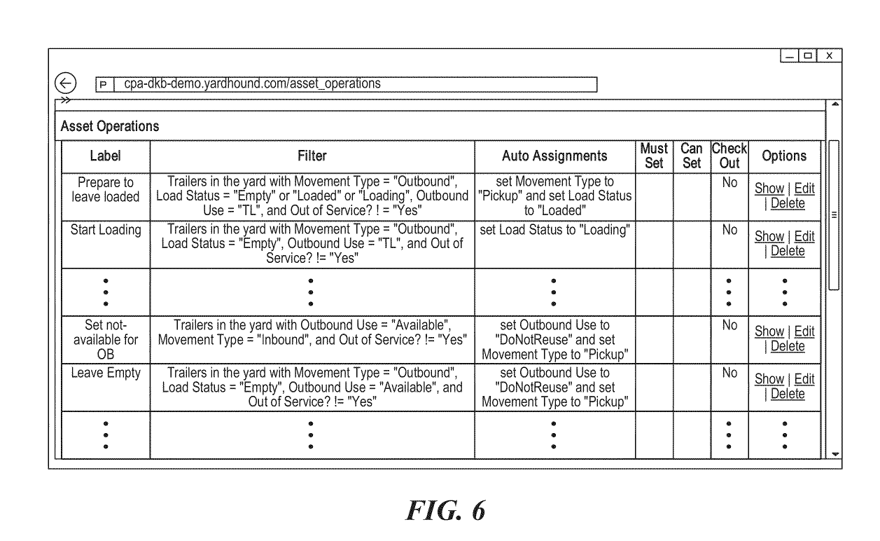

An embodiment can be understood with reference to FIG. 6, a chart of Asset Operations including but not limited to type of Label, Filter, Auto Assignments, what Must be Set, what Can be Set, Check out and types of Options.

These are customizable Operations that can be used to build workflows based on data model elements. They shield individual users from the details of the data model and bring the assembly line approach to the workflow execution.

### 4.1.2 Supporting Constructs: Journey—a Sequence of Planned Moves

Users may be interested in implementing a sequence of planned moves also referred to herein as a journey. In one embodiment, a journey is a sequence of moves each created only when certain conditions are satisfied, such as for example but not limited to:
Target locations are open
Trailer attributes match filter.

An example of such journey is: DockDoor12 Round-Trip Unload, wherein such journey:
Applies to Trailers where
   Movement Type=Inbound
   Load Status=Loaded
   First Move: Move Trailer to Dock 12
   Only created if Door 12 is empty
Second Move: Move to Lot
   Condition: Load Status=Empty

In an embodiment, a journey may be authorized only on trailers that match a filter.

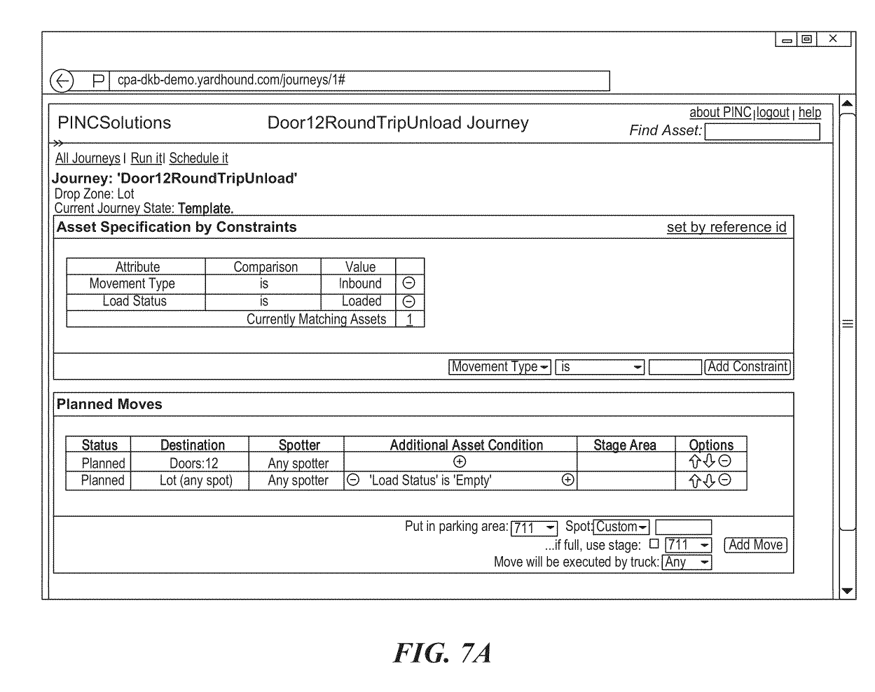

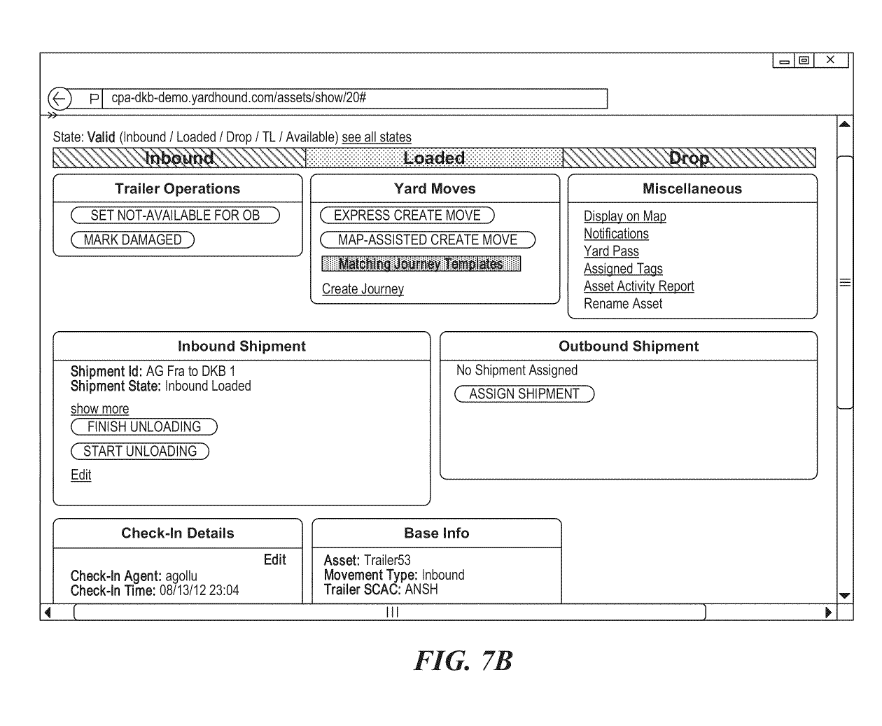

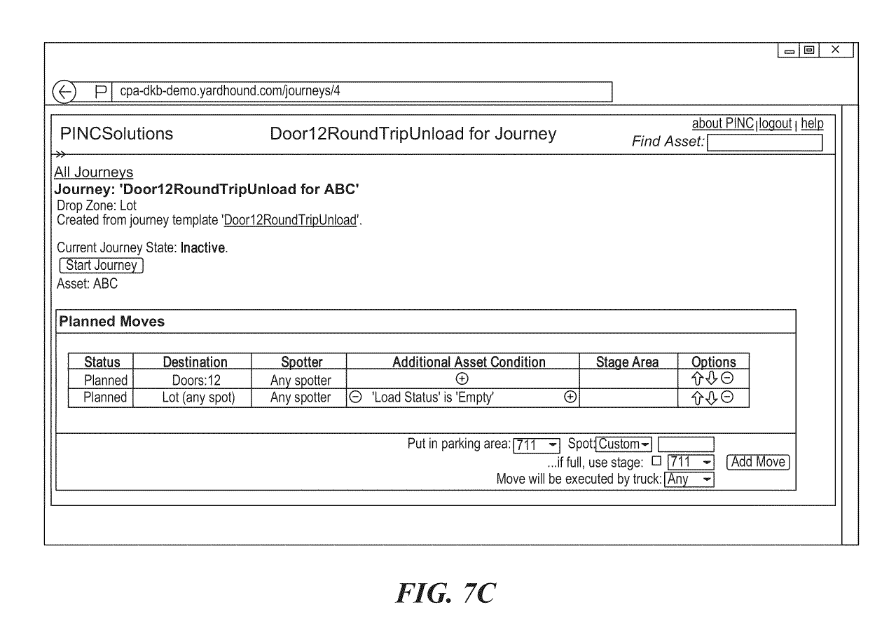

FIG. 7A is a sample screen shot of an asset specification and planned moves page of the system according to an embodiment. In the example, Attributes of Movement Type and Load Status are shown, as well as the Comparison type. The respective Values are Inbound and Loaded, respectively. The system determines and shows that there is currently one matching asset. There are drop down boxes for Attributes, Comparison, and Values, as well as a selection box to add other constraints. In the embodiment, regarding the Planned Moves, the following types of data, but not limited to such types of data, can be configured: Status, Destination, Spotter, Additional Asset Conditions, Stage Area, and Options. As well, users may indicate which parking area to put trailer, which spot, and to add a move, etc. FIG. 7B is a sample screen shot of an embodiment where the system determines an appropriate Journey for processing an Inbound Trailer/Shipment. FIG. 7C is a sample screen shot of the planned moves for a particular journey, according to an embodiment.

### 4.1.3 KPIs and Metrics

Both for Monitoring and Analysis one needs to leverage metrics and Key Performance Indicators (KPI)s to oversee execution. In monitoring, one focuses on current performance to intervene, while in analysis one looks at past performance, to make process changes and to change metric and KPI targets.

Metrics may be expressed a single numbers or as a sequence (vector) of numbers. Examples of number metrics are:
The total number of moves performed by spotter 1 last week
The number of Trailers that checked out between set dates
The average time-in-yard for Trailers that checked out between set dates

Examples of vector metrics are
The total number of moves performed by all spotters last week
The number of Trailers that checked out between set dates by Trailer SCAC

A metric or KPI can be used to express a performance value, or one can also work with a “target” and show performance against a target.

One can also look at the time history of a metric and KPI.

### 4.1.4 Reports

Reports may be used to generate multidimensional data. They can be used to look at current information or to look at past performance.
The number of moves performed by spotter 1, last week by hour and day, e.g. 168 values
Total time in yard for each Trailer for trailers that checked-out between set dates

### 4.2 Execution—Exemplary Shipment and Trailer Management

As mentioned hereinabove, two different types of work flow scenarios are described in detail using screen shots of an actual implementation. Embodiments may be understood with reference to the following sets of figures, depicting particular work flows. FIGS. 8A-8AM depict an exemplary Drop Load scenario according to an embodiment and discussed in detail below. FIGS. 9A-9O depict an exemplary Live Load scenario according to an embodiment and discussed in detail below. For purposes of understanding the work flow screen shots, four execution roles referenced in the exemplary users and functional categories are listed below under their respective area of responsibility:
Site Responsibilities
   Dock Door Manager View
      White Board
      Asset
   Yard Truck Driver View
   Gate/Guard View
Transportation Responsibilities: Shipping/Receiving/Load Manager
   May be at source/destination/headquarters depending on organization, shipper, and source/destination facility.

In the work flow scenarios screen shots, Source tabs and Destination tabs are provided. Source tabs include but are not limited to “Gate View,” “Yard Truck,” “Dock View,” and “Ship View.” The middle tab is “HQ View” for Headquarters View. The Destination tabs include but are not limited to the same tabs as the Source tabs, but the displays represent data from the Destination point of view, whereas the Source tabs represent data from the Source point of view.

### 4.2.1 An Exemplary Drop Load Scenario

FIGS. 8A-8AM are sample screen shots of the exemplary Drop Load scenario, according to an embodiment. The user perspectives depicted are gate person, yard truck driver, dock manager, shipment manager both at source, and destination facilities as well has headquarters personnel at either facility's corporation. FIG. 8A shows how a shipment is created in an overall integration upload of shipments in the system. An Outbound panel is shown in which information is requested and collected. For example, Shipment ID is requested and, in the screen shot, is depicted as Shipment 7. As another example, the destination is selected in a dropdown box as “GRB.” FIG. 8B shows a Source-Ship View and HQ View of panels configured to enable a user to configure eligible trailer filters, as well as filter shipments panels, and to assign the shipment to a trailer. FIG. 8C shows a Destination-Ship View and HQ View of pending arrivals. FIG. 8D shows a Source-Dock View of a particular trailer that is ready to be moved to dock where one can also see the shipment assigned to the trailer. By selecting “Express Create Move” one can create a move. FIG. 8E shows a Source-Dock View of a screen to create the move to dock. FIGS. 8F-8G each shows a Source-Dock View of a screen to view the pending move. FIG. 8H shows a Source-Yard Truck view to see and accept the move. FIG. 8I shows a Source-Yard Truck view to work on the move to complete the move. FIG. 8J shows a Source-Yard Truck view to complete the move. FIG. 8K shows a Source-Dock View to view the assets at each dock. FIG. 8L shows a Source-Dock View to start loading. FIG. 8M shows a Source-Dock View to finish loading. FIG. 8N shows a Source-Dock View to create the move to the yard. FIG. 8O also shows a Source-Dock View to create the move to the yard. FIG. 8P shows a Source-Yard Truck view to see and accept the move. FIG. 8Q shows a Source-Yard Truck view to complete the move. FIG. 8R shows a Source-Yard Truck view to override the destination. FIG. 8S shows a Source-Dock View to see that an asset is ready to be picked up. FIG. 8T shows a HQ View and a Destination-Ship View to see the process and, in particular, to see that the load is ready to be picked up. FIG. 8U shows a Source-Gate View to see that the carrier arrives with an empty drop, which, in an embodiment, is via a tag scan. FIG. 8V shows a Source-Gate View to check in an empty-drop trailer. FIG. 8W shows a Source-Gate View to fill in detailed information. FIG. 8X shows a Source-Gate View of a carrier that picks up a trailer that comes to the exit. FIG. 8Y shows a Source-Gate View of a carrier exiting and ids for the trailer and shipment are tagged. FIG. 8Z shows a Source-Gate View showing a carrier exits. FIG. 8AA is an HQ View and a Destination-Ship View showing that a shipment is en route. FIG. 8AB is an HQ View and a Destination-Ship View showing an inbound planner action panel. FIG. 8AC is a Destination-Gate View showing that a carrier arrives at the gate. FIG. 8AD is a Destination-Gate View showing that an urgent load is directed to Door E1. FIG. 8AE is a Source-Ship View and an HQ View showing the progress on recent departures. FIG. 8AF is a Destination-Ship View and an HQ View showing the progress on recent arrivals. FIG. 8AG is a Destination-Dock View to start unloading. FIG. 8AH is a Destination-Dock View to finish the unloading. FIG. 8AI is a Destination-Dock View to create a move. FIG. 8AJ is a Destination-Yard Truck View to see and accept the move. FIG. 8AK is a Source-Ship view and an HQ View to show the progress and when the shipment is unloaded. FIG. 8AL is a Destination-Dock View to close the shipment and accept the shipper load and count (SLC). FIG. 8AM is a Source-Ship View and an HQ View showing a shipment is closed.

### Integration and Benefits

It should be appreciated that in an embodiment, arrival event updates are sent to Transportation Management System (TMS). In this case for illustrative purposes, the TMS from Oracle Corp, referred to as OTM, is used. Any delays trigger one or more alerts. As well, because carriers also have access to the real time shipment status, they can better arrange just-in-time arrival, reducing loaded trailer idle time in the yard.

Embodiments herein enable faster Check-in/Check-out of the carrier driver, which saves significant driver idle time.

It further should be appreciated that in accordance with embodiments herein, the carrier driver may pick up a different trailer at the Destination site and depart. At this point the carrier may have completed its responsibilities for the shipment. Significantly, getting the carrier driver in and out faster saves transportation cost. Planning for the arrival of the trailer, reduces the idle time of the loaded trailer in the yard.

### 4.2.2 an Exemplary Live Load Scenario

FIGS. 9A-9O are sample screen shots of the exemplary Live Load scenario, according to an embodiment. FIG. 9A is a screen shot showing a shipment is created for a tendered shipment upload in the system. An Outbound panel is shown in which information is requested and collected. For example, Shipment ID is requested and, in the screen shot, is depicted as Shipment 9. As another example, the destination is selected in a dropdown box as “GRB.” FIG. 9B is a HQ View showing the shipment in the system. FIG. 9C is a Source-Ship View to show appointment information arrives via integration into the system. FIG. 9D is a Source-Gate View to show that the carrier checks in empty. FIG. 9E is a Source-Gate View showing that the carrier is directed to Door 9 and that Door 8 is busy. FIG. 9F is a Source-Dock View showing the trailers that are at which dock. FIG. 9G is a Source-Dock View to start loading. FIG. 9H is a Source-Dock View to finish loading. FIG. 9I is a Source-Gate View to show that the carrier arrives at the gate and the ids for the trailer and shipment are tagged. FIG. 9J is a Source-Gate View showing the carrier is checked out. FIG. 9K is an HQ View and a Destination-Ship View showing that the shipment is en route. FIG. 9L is an HQ View and a Destination-Ship View for arrival instructions. FIG. 9M is a Destination-Gate View to show the carrier is at the gate. FIG. 9N is a Destination-Gate View for last minute instructions, such as but not limited to “Convert to Drop.” FIG. 9O is a Destination-Dock View about the particular trailer.

### Integration and Benefits

It should be appreciated that in an embodiment, carrier arrival/departure times are reported to the OTM. An embodiment provides delay alerting. In both Drop/Live scenarios the order fulfillment cycle is short.

### 4.3 Monitoring—Dashboards, Notifications, Alerts

As mentioned hereinabove, the least common denominator model may be used in the provisioning of universal dashboards for shipment and trailer management based on such data. In this way, the universal dashboard enables different types of end users to share and communicate regarding common types of data and terminology.

4.3.1 Exemplary Exceptions and Monitoring at Site Level with Alerts and Notifications

In an embodiment, alerts and notifications are provided. For example, if there are situations that occur in the yard, then the system provides a set of site alerts. Regarding particular assets, notifications are provided. As well, configurable business rules are provided that may be referred to as watches. An embodiment includes but is not limited to the following:
Yard Situation—a set of Site Alerts
   pre-defined e.g. “possible missed check-out”; and
   configurable e.g. “dock lane overstay” configure n-hours
Notifications—Created on Specific Assets
   for specific conditions e.g. “Asset did not leave n hours”
Watches—a set of configurable business rules
   that are “tested” at set intervals

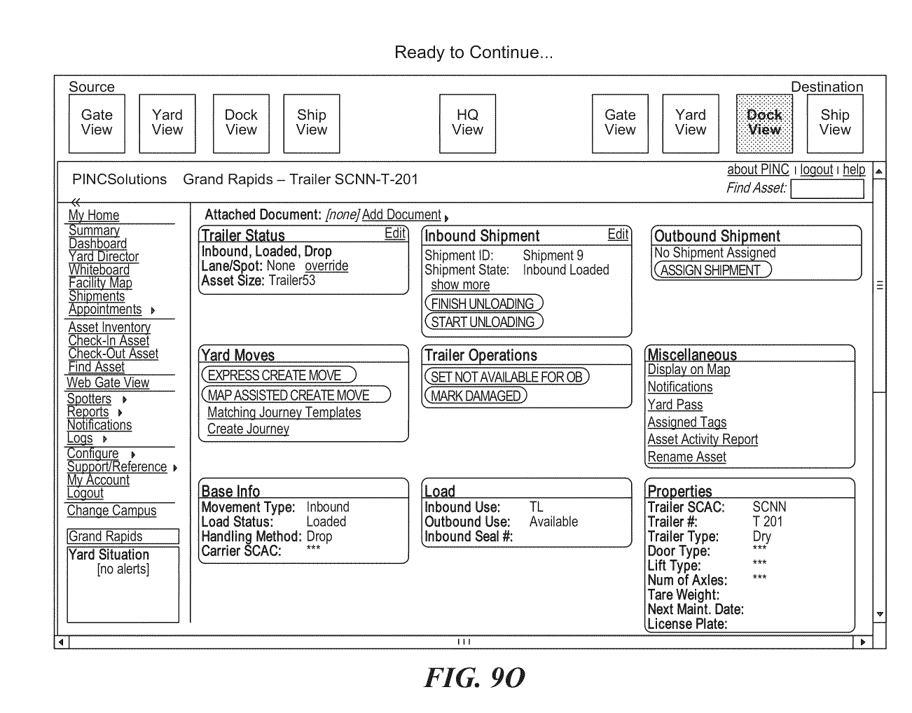

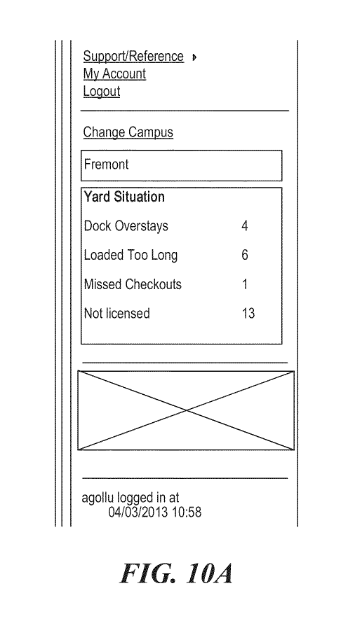

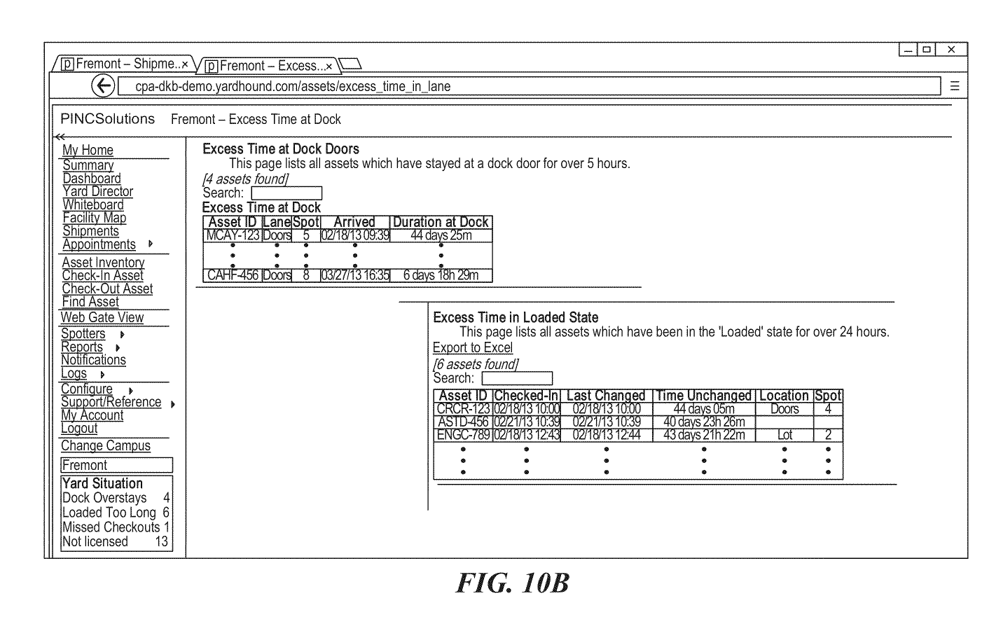

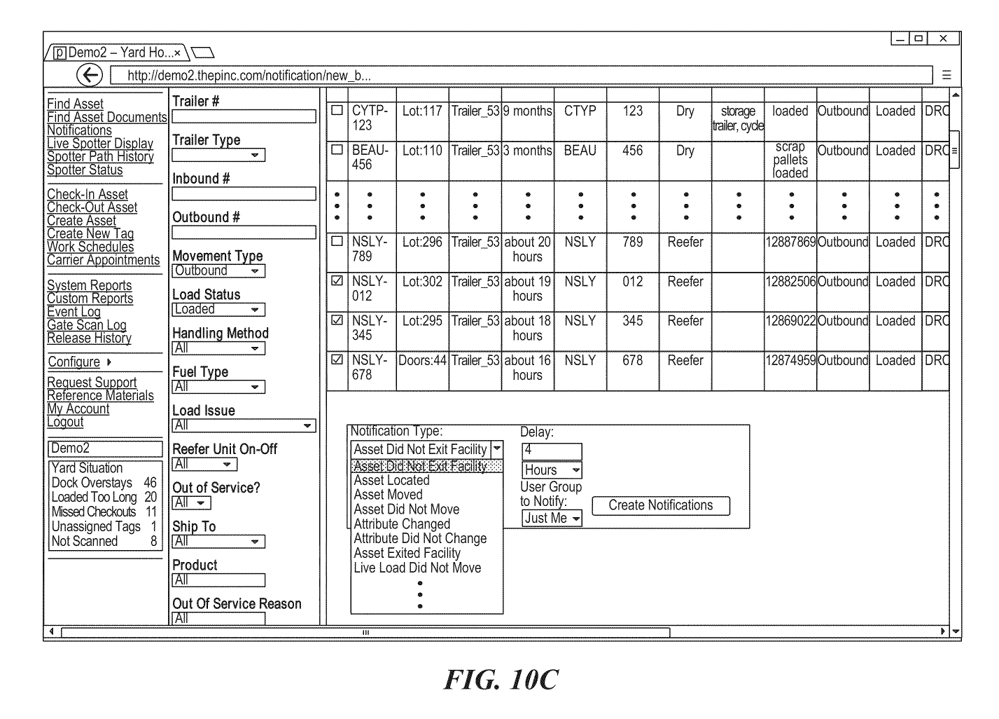

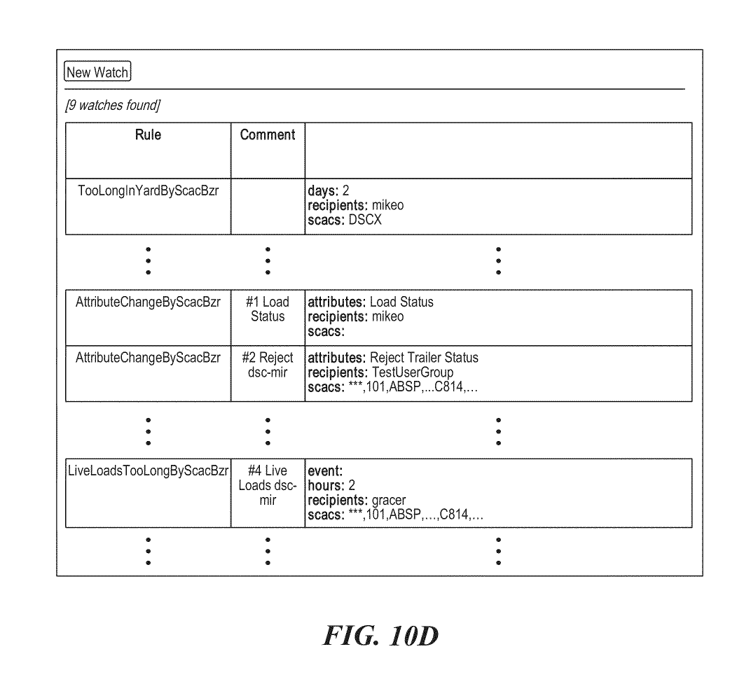

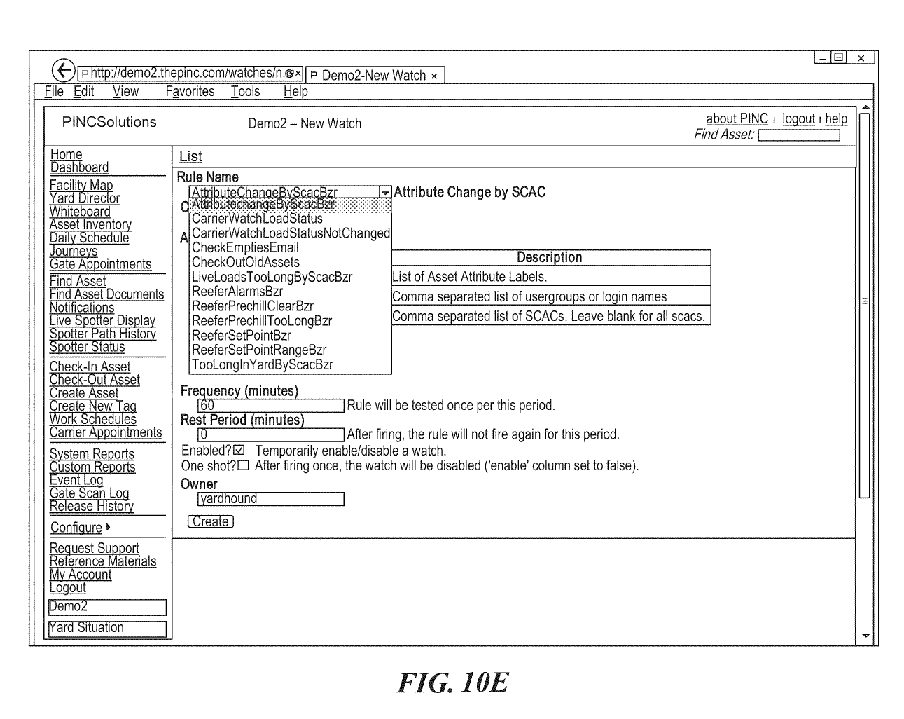

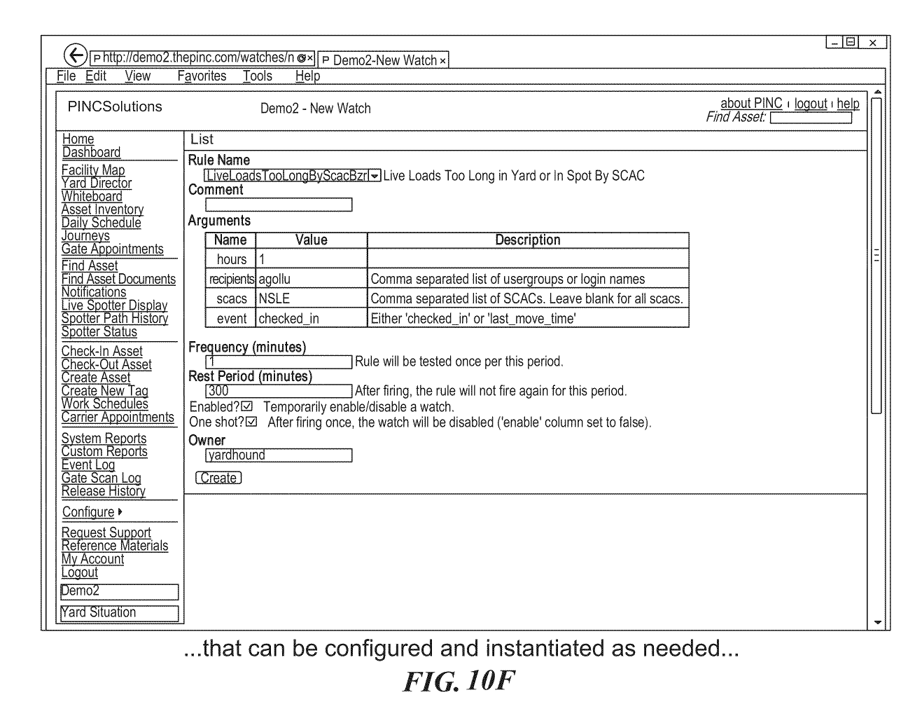

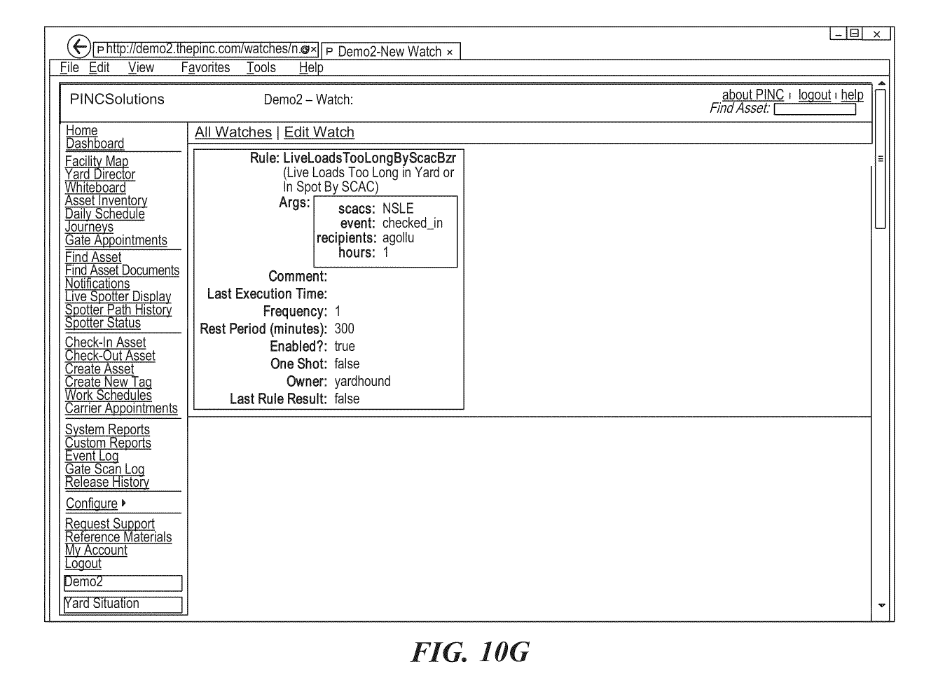

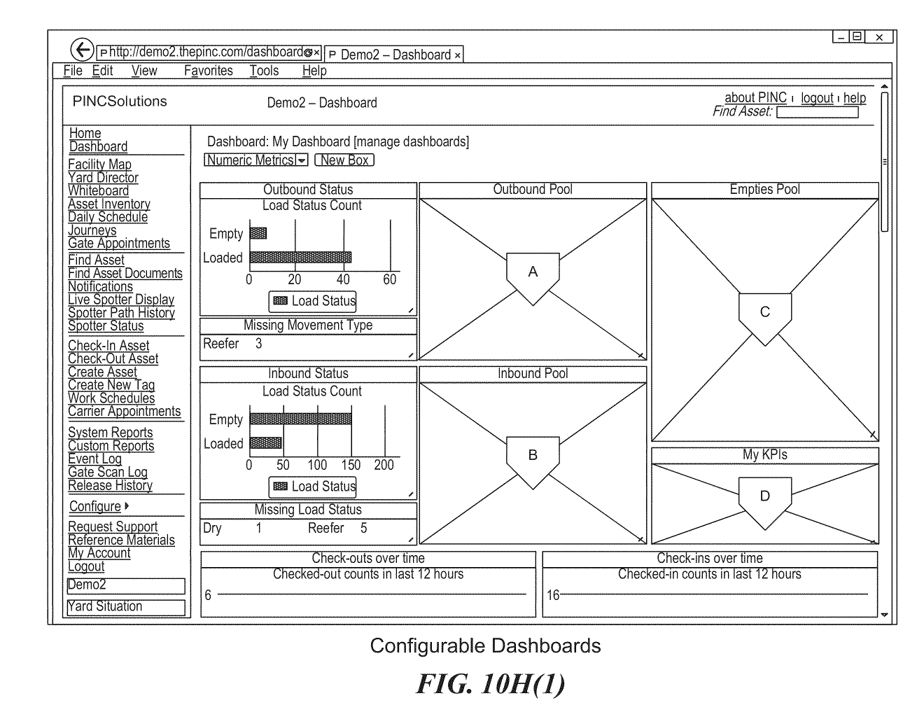

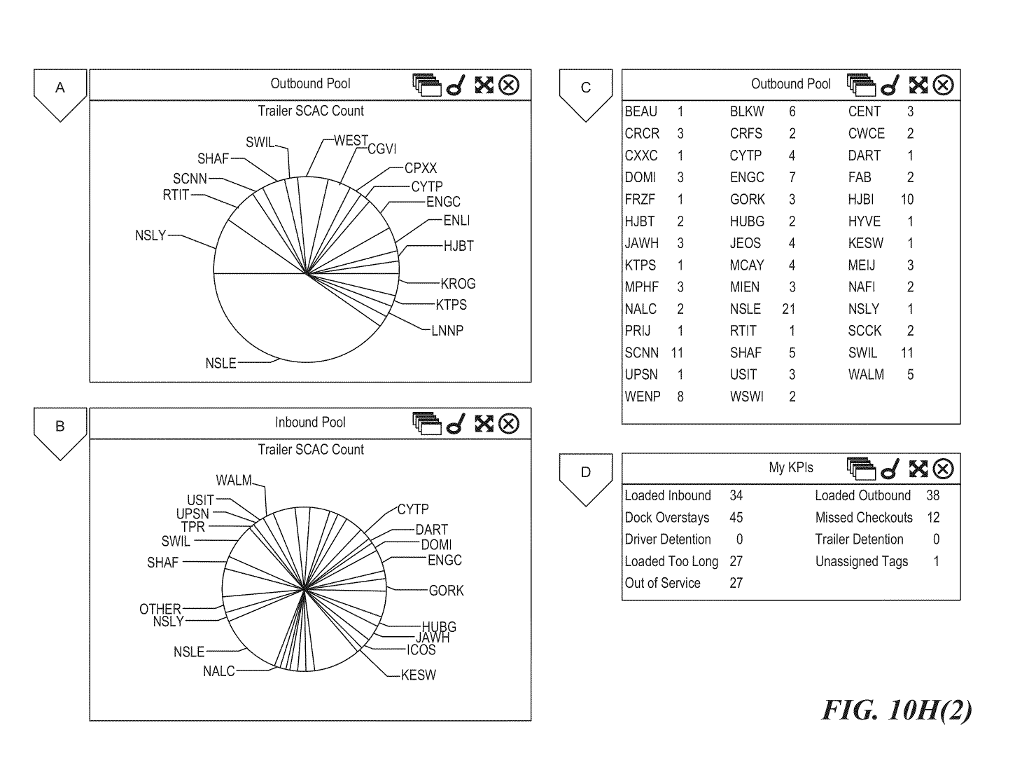

FIG. 10A is a sample screen shot snippet of Yard Situation alerts and in particular a list of key performance indicators (KPI) reported in the Yard Situation area. For example, Dock Overstays, i.e. number of trailers that have been at the dock for too long, are 4. The number loaded too long, i.e. the number of trailers that have been in a loaded state, is 6. The number of missed checkouts is 1, and the number of not scanned (referring to the Real Time Location System performance) is 13. In an embodiment, a complete list of available KPI measures may appear on the configuration page for this parameter. KPIs may be customer specific and may differ from site to site. Additionally, KPIs may not appear unless there are instances of the condition they describe. FIG. 10B is a screen shot of yard situation details. For example, the figures show excess time at the dock doors and excess time in the loaded state—details of previous KPIs. FIG. 10C is a screen shot of notifications created on individual or set of assets for configurable conditions and recipients. FIG. 10D is a screen shot of particular watches. In an embodiment, watches are alerts that are emailed to users and are based on rules selected by the user. Such rules may range from, but are not limited to, loaded too long, attribute changes, to auto checkout of assets for tasking only location. FIG. 10E is a screen shot illustrating that watches are a set of business rules. FIG. 1OF is a screen shot illustrating that such business rules of FIG. 10E may be configured and instantiated as needed. FIG. 10G is a screen shot illustrating that such business rules further are user modifiable.

FIG. 10H is a screen shot of a configurable dashboard in according to an embodiment.

### 4.3.2 Exemplary Exceptions and Monitoring at Network Level

An embodiment of the dashboard can be understood with reference to FIGS. 11A-11L. FIG. 11A is a sample screen shot of a central access to an entire network, according to an embodiment. In particular, it shows the Monitoring view of data regarding Trailers: Overview and Shipments: Overview.

It should be appreciated that sequence 11B-11D is an example of a very structured kpi/metric that has been defined and that has acceptable value thresholds and an attached process of handling the situation when the site is outside the acceptable thresholds.

FIG. 11B is a sample screen shot of the Monitoring view of Carrier Trailer Pool Management, according to an embodiment. Specifically, data displayed are By Site and By SCAC contractual pool sizes that are not in compliance. Any carrier that is below contractual threshold is highlighted for immediate action. FIG. 11C is a sample screen shot of the next step in the exemplary remediation process. When a user clicks on the cell in FIG. 11B representing Alam 1 site, for Carrier SCAC ABKW the user sees the detail that while the contract specifies 3-5 trailers, currently there are 2. This sample shows that access to site details may be obtained at central transportation control. FIG. 11D is the next step of detail, namely the actual list of trailers and their current state, showing how information is actionable, according to an embodiment. A next step may be to inform a carrier with an e-mail with the on screen action button.

Sequence 11E-11H is an example of a situation where a user may not have a very well defined metric/KPI for a condition. However, an experienced user may be looking at the situation more broadly to identify a condition that is problematic, even when there may be no particular rule that identifies it as such. The intent of such sequence example is that over time such type of exercise using embodiments herein may result in additional structured KPIs.

FIG. 11E is a screen shot of a sample dashboard view for monitoring a yard, referred to therein as yard slicer, according to an embodiment. In particular, statistical data are computed and presented for check-in date, arrival time of day, trailer count by time in yard, trailer count by time in current state, etc. It should be appreciated that not every situation can be reduced into one KPI, and, thus, by way of the dashboard, one skilled in the art may slice-dice the data. For example, one may click and drag interface attributes to simplify access. This particular example focuses on aging trailers in yard. FIG. 11F is a screen shot of the dashboard in which an aged trailer still in Inbound state is clearly indicated, according to an embodiment. FIG. 11G is a screen shot of an example Execution view in which it is shown that the first level of detail reveals no action has been taken on Trailer. FIG. 11H is a sample screen shot of site level detail, which can be accessed at central control, according to an embodiment.

See FIG. 11I is a screen shot of a Monitoring view of example KPI values, according to an embodiment. For example, one skilled in the art may use such configured dashboard page to manage that Trailers should not idle in “Inbound Loaded” or “Outbound Loaded” state above set thresholds (separate for live vs. drop) and other similar drill down capabilities. FIG. 11J is a screen shot of a Monitoring view of more KPIs, according to an embodiment. Some KPI exception management examples may include but are not limited to: Real Time Focus on appointments; and Any late arrivals or departures immediately flagged. It should be appreciated that in an embodiment the system may know appointment times through integration; actual execution details, appointment adjustments are managed by users on the ground, supported by RFID data gathering automation. It should be appreciated that FIG. 11I and FIG. 11J depict structured cases. It should be appreciated that in an embodiment, such dashboards are configured to be visible and legible when accessed from tablets, smartphones, or any device and from anywhere.

### 4.4 Analysis—Exemplary Scenarios

As mentioned above, the least common denominator data model combined with the vast and varied data stored at the corporate level and at the local level allow for the computing of meaningful, optimized statistics regarding trailers and shipments. An embodiment is provided that uses such vast amount of collected or stored data to provide the basis for a plethora of reports. One embodiment enables number metrics to be planned, projected, determined, etc., based on analyses of such data. As well, KPIs may be determined from analyses of the data or may be used to drive the business, such as for example in setting target metrics.

### 4.4.1 Performance Analysis

An embodiment enables analyzing elements and events for the purposes of understanding performance. For example, events may be placed into categories or buckets to help organize and determine solutions to particular areas. For example, placing events in particular categories may be used to answer the following questions: “If everything goes well, what happens? What are the exceptions that I'm having? What can I do to reduce them? What are the unmodeled exceptions? Are these happening frequently enough so that I need to model it, because they are a cost of doing business? Or, if something that I modeled never occurs, then maybe I should get rid of it and treat this as an unmodeled exception.”

The system may be configured to enable a user to detect inefficiencies, such as for example, determine how long a trailer, on average, sits in the yard waiting to be picked up. The user may not want to keep a trailer which broke down, had a flat tire, could not move, and had a missing part such that it sat in the yard for four days. Thus, the system provides a utility to such user by enabling him to determine by performing analytics and viewing related data that he does not want to keep such trailer.

In an embodiment, performance metrics are derived based on positive paths, as well as handled exceptions. For example, using statistical analysis, exceptions may be determined based on the number of standard deviations away from the norm the exception may occur. An exception may be deemed an outlier or may illuminate an area which needs improvement. Thus, the provided data model in accordance with embodiments herein enable, result in, and cause improved performance analysis.

In an embodiment, the system is configured not to mix data among the three categories: positive path, modeled exceptions and unmodeled exception. Such mixing may result in meaningless average numbers. For example, when a user is monitoring the data, the user may want to know if an operation is an unmodeled exception; for example, if the user needs to get involved. If an operation is a modeled exception, then the user may want to continue to monitor such type of operation. For an example implementation, the modeled exception may cause a yellow alert, as opposed to a red alert, and the workers may be able to handle the exception.

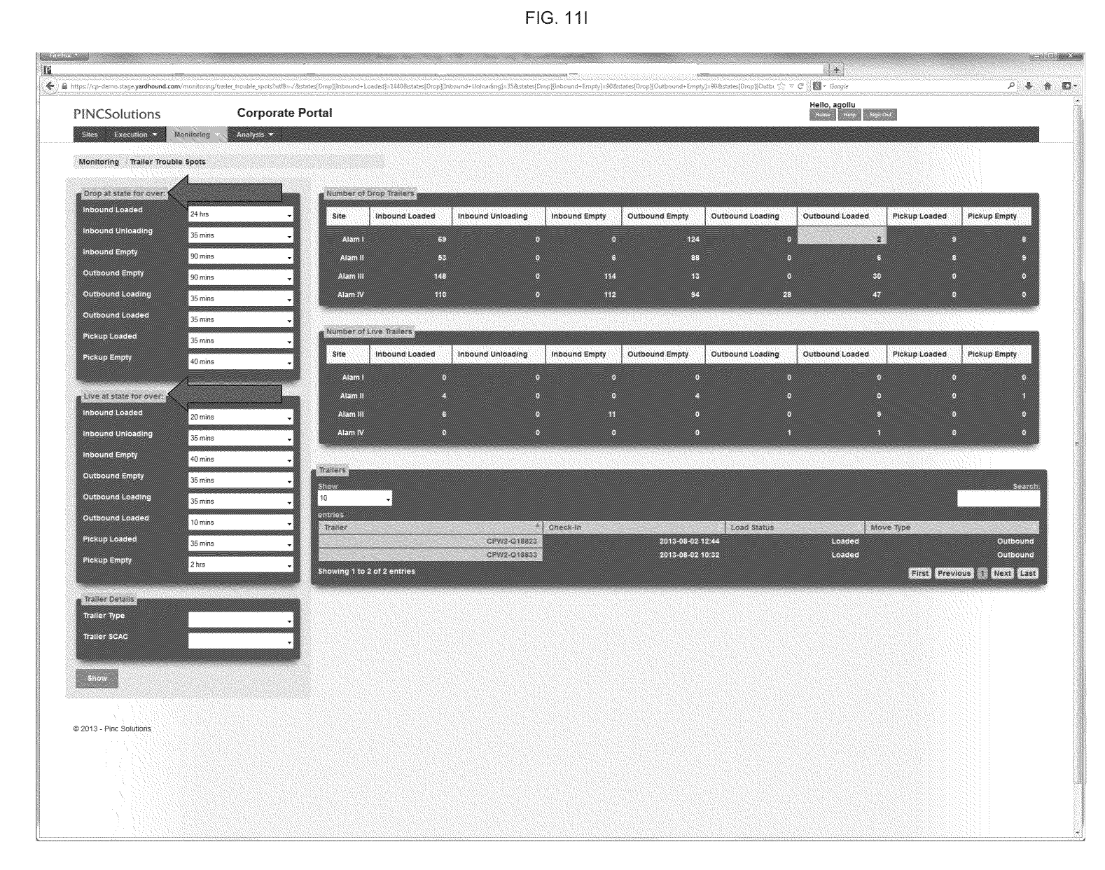

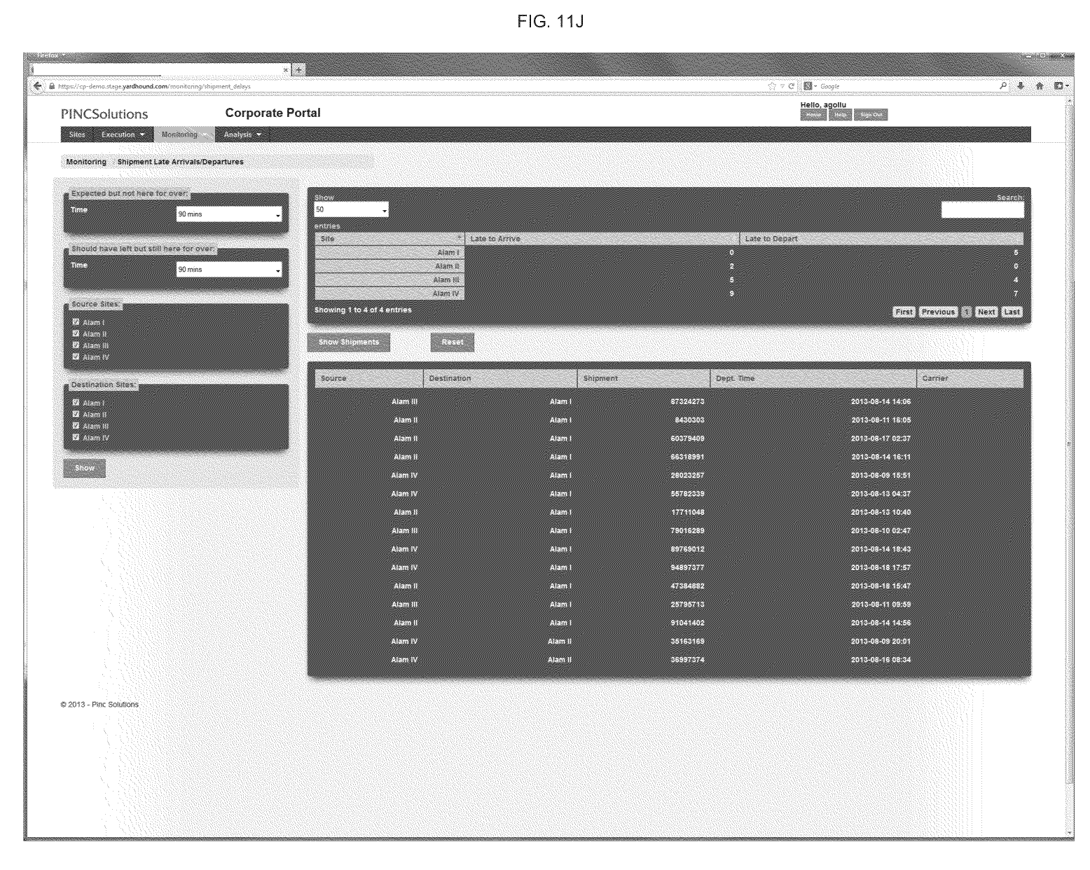

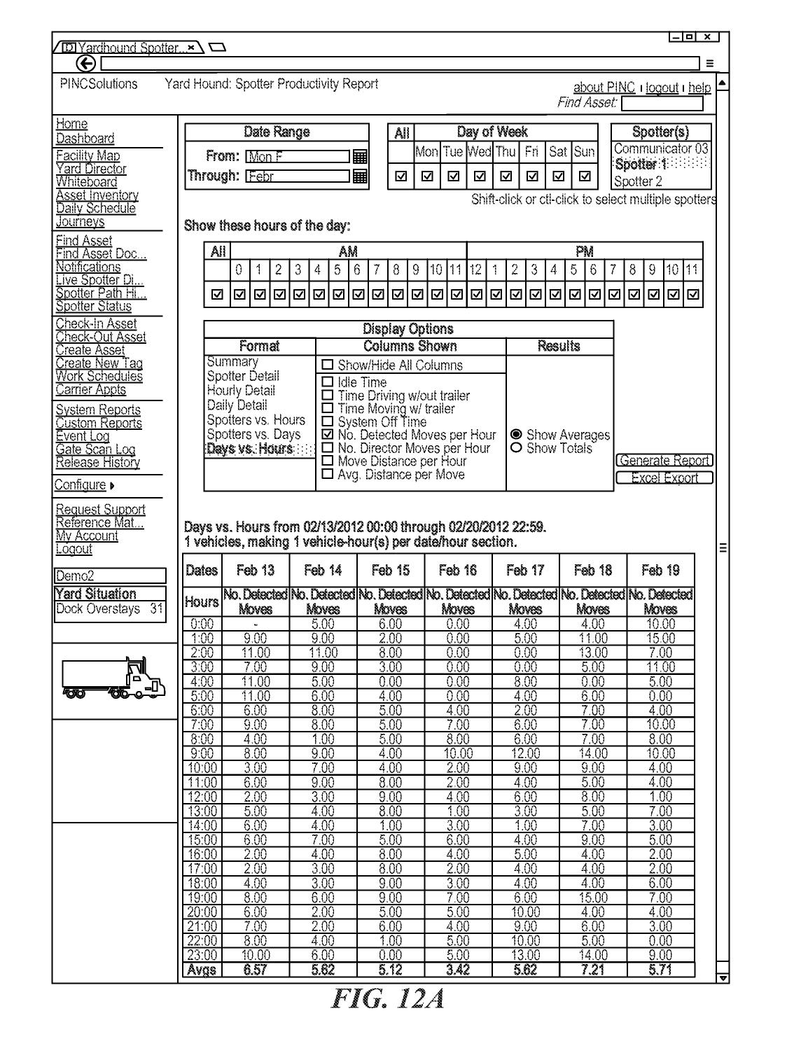

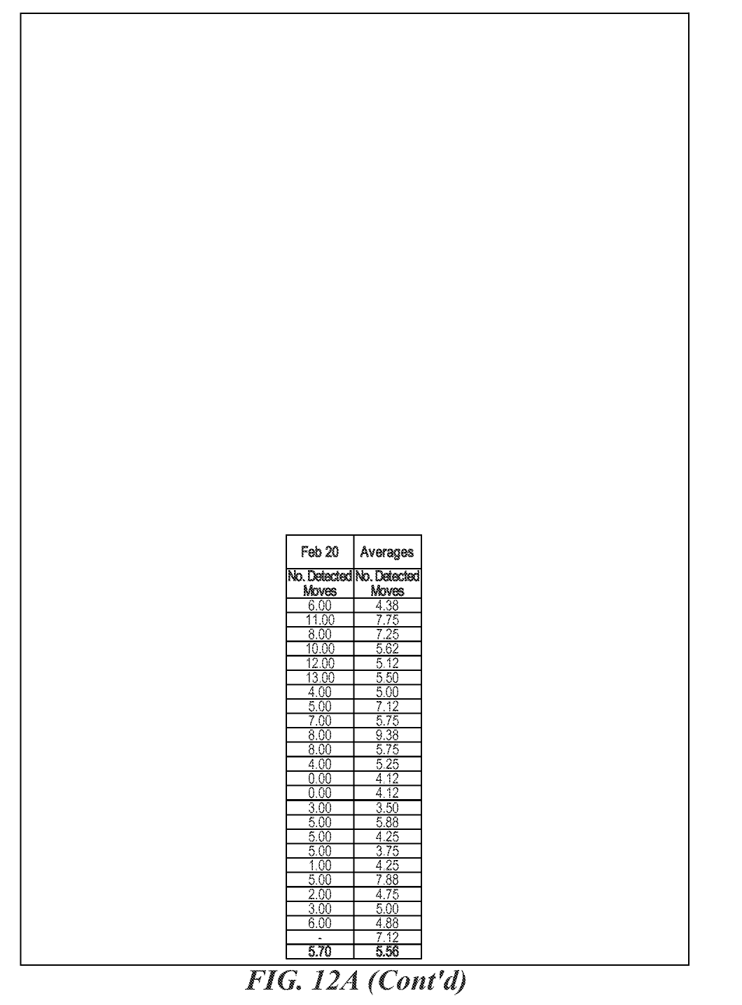

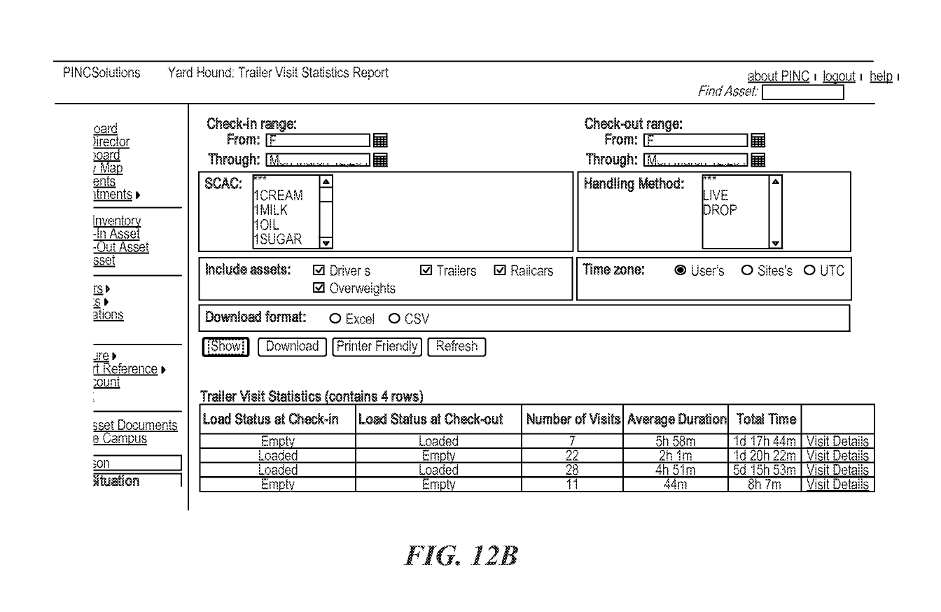

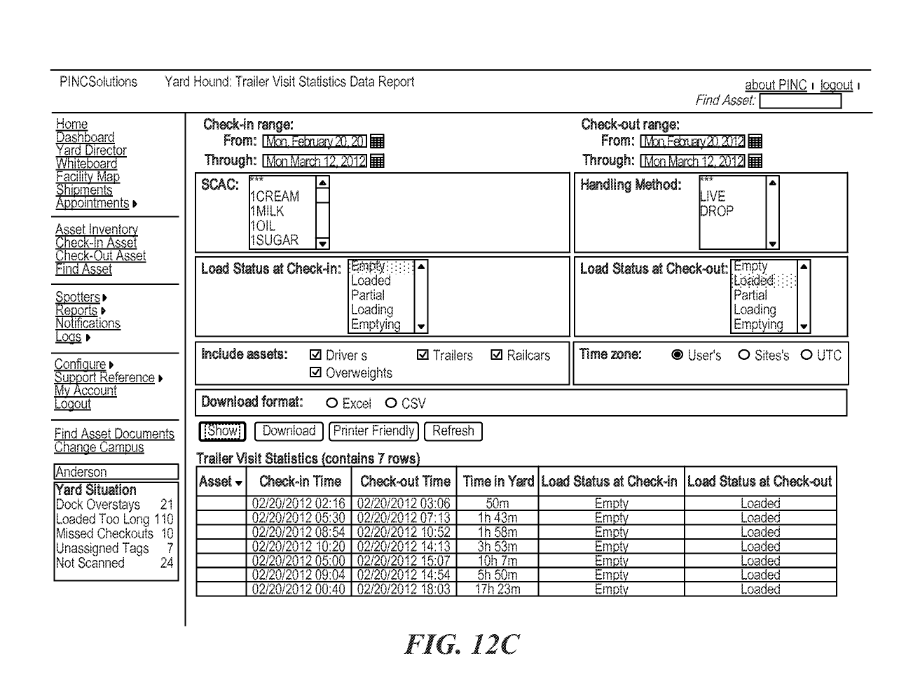

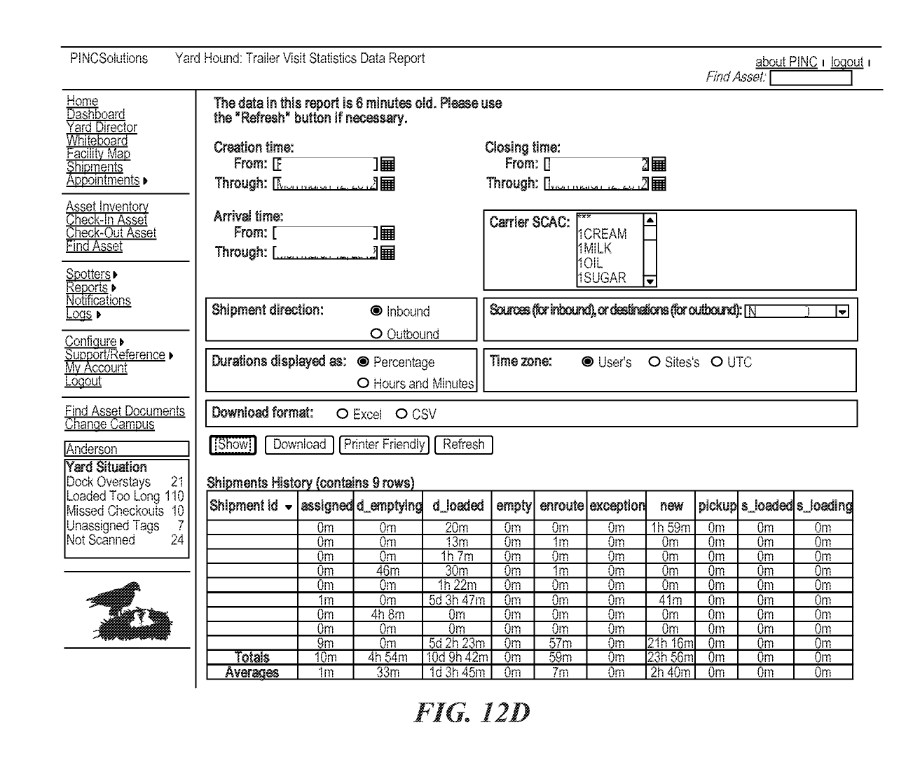

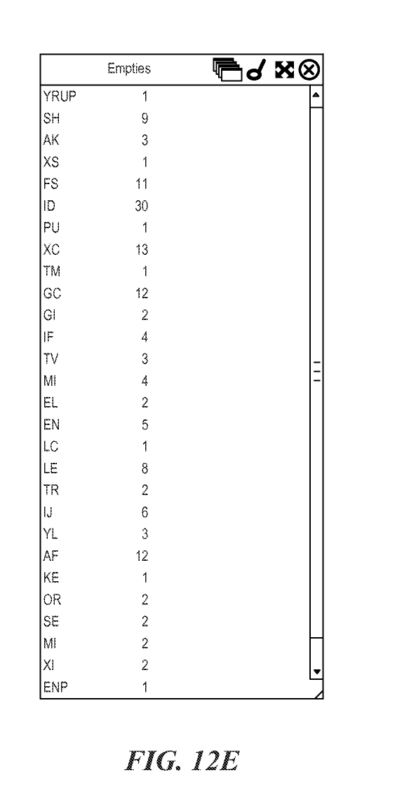

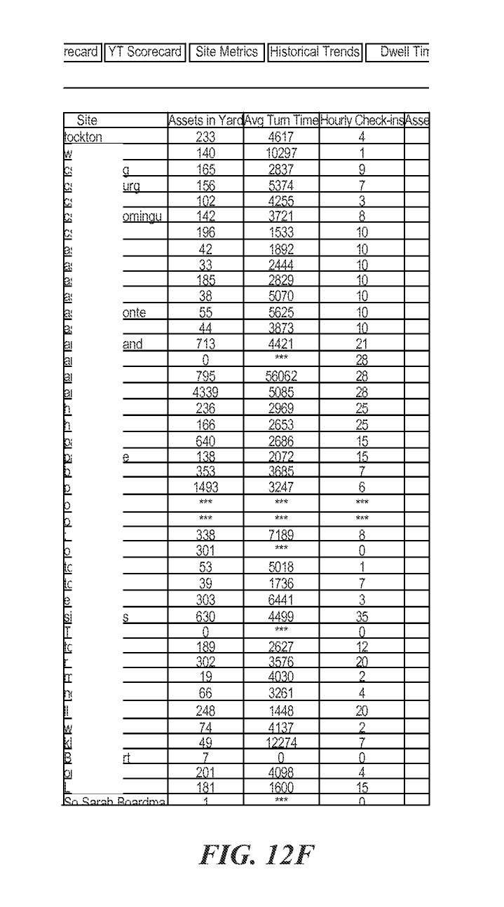

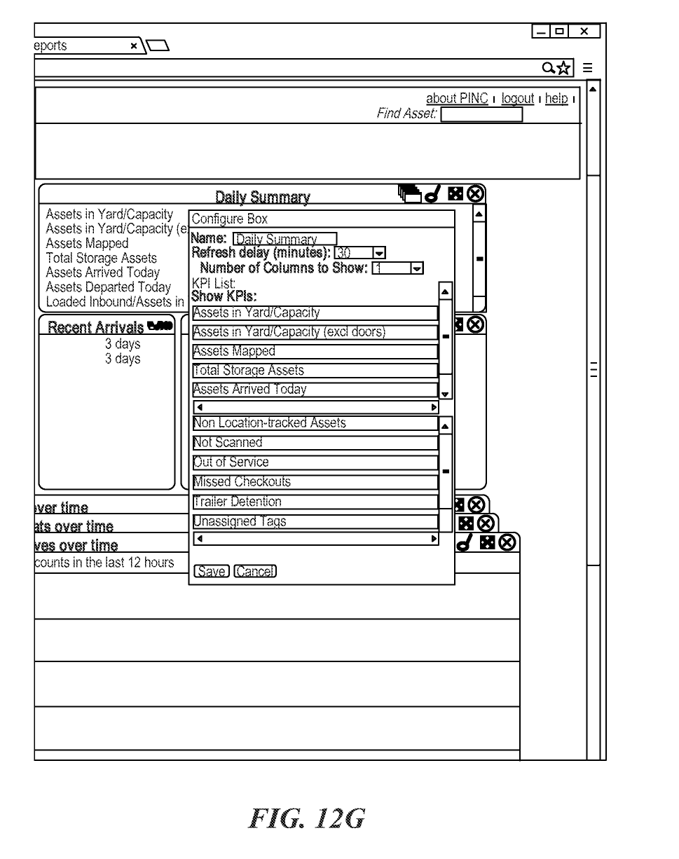

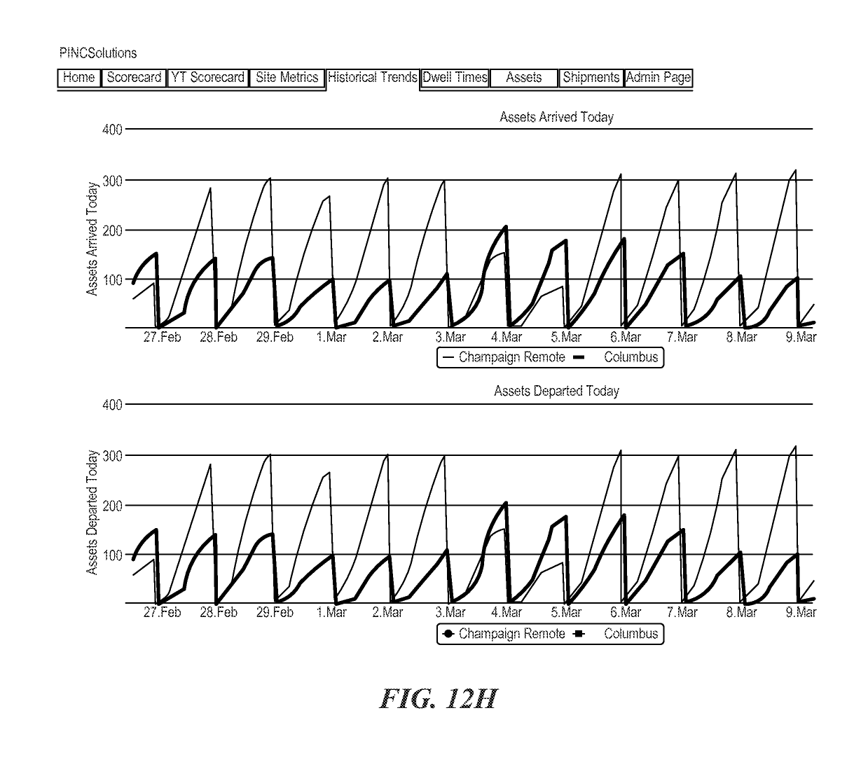

One embodiment is configured to provide the reports, number metrics, and KPIs, as described hereinbelow. It should be appreciated that the particular details are illustrative and are not meant to be limiting. FIG. 12A is a sample performance report generated from the system, according to an embodiment. FIG. 12B is a sample trailer visit statistics report, according to an embodiment. FIG. 12C is another sample of a trailer visit statistics report, according to an embodiment. FIG. 12D is a sample shipments history report, according to an embodiment. FIG. 12E is a sample vector metric report, according to an embodiment. FIG. 12F is another sample number metric report where one compares numbers across the network, according to an embodiment. FIG. 12G is another sample number metric report, according to an embodiment. FIG. 12H is a sample graph of a number metric whose value is saved on a set interval, according to an embodiment.

It should be appreciated that FIG. 12A and FIG. 12H depict structured KPI cases, enabling one skilled in the art to create similar reports to explore new KPI opportunities.

### 4.4.2 Performance Analysis at Network Level

Similar to Monitoring, Analysis can be performed at site level or at Corporate Level. It should be appreciated that some of the previous examples under Monitoring were to manage exceptions in Real Time. Here we provide an example of using past data to identify trouble spots.

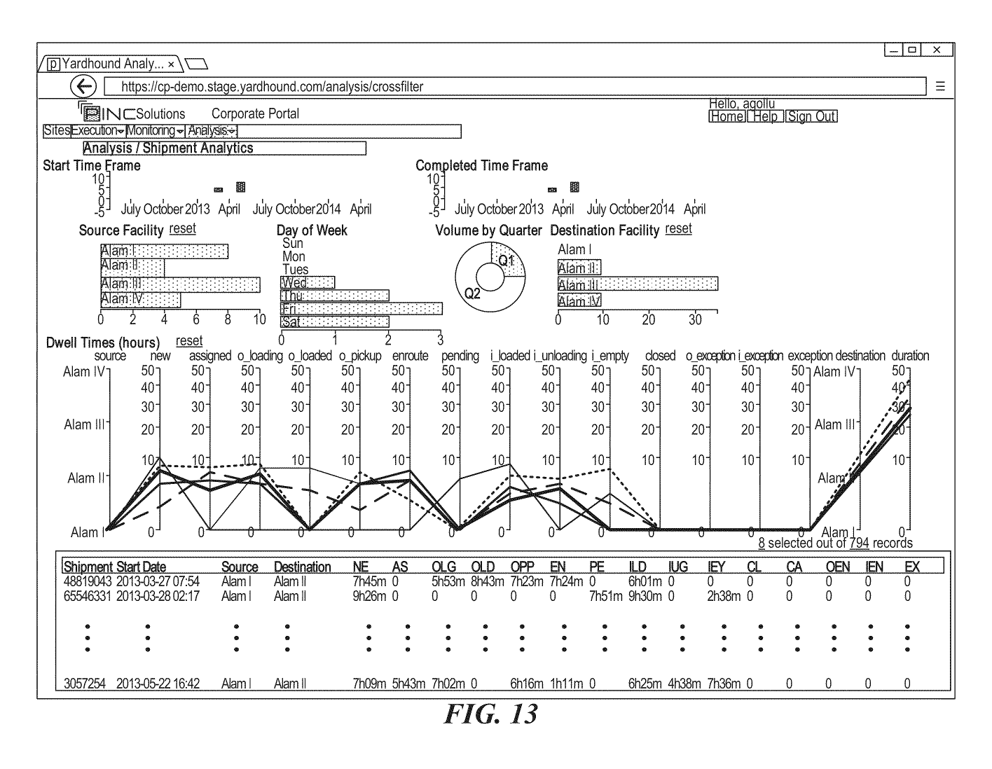

FIG. 13 is a screen shot of an Analysis view, according to an embodiment. For example, statistical values regarding source facility, destination facility, and dwell times are computed and presented. FIG. 13 shows an example of using past data to identify trouble spots to define new metrics. The system is configured to enable easy navigation. For example, the system is configured to allow a user to look at all Shipments from the last Month with click and drag. In this example, a user is able to look at all Shipments from Alameda I to Alameda IV and see that a large variance of total duration time is revealed. Thus, the user can is enabled to ask himself what is the root cause, such as for example, is it day of the week. By way of this inventive dashboard, the user is enabled to target and focus on the root cause of a problematic area and make corrections thereto.

It should be appreciated that FIG. 13 depicts unstructured cases, enabling one skilled in the art to create similar reports to explore structured KPI opportunities at network level.

### 5 An Exemplary Platform Architecture

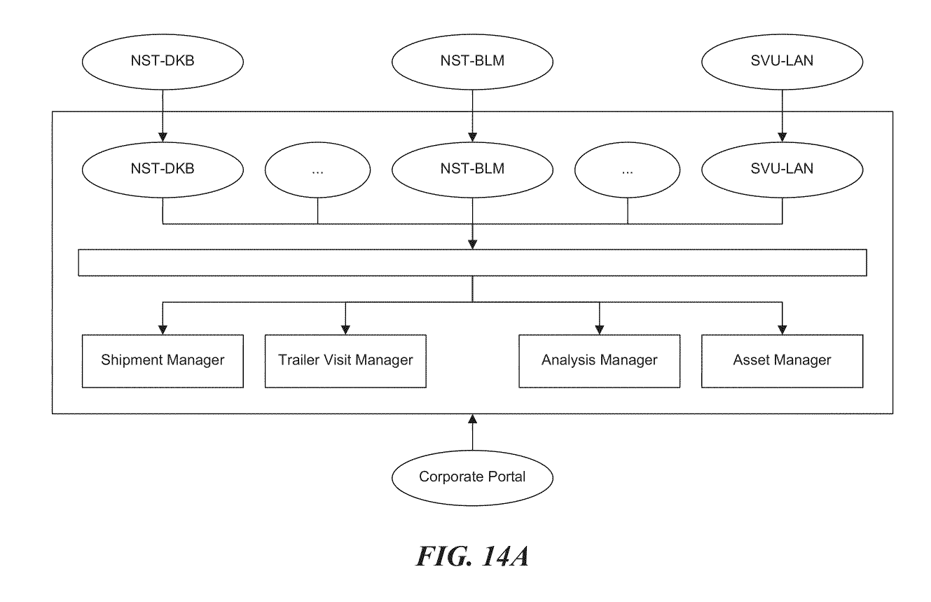

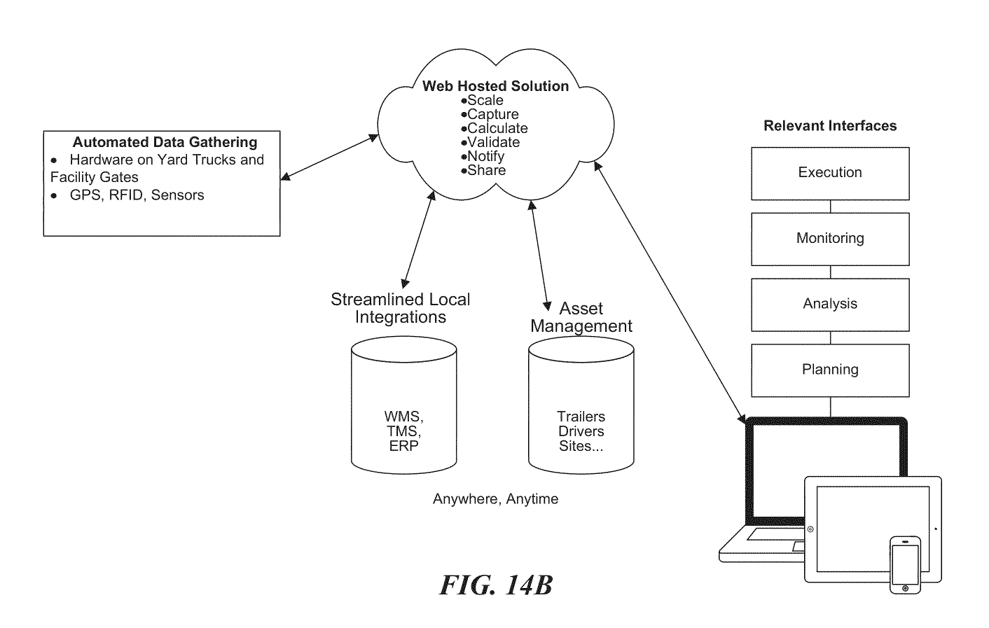

As discussed hereinabove, the least common denominator model enables the provision of a platform, which, in turn, enables the provision of a universal dashboard as well as the generation of meaningful analysis and statistics. One embodiment can be understood with reference to FIG. 14A, a schematic diagram of main components of the platform at a high level. In the embodiment, individual facilities (NST-MED, DSC-PC1, . . . ) use interfaces to manage execution. monitoring, and analysis functions from a site perspective. Meanwhile services provided at network level, such as a corporate portal and asset manager may provide same functional categories from a corporate and network perspective for all corporations collaborating on this data. In one embodiment, each site can have their own data repository for their local data, while the collaborative data and application servers can be separated into five but not limited to five, sub-components, reflecting five different perspectives. Such data are depicted in the figure as Shipment Manager, Asset Visit Manager, Analysis Manager, Authentication Manager, and Asset Manager, respectively. It should be appreciated that one skilled in the art could readily recognize that such volume of comprehensive trailer and shipment data that is accessible at the network level may be organized in a variety of ways and that the five categories depicted therein are illustrative and are not meant to be limiting. As well, such volume of data may be organized for various audiences as discussed hereinabove. As well, depending on type of access whether it is for execution and monitoring for real time transactions, or after the fact off-line analysis a user can structure the data differently to meet latency and throughput requirements. Finally a plurality of interfaces can be provided at the network level such as a Carrier Portal, Driver Portal, 3PL Portal etc.

FIG. 14B is a schematic diagram that illustrates main components from the enterprise perspective, according to an embodiment. In the embodiment, automated data is gathered, e.g. via hardware on yard trucks and facility gates using, but not limited to using, GPS, RFID sensors, and the like. The embodiment provides a Web hosted solution that may be scalable, performs computations, and validates input data, and so on. Such Web hosted solution enables streamlined local integrations as well as asset management across sites. The embodiment provides relevant interfaces including but not limited to interfaces for execution, monitoring, analysis, and planning.

An embodiment contemplates or provides global back end capabilities including but not limited to:
Shipment and Trailer Visit Server
   Centralized information about Shipments and Trailers
Analysis Server
   Ability to analyze closed Shipments and Trailer Visits
   Central Location for KPI Trends from each site
Integration Server
   Standard REST APIs, Event Queues, and External Get-Points
Asset Management Server
   List of Users
   List of Trailers, permanent tags, characteristics
   List of Drivers, e.g. Drivers as Assets
   List of Facilities
Central KPI Server
   Contains KPIs/dashboards from all sites in one central location
   Ability to view Dashboard boxes from multiple sites on one page
   Ability to create Dashboard boxes against multiple sites
   Ability to click through to additional detail

In an embodiment, a corporate portal may provide but is not limited to provide the following capabilities:
Single Sign On to all facilities
Ability to operate on Shipments and Trailers that are en route to a Corporate Facility
   As notes
   As operations
Ability to view KPIs from Central KPIs Server
   Ability to click through to additional detail
   Ability to view Dashboard boxes from multiple sites on one page
   Ability to create Dashboard boxes against multiple sites
Access to Analysis Server and Site Reports

### 5.1 Exemplary Benefits

In an embodiment, the system is configured to:
Centralize certain site responsibilities to reduce headcount and increase execution precision
   Perform shipment and trailer planning at HQ
   Move certain check-in/check-out tasks to a central location
Improve load planning with tare weights
Tighter management of trailer pools
Accelerate a Driver's and Tractor's visit through the facility
Accelerate a Trailer's visit through the facility
Collaboration with Suppliers and Customer to reduce Empty miles
Reduce safety stock inventory

### 6 An Example Machine Overview

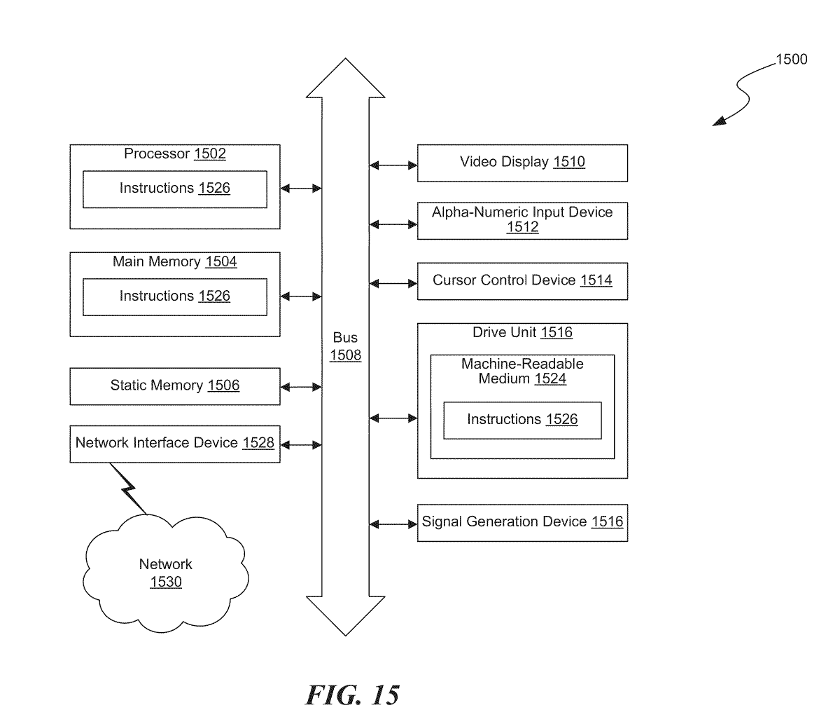

FIG. 15 is a block schematic diagram of a system in the exemplary form of a computer system 1500 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance or any system capable of executing a sequence of instructions that specify actions to be taken by that system.

The computer system 1500 includes a processor 1502, a main memory 1504 and a static memory 1506, which communicate with each other via a bus 1508. The computer system 1500 may further include a display unit 1510, for example, a liquid crystal display (LCD) or a cathode ray tube (CRT). The computer system 1500 also includes an alphanumeric input device 1512, for example, a keyboard; a cursor control device 1514, for example, a mouse; a disk drive unit 1516, a signal generation device 1518, for example, a speaker, and a network interface device 1528.

The disk drive unit 1516 includes a machine-readable medium 1524 on which is stored a set of executable instructions, i.e. software, 1526 embodying any one, or all, of the methodologies described herein below. The software 1526 is also shown to reside, completely or at least partially, within the main memory 1504 and/or within the processor 1502. The software 1526 may further be transmitted or received over a network 1530 by means of a network interface device 1528.

In contrast to the system 1500 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations, e.g. requiring cables and complex software configurations, e.g. requiring a consultant to install. For example, embodiments may provide one or more cloud computing solutions that enable users, e.g. users on the go, to manage shipment on such internet-enabled or other network-enabled devices, servers, or clients. It further should be appreciated that one or more cloud computing embodiments include managing shipment using mobile devices, tablets, and the like, as such devices become standard consumer devices.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for providing shipping and trailer management over a network, comprising:
at least one processor operable to execute computer program instructions; and
at least one memory operable to store computer program instructions executable by said at least one processor, for performing:
receiving trailer visit data from a plurality of trailer visit sources and storing said received trailer visit data;
receiving shipment data from a plurality of shipment data sources and storing said received shipment data, wherein said shipment data comprises least common denominator data of a least common denominator model, said least common denominator data comprising informational data that are in the same format across a plurality of trailer visit sites;
extracting data from said stored trailer visit data and extracting data from said stored shipment data to process said extracted data to form monitoring and analysis data;
generating a data map of trailer states to shipping states based on the least common denominator model using said stored trailer visit data, said stored shipment data, and local trailer visit data, by translating a trailer state to a shipping state;
providing one or more interfaces to enter new or modify existing trailer visit data associated with particular trailer visits at a local yard;
providing one or more interfaces to enter new or modify existing shipment data at a local yard and across the network; and
providing one or more interfaces to allow monitoring and analyzing any of said analysis data, stored trailer visit data, and stored shipment data.

2. The apparatus of claim 1, wherein said data map is extendable by adding additional trailer states on a per local yard basis.

3. The apparatus of claim 1, wherein each local yard has the ability to manage trailers and trailer state transitions independently.

4. The apparatus of claim 1, wherein each local yard has the ability of sharing local data selectively using shipments.

5. The apparatus of claim 1, wherein categories of trailer states comprise the following attributes: movement type, load status, handling method, out-of-service, inbound use, outbound use, location, inbound shipment state, outbound shipment state and valid, and check-in state and check-out state of said attributes.

6. The apparatus of claim 1, wherein categories of shipment states comprise:
Outbound—
New;
Assigned;
Outbound Loading;
Outbound Loaded;
Outbound Pick Up; and
Outbound Exception;
En route—
Exception—
Overweight;
Inbound—
Inbound Loaded;
Inbound Emptying;
Inbound Empty;
Closed; and
Inbound Exception.

7. The apparatus of claim 1, wherein:
to represent a trailer visit, the trailer visit data comprises an inbound shipment, an inbound driver, an inbound tractor; an outbound shipment, an outbound driver, and an outbound tractor; and
to represent a shipment, the shipment data comprises a source trailer visit, a destination trailer visit, a driver, and a tractor.

8. The apparatus of claim 1, wherein a trailer state is valid or an exception and a shipment state is valid, a modeled exception, or an unmodeled exception.

9. The apparatus of claim 1, wherein said local yard defines an extended set of trailer states that are relevant to said local yard and other locations, maps said extended trailer states into said data map, and makes said extended trailer states visible via the mapped shipment states.

10. The apparatus of claim 1, wherein said least common denominator model comprises sequences of state transitions which fall into a positive-path operations category, an operations with known/modeled exceptions category, and an operations with exceptions that are not modeled category resulting in state trajectories.

11. The apparatus of claim 10, wherein said instructions further comprises monitoring, analyzing and providing a report on the number of trailer visits or shipments that fall into each of said three operation categories.

12. The apparatus of claim 10, wherein said instructions further comprises monitoring, analyzing and providing a report regarding performance statistics and metrics in each category separately.

13. The apparatus of claim 1, wherein said instructions further comprises monitoring, analyzing and providing a report regarding performance statistics and metrics in each trailer state or shipment state group separately.

14. The apparatus of claim 1, wherein said instructions further comprises setting performance targets and reporting trailer visits, shipments, and locations that are within a particular key performance indicator (KPI) or out of said KPI.

15. A computer-implemented method for providing shipping and trailer management over a network, comprising:
receiving trailer visit data from a plurality of trailer visit sources and storing said received trailer visit data;
receiving shipment data from a plurality of shipment data sources and storing said received shipment data, wherein said shipment data comprises least common denominator data of a least common denominator model, said least common denominator data comprising informational data that are in the same format across a plurality of trailer visit sites;
extracting data from said stored trailer visit data and extracting data from said stored shipment data to process said extracted data to form monitoring and analysis data;
generating a data map of trailer states to shipping states based on the least common denominator model, using said stored trailer visit data, said stored shipment data, and local trailer visit data, by translating a trailer state to a shipping state;
providing one or more interfaces to enter new or modify existing trailer visit data associated with particular trailer visits at a local yard;
providing one or more interfaces to enter new or modify existing shipment data at a local yard, or across the network; and
providing one or more interfaces to allow monitoring and analyzing any of said analysis data, stored trailer visit data, and stored shipment data.

16. The method of claim 15, wherein said data map is extendable by adding additional trailer states on a per local yard basis.

17. The method of claim 15, wherein each local yard has the ability to manage trailers and trailer state transitions independently.

18. The apparatus of claim 15, wherein each local yard has the ability of sharing local data selectively using shipments.

19. The method of claim 15, wherein categories of trailer states comprise the following attributes: movement type, load status, handling method, out-of-service, inbound use, outbound use, location, inbound shipment state, outbound shipment state and valid, and check-in state and check-out state of said attributes.

20. The method of claim 15, wherein categories of shipment states comprise:
Outbound—
New;
Assigned;
Outbound Loading;
Outbound Loaded;
Outbound Pick Up; and
Outbound Exception;
En route—
Exception—
Overweight;
Inbound—
Inbound Loaded;
Inbound Emptying;
Inbound Empty;
Closed; and
Inbound Exception.

21. The method of claim 15, wherein:
to represent a trailer visit, the trailer visit data comprises an inbound shipment, an inbound driver, an inbound tractor; an outbound shipment, an outbound driver, and an outbound tractor; and
to represent a shipment, the shipment data comprises a source trailer visit, a destination trailer visit, a driver, and a tractor.

22. The method of claim 15, wherein a trailer state is valid or an exception and a shipment state is valid, a modeled exception, or an unmodeled exception.

23. The method of claim 15, wherein said local yard defines an extended set of trailer states that are relevant to said local yard and other locations, maps said extended trailer states into said data map, and makes said extended trailer states visible via the mapped shipment states.

24. The method of claim 15, wherein said least common denominator model comprises sequences of state transitions which fall into a positive-path operations category, an operations with known/modeled exceptions category, and an operations with exceptions that are not modeled category, resulting in state trajectories.

25. The method of claim 24, further comprising monitoring, analyzing and providing a report on the number of trailer visits or shipments that fall into each of said three operation categories.

26. The method of claim 24, further comprising monitoring, analyzing and providing a report regarding performance statistics and metrics in each category separately.

27. The method of claim 15, further comprising monitoring, analyzing and providing a report regarding performance statistics and metrics in each trailer state or shipment state group separately.

28. The method of claim 15, further comprising setting performance targets and reporting trailer visits, shipments, and locations that are within a particular key performance indicator (KPI) or out of said KPI.
